(19) United States
(12) Patent Application Publication
(10) Pub. No.: US 2017/0317507 A1
(43) Pub. Date: Nov. 2, 2017

(54) CONTROL DEVICE, POWER STORAGE DEVICE, CONTROL METHOD AND RECORDING MEDIUM

(71) Applicant: NEC Corporation, Tokyo (JP)

(72) Inventor: Koji KUDO, Tokyo (JP)

(21) Appl. No.: 15/521,267

(22) PCT Filed: Oct. 8, 2015
(86) PCT No.: PCT/JP2015/078586

§ 371 Date: Apr. 21, 2017

(30) Foreign Application Priority Data
Oct. 23, 2014 (JP) 2014-216286

(51) Int. Cl. H02J 7/00

(52) U.S. Cl. CPC H02J 7/0014; H02J 7/0021; H02J 7/007

(57) ABSTRACT

This control device includes: a reception unit that receives information that indicates characteristics of a power supply/demand adjustment process; and a determination unit that, on the basis of the information that indicates the characteristics of the power supply/demand adjustment process, determines as usage information to be used for the adjustment process the state of a power grid or an index that relates to an adjustment power amount that was received from a predetermined device.

### TECHNICAL FIELD

The present invention relates to a control device, a power storage device, a control method and a program, and more particularly relates to a control device, a power storage device, a control method, and a program that relate to a process of adjusting electric power supply and demand.

### BACKGROUND ART

Methods are known of using power supply/demand adjustment devices such as batteries to carry out processes of adjusting power supply and demand to adjust the supply and demand of electric power on a power grid.

Patent Document 1 discloses a power grid power storage system that controls storage batteries to implement power supply/demand adjustment processes. The power grid power storage system described in Patent Document 1 implements GF (Governor Free) adjustment processes and LFV (Load Frequency Control) adjustment processes as the power supply/demand adjustment processes.

A GF adjustment process is a process that is compatible with GF that is being carried out on the power plant side. In the GF that is being carried out on the power plant side, the power generator automatically adjusts output in accordance with a fluctuation period of from one to twenty seconds at the frequency of the power grid (hereinbelow referred to as the “grid frequency”). In a GF adjustment process, charging and/or discharging of storage batteries is regulated in order to compensate for imbalance in the power supply and demand that corresponds to a fluctuation period of from one to twenty seconds in the grid frequency.

An LFC adjustment process is a process that is compatible with the LFC that is being implemented on the power plant side. In the LFC that is being carried out on the power plant side, the output of a power generator is controlled through the use of control signals to adjust the output of the power generator in accordance with a fluctuation period of from one to twenty minutes in the grid frequency. In an LFC adjustment process, the charging and/or discharging of storage batteries is adjusted to compensate for imbalance in the power supply and demand that corresponds to a fluctuation period of from one to twenty minutes in the grid frequency.

### LITERATURE OF THE PRIOR ART

### Patent Documents

Patent Document 1: Japanese Patent Laid-Open No. 2012-50211

### SUMMARY

### Problem to be Solved by the Invention

In different power supply/demand adjustment processes such as a GF adjustment process and an LFC adjustment process, the methods of controlling power supply/demand adjustment devices such as batteries differ.

As a result, when a control method of a power supply/demand adjustment device that accords with a power supply/demand adjustment process cannot be realized in the power grid power storage system described in Patent Document 1, the problem arises that an appropriate power supply/demand adjustment process cannot be carried out.

It is an object of the present invention to provide a control device, a power storage device, a control method and a program that can provide a solution to the problem described above.

### Means for Solving the Problem

The control device of the present invention includes a reception unit that receives information indicating characteristics of a power supply/demand adjustment process; and a determination unit that, on the basis of information indicating characteristics of the power supply/demand adjustment process, determines an index that relates to an adjustment power amount received from a predetermined device or to the state of the power grid as usage information that is used in the adjustment process.

Another control device of the present invention includes a communication unit that receives report information that specifies usage information that is used in a power supply/demand adjustment process and a control unit that uses the usage information that is specified by the report information to control a power supply/demand adjustment device.

The power storage device of the present invention includes: a battery that is connected to a power grid; a detection unit that detects the state of the power grid; a communication unit that receives an index relating to the adjustment power amount that is received from an external device; a reception unit that receives information that indicates characteristics of a power supply/demand adjustment process that uses the battery; a determination unit that, in accordance with the adjustment process that is specified in information that indicates characteristics of the power supply/demand adjustment process, determines the state of the power grid or the index as usage information that is used in the adjustment process; and a control unit that, on the basis of the usage information, controls the battery to execute the adjustment process.

The control method of the present invention includes steps of: receiving information that indicates characteristics of a power supply/demand adjustment process; on the basis of the information that indicates characteristics of the power supply/demand adjustment process, determining an index that relates to an adjustment power amount that is received from a predetermined device or to the state of the power grid as usage information used in the adjustment process.

Another control method of the present invention includes steps of: receiving report information that specifies usage information that is used in a power supply/demand adjustment process, and using the usage information that is specified in the report information to control a power supply/demand adjustment device.

The recording medium of the present invention is a recording medium that can be read by a computer and on which is recorded a program for causing a computer to execute: a reception procedure of receiving information that indicates characteristics of a power supply/demand adjustment process; and a determination procedure of, on the basis of information that indicates characteristics of the power supply/demand adjustment process, determining an index relating to an adjustment power amount that is received from a predetermined device or to the state of the power grid as usage information that is used in the adjustment process.

Another recording medium of the present invention is a recording medium that can be read by a computer and on which is recorded a program that causes a computer to execute: a reception procedure of receiving report information that specifies usage information that is used in a power supply/demand adjustment process; and a control procedure of using usage information that is specified in the report information to control a power supply/demand adjustment device.

### Effect of the Invention

The present invention enables appropriate execution of a power supply/demand adjustment process.

### BRIEF DESCRIPTION OF THE DRAWINGS

FIG. 1A shows control device A of the first exemplary embodiment of the present invention.

FIG. 1B is a flow chart for describing the operation of control device A.

FIG. 2A shows apparatus control device B of the second exemplary embodiment of the present invention.

FIG. 2B is a flow chart for describing the operation of apparatus control device B.

FIG. 2C shows an example of LFC operation control information.

FIG. 2D shows an example of GF operation control information.

FIG. 2E shows apparatus control device BB in which communication unit B3 receives specification information, index i1, and operation control information.

FIG. 2F shows apparatus control device B that incorporates storage battery R2.

FIG. 2G shows apparatus control device BB that incorporates storage battery R2.

FIG. 3A shows power control device C of the third exemplary embodiment of the present invention.

FIG. 3B is a flow chart for describing the operation of power control device C.

FIG. 3C is a flow chart for describing the operation of apparatus control device D.

FIG. 3D shows apparatus control device D that incorporates storage battery R2.

FIG. 4A shows control device E of the fourth exemplary embodiment of the present invention.

FIG. 4B is a flow chart for describing the operation of control device E.

FIG. 5A shows apparatus control device F of the fifth exemplary embodiment of the present invention.

FIG. 5B is a flow chart for describing the operation of apparatus control device F.

FIG. 5C shows an example of first LFC operation control information.

FIG. 5D shows an example of BL operation control information.

FIG. 5E shows an example of MO operation control information.

FIG. 5F shows apparatus control device FF in which communication unit F2 receives specification information, each index, and each type of operation control information.

FIG. 5G shows apparatus control device F that incorporates storage battery R2.

FIG. 5H shows apparatus control device FF that incorporates storage battery R2.

FIG. 6A shows power control device G of the sixth exemplary embodiment of the present invention.

FIG. 6B is a flow chart for describing the operation of power control device G.

FIG. 6C is a flow chart for describing the operation of apparatus control device H.

FIG. 6D shows apparatus control device H that incorporates storage battery R2.

FIG. 7 shows power control system 1000 that adopts the seventh exemplary embodiment of the present invention.

FIG. 8 shows an example of load dispatching unit 2, power control device 7, and a plurality of apparatus control devices 8.

FIG. 9A shows an example of storage battery distribution rate curve 202a at the time of discharging.

FIG. 9B shows an example of storage battery distribution rate curve 202b at the time of charging.

FIG. 10A shows an example of the DR1 drooping characteristic line.

FIG. 10B shows an example of the DR2 charge/discharge gain line.

FIG. 10C shows an example of the DR3 charge/discharge gain line.

FIG. 11 is a flow chart for describing the operation in which apparatus control device 8 determines usage information.

FIG. 12 is a sequence diagram for describing the operation of deriving P_{ES}.

FIG. 13 is a sequence diagram for describing the DR1 comprehension operation.

FIG. 14 is a sequence diagram for describing the DR1 allotment operation.

FIG. 15 shows an example of local drooping characteristic line 400C.

FIG. 16 is a sequence diagram for describing the charging/discharging control operation.

FIG. 17 is a sequence diagram for describing the DR2 comprehension operation.

FIG. 18 is a sequence diagram for describing the DR2 allotment operation.

FIG. 19 shows an example of first local charging/discharging gain line 800A.

FIG. 20 is a sequence diagram for describing the charging/discharging control operation.

FIG. 21 is a sequence diagram for describing the DR3 comprehension operation.

FIG. 22 is a sequence diagram for describing the DR3 allotment operation.

FIG. 23 shows an example of the second local charging/discharging gain line 800B.

FIG. 24 is a sequence diagram for describing the charging/discharging control operation.

FIG. 25 shows an example of a power generation plan.

FIG. 26 shows a SOC distribution.

### EXEMPLARY EMBODIMENT

Exemplary embodiments of the present invention are next described with reference to the accompanying drawings.

### First Exemplary Embodiment

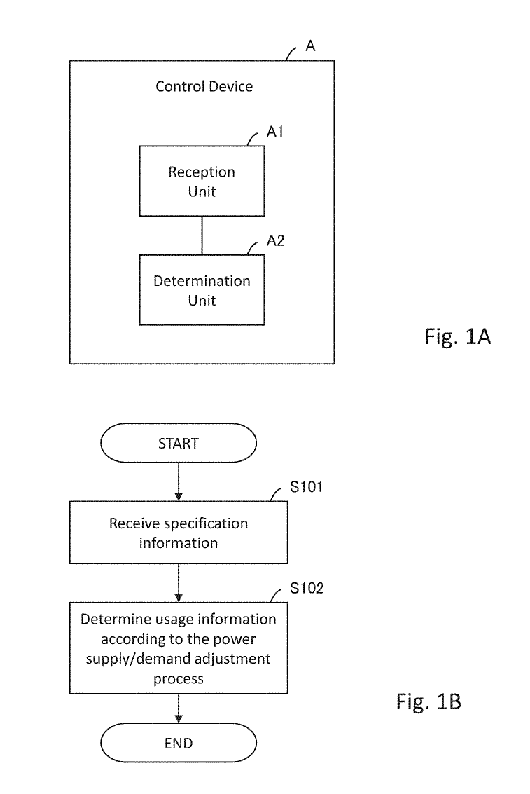

FIG. 1A shows control device A of the first exemplary embodiment of the present invention.

Control device A includes reception unit A1 and determination unit A2.

Reception unit A1 receives LFC identification information that specifies an LFC adjustment process and GF identification information that specifies a GF adjustment process.

An LFC adjustment process is a process of adjusting charging or discharging of a storage battery to compensate for imbalance in power supply/demand that corresponds to a fluctuation period of from one to twenty minutes in the grid frequency.

A GF adjustment process is a process of adjusting charging or discharging of a storage battery to compensate for imbalance in the power supply and demand that corresponds to a fluctuation period of from one to twenty seconds in the grid frequency.

Each of the LFC adjustment process and the GF adjustment process is an example of a process of adjusting power supply and demand. In the following explanation, an LFC adjustment process and a GF adjustment process are also referred to as “power supply/demand adjustment processes.”

Each of the LFC identification information and GF identification information is an example of specification information or information that indicates the characteristics of a power supply/demand adjustment process. In the following explanation, LFC identification information and GF identification information are also referred to as “specification information.” The LFC identification information is, for example, an identifier or a name of an LFC adjustment process. The GF identification information is, for example, an identifier or a name of a GF adjustment process.

A storage battery that is used in a power supply/demand adjustment process such as an LFC adjustment process or a GF adjustment process is an example of a power supply/demand adjustment device. A power supply/demand adjustment device is not limited to a storage battery and can be altered as appropriate. For example, an electric apparatus such as an air conditioner, an electric water heater, a heat pump water heater, a pump, or an electric vehicle may also be used as a power supply/demand adjustment device.

The storage battery is linked to a power grid. The power grid is assumed to be connected to another power grid by means of linking lines.

Determination unit A2 determines, as usage information that is used in a power supply/demand adjustment process, the frequency of the power grid or an index (hereinbelow simply referred to as (index i1″) relating to the adjustment power amount that is received from a predetermined device according to the power supply/demand adjustment process that is specified in the specification information. Index i1 also functions as an index relating to the power state that is transmitted from the predetermined device.

The predetermined device is an external device or control device A.

The frequency of the power grid fluctuates according to the state of balance of power supply and demand. The frequency of the power grid is detected by, for example, an execution device that executes the power supply/demand adjustment process (hereinbelow also referred to as simply the “execution device”). The frequency of the power grid is an example of the state of the power grid. The state of the power grid is not limited to the frequency of the power grid and can be altered as appropriate to, for example, the voltage of the power grid.

Index i1 is generated in, for example, the predetermined device. Index i1 is a value that is determined on the basis of the frequency of the power grid and the flow on the linking line.

Index i1 is determined, for example, as shown below.

When power is supplied from the power grid to another power grid by way of a linking line:

The deviation of the frequency of the power grid (the grid frequency) from a reference frequency (for example, 50 Hz) (grid frequency−reference frequency: hereinbelow referred to as the “frequency deviation”) is calculated. The power that is supplied from the power grid to another power grid by way of a linking line is multiplied by a predetermined coefficient (positive value). The integrated value of the addition value of this product and the frequency deviation is determined as index i1. The addition value signifies a corrected frequency deviation in which the frequency deviation has been corrected by the flow on the linking line.

When power is supplied to the power grid from another power grid by way of a linking line:

The frequency deviation is calculated. The power that is being supplied to the power grid from another power grid by way of a linking line is multiplied with the above-described predetermined coefficient. The integrated value of the value obtained by subtracting the product of this multiplication from the frequency deviation is determined as index i1. The subtraction value signifies the corrected frequency deviation that is obtained by correcting the frequency deviation by the flow on the linking line.

Index i1 is received by, for example, the execution device. The execution device uses one-way communication to receive index i1. The execution device may further use bidirectional communication (for example, one-to-N bidirectional communication) to receive index i1.

The operation of the present exemplary embodiment is next described.

FIG. 1B is a flow chart for describing the operation of control device A.

Reception unit A1 receives specification information (Step S101). Reception unit A1 then supplies the specification information to determination unit A2.

Determination unit A2 next receives the specification information.

Determination unit A2 then, according to the power supply/demand adjustment process that is specified in the specification information, determines the frequency of the power grid or index i1 as usage information (Step S102).

In Step S102, determination unit A2 determines index i1 as the usage information when reception unit A1 has received LFC identification information. On the other hand, determination unit A2 determines the frequency of the power grid as the usage information when reception unit A1 has received GF identification information. As a result, determination unit A2 changes the usage information that is to be used in the power supply/demand adjustment process according to the power supply/demand adjustment process.

In the case of an LFC adjustment process, charging/discharging of the storage battery is controlled according to the received LFC signal (for example, index i1). Typically, in the case of a business and customer that carries out the LFC adjustment process, the LFC signal that is transmitted is shared. As a result, checking whether or not the charging/discharging operation of the storage battery is compatible with the received LFC signal enables verification that the storage battery is carrying out the LFC adjustment process.

In the case of a GF adjustment process, the charging/discharging of a storage battery is controlled according to the frequency fluctuation of the power grid. Checking whether the frequency fluctuation of the power grid is compatible with the charging/discharging operation of a storage battery enables verification that the storage battery is carrying out the GF adjustment process.

In addition, an incentive must be paid when DR (Demand Response) is implemented, and a history remains such as a log taken from the implementation content. If the response of charging/discharging (such as the control period) is checked in, for example, a log, the application for which charging/discharging was executed can be ascertained.

The effect of the present exemplary embodiment is next described.

In the present exemplary embodiment, reception unit A1 receives specification information. Determination unit A2 determines as the usage information the frequency of the power grid or index i1 that was transmitted from a predetermined device according to the power supply/demand adjustment process that is specified in the specification information.

As a result, the usage information that is used in a power supply/demand adjustment process can be changed according to the power supply/demand adjustment process. Accordingly, a power supply/demand adjustment process can be executed using the usage information that is appropriate to the power supply/demand adjustment process, whereby the power supply/demand adjustment process can be executed accurately.

When the power supply/demand adjustment process that is specified in the specification information is an LFC adjustment process, determination unit A2 determines index i1 that was transmitted from a predetermined device as the usage information. As a result, the LFC adjustment process can be executed according to index i1 that was set by the predetermined device.

In addition, when index i1 is determined on the basis of the state of the power grid and the flow of the linking line, the LFC adjustment process can be more accurately executed in a power grid to which a linking line is connected.

When the power supply/demand adjustment process that is specified in specification information is a GF adjustment process, determination unit A2 determines the frequency of the power grid as the usage information. As a result, the GF adjustment process can be executed according to the frequency of the power grid, whereby the GF adjustment process can be more accurately executed.

Essentially, because the usage information is selected according to the characteristics of the adjustment process according to the present exemplary embodiment, an adjustment process that requires high speed such as a GF adjustment process or an LFC adjustment process can be executed accurately.

Modifications of the present exemplary embodiment are next described.

Control device A may also function as an execution device. In this case, the predetermined device that transmits index i1 is an external device (a device that differs from control device A). Control device A preferably controls a power supply/demand adjustment device on the basis of either the frequency of the power grid or index i1 (usage information) and on the basis of operation control information that accords with the power supply/demand adjustment process that is specified in the specification information.

Control device A may report to the execution device report information that specifies the usage information (for example, the name or identifier of usage information) and specification information. In this case, the execution device uses the report information to identify the usage information. The execution device controls the power supply/demand adjustment device on the basis of the usage information and operation control information that accord with the power supply/demand adjustment process that is specified in the specification information. In this case, control device A may be managed by an aggregator or PPS (Power Producer and Supplier). Alternatively, control device A may also function as the predetermined device.

In the present exemplary embodiment, an example of the derivation of index i1 was shown, but the present invention is not limited to derivation by the method shown in the present exemplary embodiment and an index that is derived in a load dispatching unit by a different method may also be used. An index similar to an LFC signal distributed by PJM, which is a U.S. ISO (Independent System Operator), can also be offered as an example.

In other words, PJM is known as the largest North American regional transmission organization (RTO) and is also an independent system operator (ISO) that operates the wholesale power exchange market while having jurisdiction over electric power systems in the area of thirteen U.S. states and Washington D.C. Essentially, an index may also be acquired (may be received) not only from a load dispatching unit such as a power company, but also from a power transmission organization that manages a power transmission network.

The index is used not only in an LFC adjustment process but may also be used in a balancing process. The index used in a balancing process may be set on the basis of, for example, the difference between power supply and demand.

### Second Exemplary Embodiment

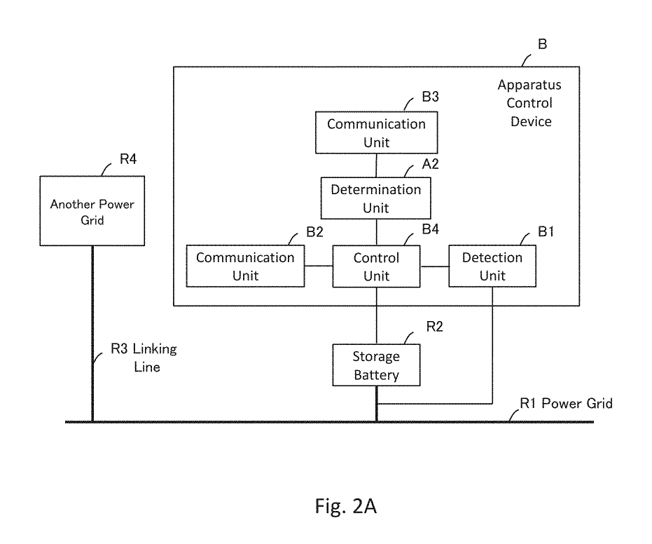

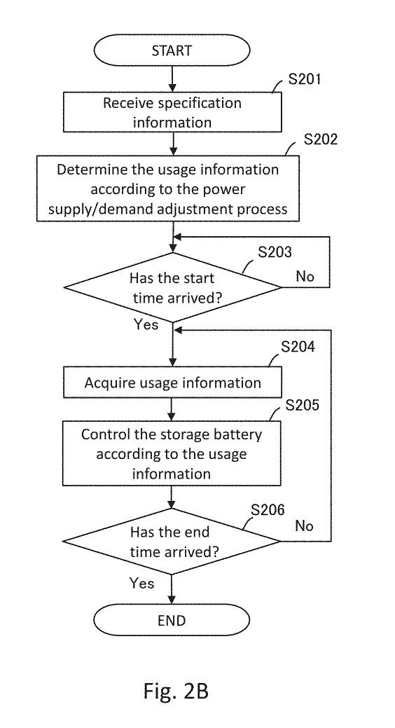

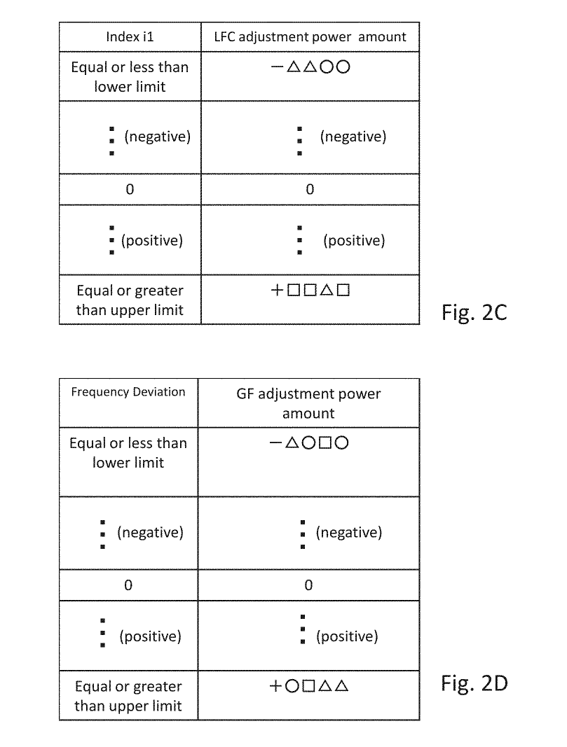

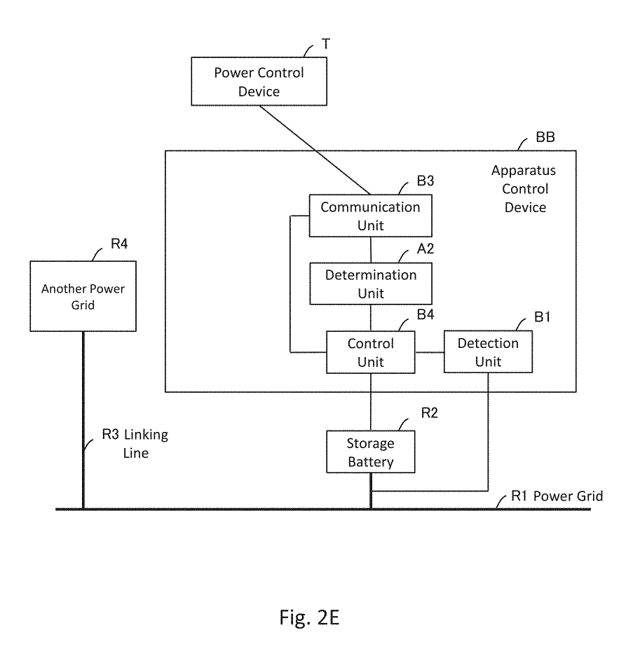

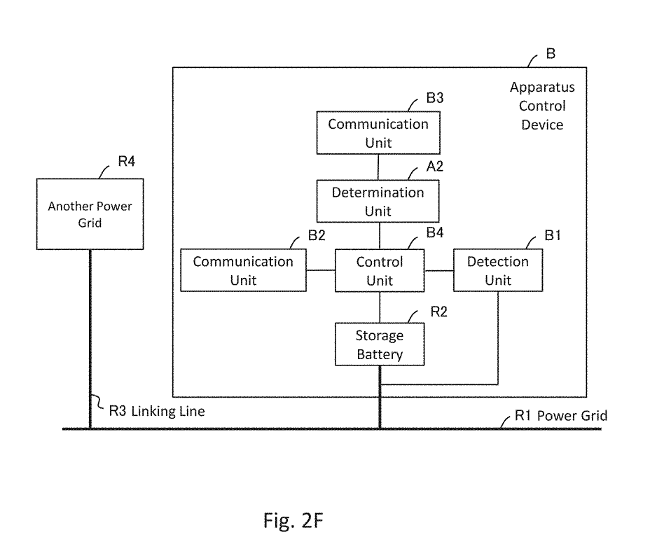

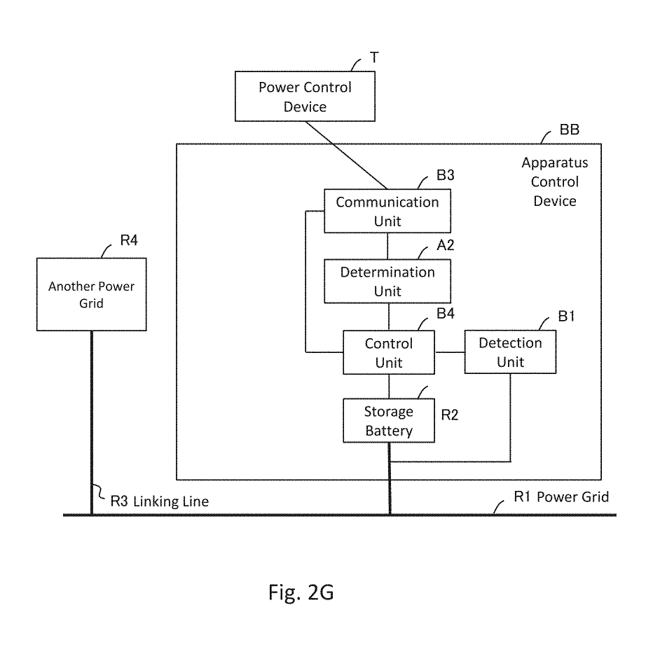

FIG. 2A shows apparatus control device B of the second exemplary embodiment of the present invention. In FIG. 2A, components of the configuration that are identical to components shown in FIG. 1A are given the same reference numbers.

In the second exemplary embodiment, apparatus control device B that is equipped with the functions belonging to control device A shown in the first exemplary embodiment executes power supply/demand adjustment processes. The following explanation will focus on points of the second exemplary embodiment that differ from the first exemplary embodiment.

Apparatus control device B is one example of the control device and execution device. Apparatus control device B executes a power supply/demand adjustment process by controlling the charging and discharging of storage battery R2 that is connected to power grid R1.

Apparatus control device B includes determination unit A2, detection unit B1, communication units B2 and B3, and control unit B4.

Detection unit B1 detects the frequency of power grid R1. Power grid R1 is connected to another power grid R4 by way of linking line R3.

Communication unit B2 receives index i1 that is transmitted from an external device. The external device is, for example, a load dispatching unit that implements power generation such as a power company or a PPS.

Communication unit B3 is an example of the reception unit. Communication unit B3 receives specification information (LFC identification information or GF identification information) that is transmitted from the external device.

Determination unit A2 determines, as the usage information, the frequency of power grid R1 that was detected by detection unit B1 or index i1 that was received by communication unit B2 according to the power supply/demand adjustment process that is specified in the specification information.

In addition, determination unit A2 determines, as the usage information, operation control information for causing storage battery R2 to execute the power supply/demand adjustment process that is specified in the specification information. Each item of operation control information that corresponds to each power supply/demand adjustment process stipulates the control method of storage battery R2 that accords with the corresponding power supply/demand adjustment process. Each item of operation control information may be changed according to the state of the supply and demand adjustment device (storage battery), the chargeable/dischargeable capacity of the storage battery, and the allotment amount of each storage battery in the entire adjustment amount that is determined on the basis of the power adjustment amount.

Control unit B4 controls the operation (charging and/or discharging) of storage battery R2 on the basis of the usage information that is determined in determination unit A2. Control unit B4 acquires operation control information from, for example, the external device by way of communication unit B2.

The operation of apparatus control device B is next described. Time slot information that indicates the execution time slot for implementing the power supply/demand adjustment process specified in specification information is added to the specification information.

FIG. 2B is a flow chart for describing the operation of apparatus control device B.

Communication unit B3 receives specification information to which time slot information has been appended (Step S201). Communication unit B3 next supplies determination unit A2 with the specification information to which the time slot information has been appended.

Determination unit A2, upon receiving the specification information to which the time slot information has been appended, determines, as the usage information, the frequency of power grid R1 or index i1 and the operation control information according to the power supply/demand adjustment process that is specified in the specification information (Step S202).

In Step S202, determination unit A2 determines index i1 and LFC operation control information that accords with an LFC adjustment process as the usage information when the specification information is LFC identification information. On the other hand, determination unit A2 determines the frequency of power grid R1 and GF operation control information that accords with a GF adjustment process as the usage information when the specification information is GF identification information.

Determination unit A2 next supplies the determination result of the usage information and the time slot information to control unit B4.

Control unit B4, upon receiving the determination result of the usage information and the time slot information, retains the determination result of the usage information and the time slot information.

Then, when the current time becomes the starting time of the execution time slot indicated by the time slot information (Step S203), control unit B4 acquires the usage information indicated by the determination result of the usage information (Step S204).

In Step S204, control unit B4 acquires the most recent index i1 that was received by communication unit B2 and the most recent LFC operation control information when the usage information is index i1 and LFC operation control information. On the other hand, when the usage information is the frequency of power grid R1 and GF operation control information, control unit B4 acquires the most recent frequency of power grid R1 detected by detection unit B1 and the most recent GF operation control information received by communication unit B2.

The operation of communication unit B2 and detection unit B1 is here described. Communication unit B2 receives LFC operation control information at period T1_{LFC}.

Communication unit B2 further receives GF operation control information at period T1_{GF}. Detection unit B1 detects the frequency of power grid R1 at period T2. Communication unit B2 receives index i1 at period T3.

Period T1_{LFC} is longer than period T3. Period T1_{GF} is longer than period T2. Period T1_{LFC} is longer than period T1_{GF}. Period T3 is longer than period T2.

Period T2 is, for example, from 0.5 seconds to 1 second. Period T3 is, for example, from several seconds to less than twenty seconds. Period T1_{GF} is, for example, from several minutes but less than twenty minutes. Period T1_{LFC} is, for example, from several minutes up to less than twenty minutes.

Control unit B4 next controls the operation (charging and/or discharging) of storage battery R2 on the basis of the usage information (Step S205).

In Step S205, control unit B4 controls the operation of storage battery R2 on the basis of index i1 and LFC operation control information when the usage information is index i1 and LFC operation control information. The LFC adjustment process is executed by means of this control.

FIG. 2C shows an example of LFC operation control information. As shown in FIG. 2C, when the LFC operation control information represents the relation between index i1 and adjustment amount (LFC adjustment power amount) in storage battery R2, control unit B4 operates as shown below. An LFC adjustment power amount that is a positive value signifies charging in storage battery R2. An LFC adjustment power amount that is a negative value signifies discharging in storage battery R2.

Control unit B4 first uses the LFC operation control information to specify the LFC adjustment power amount (hereinbelow referred to as the “corresponding LFC adjustment power amount”) corresponding to index i1. Control unit B4 next executes charging of the corresponding LFC adjustment power amount to storage battery R2 when the corresponding LFC adjustment power amount is a positive value. On the other hand, when the corresponding LFC adjustment power amount is a negative value, control unit B4 executes discharging of the corresponding LFC adjustment power amount from storage battery R2.

Alternatively, in Step S205, control unit B4 controls the operation of storage battery R2 on the basis of the frequency of power grid R1 and GF operation control information when the usage information is the frequency of power grid R1 and GF operation control information.

The GF adjustment process is executed by means of this control.

FIG. 2D shows an example of GF operation control information. When the GF operation control information as shown in FIG. 2D represents the relation between frequency deviation in power grid R1 and adjustment power amount (GF adjustment power amount) in storage battery R2, control unit B4 operates as shown below. A GF adjustment power amount of a positive value signifies charging of storage battery R2. Alternatively, a GF adjustment power amount of a negative value means discharging of storage battery R2.

Control unit B4 first uses the GF operation control information to specify the GF adjustment power amount (hereinbelow referred to as “corresponding GF adjustment power amount”) that corresponds to the frequency deviation at power grid R1. Control unit B4 next executes charging of the corresponding GF adjustment power amount to storage battery R2 when the corresponding GF adjustment power amount is a positive value. On the other hand, control unit B4 executes discharging of the corresponding GF adjustment power amount from storage battery R2 when the corresponding GF adjustment power amount is a negative value.

Control unit B4 next returns the process to Step S204 if the current time is not the end time of the execution time slot indicated by the time slot information (Step S206).

On the other hand, if the current time has become the end time in Step S206, control unit B4 ends (power supply/demand adjustment process) the control of storage battery R2.

The effect of the present exemplary embodiment is next described.

In the present exemplary embodiment, determination unit A2 determines the frequency of the power grid that is detected in detection unit B1 or index i1 that is received in communication unit B2 as the usage information according to the power supply/demand adjustment process that is specified in the specification information.

As a result, either information (the frequency of power grid R1) that is detected by apparatus control device B or information (index i1) that is received by apparatus control device B can be determined as the information (usage information) that is used in the power supply/demand adjustment process.

In addition, apparatus control device B is able to acquire different information (the frequency of the power grid and index i1) by a different method. As a result, apparatus control device B is able to acquire the information by an appropriate method.

For example, when index i1 is determined on the basis of the frequency of power grid R1 and the flow in linking line R3, index i1 is information that cannot be acquired despite investigating power grid R1. Apparatus control device B is therefore able to acquire index i1 that cannot be acquired even when power grid R1 is checked by receiving index i1 that is transmitted from an external device.

Determination unit A2 determines index i1 and LFC operation control information as usage information when the power supply/demand adjustment process specified in the specification information is the LFC adjustment process.

As a result, the LFC adjustment process can be executed by using usage information that is appropriate to the LFC adjustment process. The LFC adjustment process can therefore be executed accurately.

Determination unit A2 determines the frequency of power grid R1 and GF operation control information as the usage information when the power supply/demand adjustment process specified in the specification information is a GF adjustment process.

As a result, the GF adjustment process can be executed using usage information that is appropriate to the GF adjustment process. The GF adjustment process can therefore be executed accurately.

Modifications of the present exemplary embodiment are next described.

Communication unit B2 or B3 may receive specification information, index i1 and operation control information.

FIG. 2E shows apparatus control device BB in which communication unit B3 receives specification information, index i1 and operation control information. In FIG. 2E, components that constitute constructions that are identical to components shown in FIG. 2A are given the same reference numbers. The following explanation regarding apparatus control device BB shown in FIG. 2E focuses on points that differ from apparatus control device B shown in FIG. 2A.

In FIG. 2E, communication unit B3 receives specification information that is transmitted from power control device T. Power control device T is an example of an external device. Communication unit B3 supplies the specification information to determination unit A2.

In addition, communication unit B3 receives index i1 and operation control information (LFC operation control information and GF operation control information) transmitted from power control device T. Communication unit B3 supplies index i1 and the operation control information to control unit B4. The reception period of both index i1 and operation control information in communication unit B3 is similar to the reception periods of both index i1 and operation control information in communication unit B2.

The operations of determination unit A2, detection unit B1, and control unit B4 within apparatus control device BB are similar to the operations of determination unit A2, detection unit B1, and control unit B4 within apparatus control device B shown in FIG. 2A.

In apparatus control device BB, communication unit B3 receives specification information, index i1 and operation control information. As a result, apparatus control device BB is able to achieve simplification of its configuration compared to apparatus control device B that receives specification information, index i1 and operation control information by different communication units.

When communication unit B2 or B3 receives specification information, index i1 and operation control information, the following reception method may be used.

In the case of an LFC adjustment process, communication unit B2 or B3 receives index i1 at period T3 and receives LFC operation control information at period T1_{LFC}. As a result, communication unit B2 or B3 successively receives index i1 at intervals of period T3 and receives LFC operation control information together with index i1 at the timing at which the reception of index i1 reaches a predetermined number (the timing of T1_{LFC}) as in (i1, i1, . . . , i1+LFC operation control information).

Communication unit B2 or B3 then carries out communication by successively receiving index i1 at intervals of period T3 as described above and by receiving LFC operation control information together with index i1 at the timing of the passage of period T1_{LFC}.

In the case of a GF adjustment process, an operation is implemented to detect the frequency of the power grid at a short interval of period T2 and then to receive GF operation control information upon reaching the timing of the passage of period T1_{GF}.

Power control device T may change the LFC operation control information and GF operation control information according to the state (temperature, voltage, residual amount of power storage, etc.) of storage battery R2 that is controlled by apparatus control device BB.

For example, power control device T receives from apparatus control device BB the chargeable/dischargeable capacity of storage battery R2 (including specifications such as the output of the PCS (power conditioner) or the capacity of the storage battery that is to be supplied according to a contract by the owner of the storage battery). The chargeable/dischargeable capacity of storage battery R2 is an example of the state of storage battery R2.

Power control device T next generates LFC operation control information and GF operation control information according to the chargeable/dischargeable capacity of storage battery R2.

For example, power control device T generates LFC operation control information and GF operation control information such that the adjustment power amount in storage battery R2 in an LFC adjustment process or GF adjustment process (see FIG. 2C and FIG. 2D) is no greater than the chargeable/dischargeable capacity of storage battery R2.

In addition, power control device T may change the LFC operation control information and GF operation control information according to a power adjustment amount that has been undertaken by power control device T (for example, the power adjustment amount that has been delegated from a power company or the power adjustment amount that was successfully bid on a power exchange market).

For example, power control device T generates LFC operation control information or GF operation control information such that the adjustment power amount in storage battery R2 in an LFC adjustment process or GF adjustment process (see FIG. 2C and FIG. 2D) matches the power adjustment amount undertaken by power control device T.

When power control device T controls a plurality of apparatus control devices BB, power control device T may generate LFC operation control information for each apparatus control device BB such that the total amount of the adjustment power amounts in storage batteries R2 in the LFC adjustment process matches the power adjustment amount undertaken by power control device T for all of the plurality of apparatus control devices BB.

In addition, when power control device T controls a plurality of apparatus control devices BB, power control device T may generate GF operation control information for each apparatus control device BB such that the total amount of adjustment power amounts in storage batteries R2 in the GF adjustment process matches the power adjustment amount undertaken by power control device T for all of the plurality of apparatus control devices BB.

In FIG. 2A and FIG. 2E, storage battery R2 is provided outside the apparatus control device, but storage battery R2 may also be incorporated in the apparatus control device.

FIG. 2F shows apparatus control device B that incorporates storage battery R2.

FIG. 2G shows apparatus control device BB that incorporates storage battery R2.

Apparatus control device B or BB that incorporates storage battery R2 is an example of a power storage device.

### Third Exemplary Embodiment

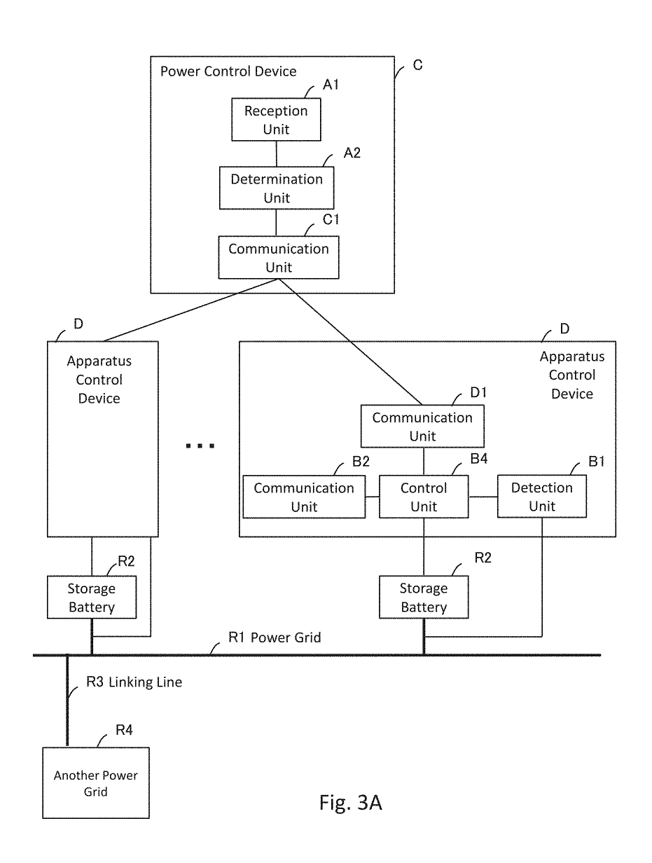

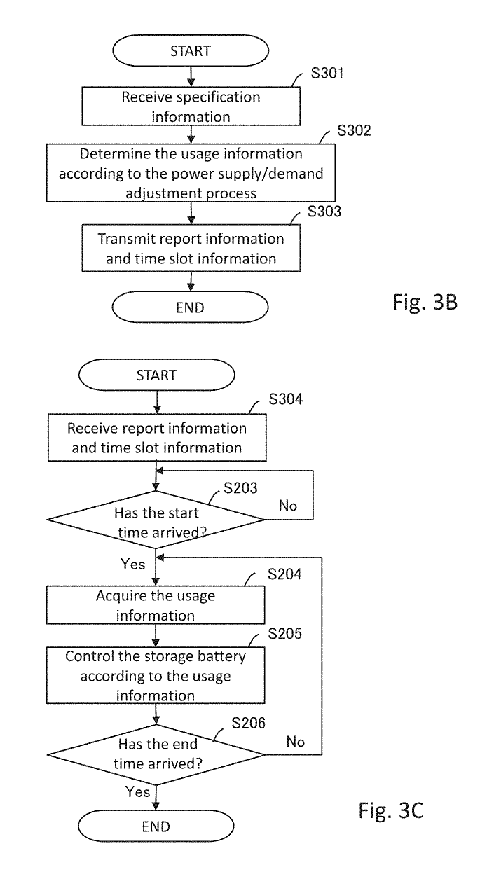

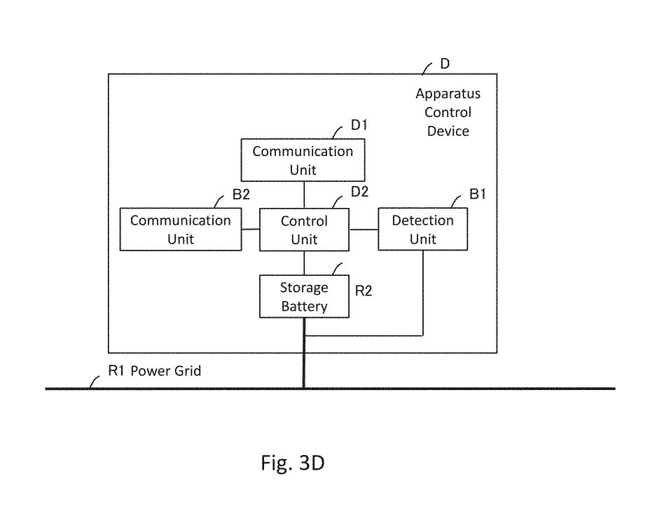

FIG. 3A shows power control device C of the third exemplary embodiment of the present invention. In FIG. 3A, components having the same configuration as components shown in FIGS. 1A, 2A and 2E are given the same reference numbers.

In the third exemplary embodiment, power control device C that is provided with the functions belonging to control device A shown in the first exemplary embodiment reports report information that specifies usage information to each apparatus control device D that functions as an execution device.

The chief point of difference between power control device C of the third exemplary embodiment and control device A of the first exemplary embodiment is the provision of communication unit C in power control device C of the third exemplary embodiment. The following explanation of the third exemplary embodiment focuses on the point of difference with the first exemplary embodiment.

Power control device C is an example of a control device. Power control device C transmits to apparatus control device D report information that specifies usage information for causing apparatus control device D to execute a power supply/demand adjustment process.

Power control device C includes reception unit A1, determination unit A2 and communication unit C1.

In the present exemplary embodiment, determination unit A2 determines index i1 and LFC operation control information as usage information when the specification information is LFC identification information. On the other hand, determination unit A2 determines the frequency of power grid R1 and GF operation control information as the usage information when the specification information is GF identification information.

Communication unit C1 is an example of the report unit. Communication unit C1 reports, to each apparatus control device D, report information that specifies the usage information that was determined by determination unit A2 (for example, the name or identifier of each item of usage information).

Each apparatus control device D includes detection unit B1, communication unit B2, control unit B4 and communication unit D1.

Communication unit D1 receives report information from power control device C.

The operation of the third exemplary embodiment is next described.

The operation of power control device C is first described. Time slot information that indicates an execution time slot in which the power supply/demand adjustment process specified in specification information is to be executed is appended to the specification information.

FIG. 3B is a flow chart for describing the operation of power control device C.

Reception unit A1 receives specification information to which time slot information has been appended (Step S301). Reception unit A1 next supplies determination unit A2 with the specification information to which the time slot information has been appended.

Determination unit A2, having received the specification information to which time slot information has been appended, determines as the usage information the operation control information and the frequency of power grid R1 or index i1 according to the power supply/demand adjustment process that is specified in the specification information (Step S302).

In Step S302, determination unit A2 determines index i1 and LFC operation control information as the usage information if the specification information is LFC identification information. On the other hand, determination unit A2 determines the frequency of power grid R1 and GF operation control information as the usage information if the specification information is GF identification information.

Determination unit A2 next supplies the determination result of the usage information and the time slot information to communication unit C1.

Communication unit C1, upon receiving the determination result of the usage information and the time slot information, transmits report information that specifies the usage information and the time slot information to each of apparatus control devices D (Step S303).

The operation of apparatus control device D is next described.

FIG. 3C is a flow chart for describing the operation of apparatus control device D. In FIG. 3C, processes similar to processes shown in FIG. 2B are given the same reference numbers.

Communication unit D1 receives the report information and time slot information from power control device C (Step S304).

Communication unit D1 next supplies the report information and time slot information to control unit B4.

Control unit B4, upon receiving the report information and time slot information, executes Step S203. Steps S204-S206 are subsequently executed.

The effect of the present exemplary embodiment is next described.

Determination unit A2 of power control device C determines the frequency of power grid R1 or index i1 as usage information according to the power supply/demand adjustment process that is specified in the specification information. Communication unit C1 then reports the report information that specifies the usage information to apparatus control device D.

As a result, apparatus control device D is able to use usage information that is appropriate to the power supply/demand adjustment process to bring about execution of the power supply/demand adjustment process.

Communication unit D1 of apparatus control device D receives the report information. Control unit D2 uses the usage information that is specified in the report information to control storage battery R2.

As a result, apparatus control device D is able to use usage information that is appropriate to the power supply/demand adjustment process to execute the power supply/demand adjustment process.

Modifications of the present exemplary embodiment are next described.

Power control device C may transmit to apparatus control device D LFC operation control information or GF operation control information. In this case, power control device C may generate LFC operation control information or GF operation control information.

Further, power control device C, similar to power control device T, may change the LFC operation control information or GF operation control information according to the state (such as temperature, voltage, or residual amount of stored power) of storage battery R2 that apparatus control device D controls.

In addition, power control device C, similar to power control device T, may change the LFC operation control information or GF operation control information according to the power adjustment amount undertaken by power control device C (for example, the power adjustment amount that has been delegated from a power company or the power adjustment amount that was successfully bid on a power exchange market).

Further, power control device C may change the LFC operation control information or GF operation control information according to the chargeable/dischargeable capacity (including specifications such as the PCS output or the storage battery capacity that the storage battery owner is to supply according to a contract).

Although storage battery R2 is provided outside apparatus control device D in FIG. 3A, storage battery R2 may also be incorporated in apparatus control device D.

FIG. 3D shows apparatus control device D that incorporates storage battery R2. Apparatus control device D that incorporates storage battery R2 is an example of a power storage device.

### Fourth Exemplary Embodiment

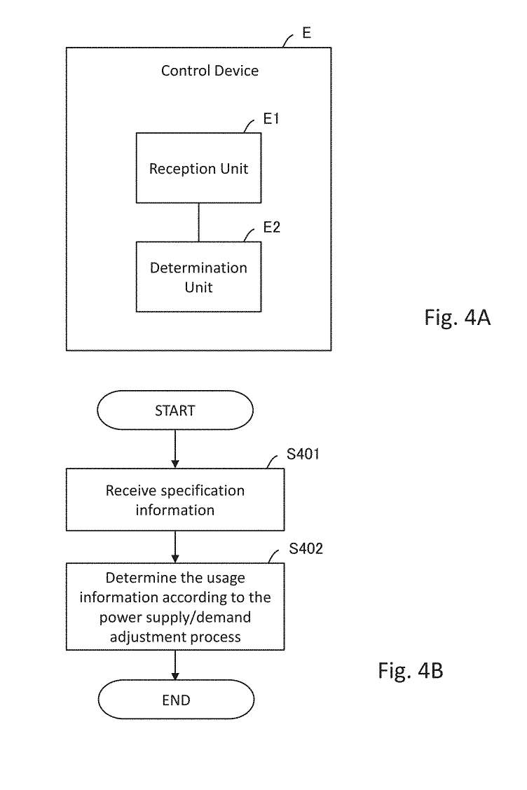

FIG. 4A shows control device E of the fourth exemplary embodiment of the present invention.

The chief point of difference between the fourth exemplary embodiment and the first exemplary embodiment is that in the fourth exemplary embodiment, control device E determines usage information according to five types of power supply/demand adjustment processes (a GF adjustment process, first LFC adjustment process, second LFC adjustment process, difference adjustment process and instantaneous adjustment process).

Here, the first LFC adjustment process means an LFC adjustment process in a power grid to which a linking line is not connected (such as the case of an island in which there are no linking lines at all, or an LFC adjustment process that, despite the existence of a linking line, uses the frequency of the power grid but that does not use the flow of the linking line, for example, carrying out frequency adjustment by an FFC (Flat Frequency Control) method.

The second LFC adjustment process means an LFC adjustment process in a power grid to which a linking line is connected (an LFC adjustment process that uses the frequency of the power grid and the flow of the linking line such as when the amount of linking line flow is great and the frequency adjustment is carried out by a TBC (Tie Line Bias) method.

The difference adjustment process means a power supply/demand adjustment process that adjusts the difference between a target value in a predetermined interval and power supply amount or power demand amount in the predetermined interval. For example, the difference adjustment process means a power supply/demand adjustment process that carries out control such that, in a time interval that has been divided into predetermined time intervals, the difference between demand and supply is kept within a predetermined amount.

A balancing process can be offered as an example of the difference adjustment process. A balancing process refers to a power supply/demand adjustment process that causes a power supply amount or demand amount in a predetermined interval to coincide with a target value in the predetermined interval. For example, a balancing process is a process of causing the actual power supply amount in a thirty-minute time slot to coincide with a planned value that is the target value in the thirty-minute time slot. Further, as a balancing process, a process may also be used of causing the actual power demand amount in a thirty-minute time slot to coincide with the actual power supply amount that is the target value in that time slot. The thirty-minute time slot is an example of the predetermined interval. The predetermined interval is not limited to a thirty-minute time slot. For example, the predetermined interval may also be a one-minute time slot and can be altered as appropriate. Furthermore, the difference adjustment process is not limited to a balancing process and can be altered as appropriate.

An instantaneous adjustment process is a power supply/demand adjustment process of causing a storage battery to execute discharging in an emergency.

The fourth exemplary embodiment is next described with focus on the points of difference with the first exemplary embodiment.

Control device E includes reception unit E1 and determination unit E2.

Reception unit E1 receives GF identification information, first LFC identification information, second LFC identification information, balancing identification information and instantaneous identification information.

The GF identification information, first LFC identification information, second LFC identification information, balancing identification information and instantaneous identification information are each identification information of a GF adjustment process, identification information of a first LFC adjustment process, identification information of a second LFC adjustment process, identification information of a balancing process and identification information of an instantaneous adjustment process, respectively.

The GF identification information, first LFC identification information, second LFC identification information, balancing identification information and instantaneous identification information are each an example of information indicating characteristics of a power supply/demand adjustment process or specification information. In the following explanation, the GF identification information, first LFC identification information, second LFC identification information, balancing identification information and instantaneous identification information are also referred to as “specification information.”

Reception unit E1 supplies specification information to determination unit E2.

Determination unit E2 determines usage information according to the power supply/demand adjustment process that is specified in the specification information.

Determination unit E2 determines the frequency of the power grid as the usage information upon receiving GF identification information.

Determination unit E2 determines the frequency of the power grid as the usage information upon receiving first LFC identification information.

Determination unit E2 determines index i1 that was transmitted from a predetermined device by bidirectional communication or one-way communication as the usage information upon receiving second LFC identification information. The predetermined device is control device E or an external device (a device that differs from control device E). Determination unit E2 may determine index i1 that was transmitted from the predetermined device by 1-to-N bidirectional communication as the usage information upon receiving second LFC identification information.

Determination unit E2 determines index i2 that was transmitted from the predetermined device by 1-to-N bidirectional communication as the usage information upon receiving balancing identification information.

Index i2 is an index that is determined according to the difference between a planned power supply amount (target amount) in a predetermined interval (for example, a thirty-minute time slot) and the actual amount of power supplied in the predetermined interval. The predetermined interval is not limited to thirty minutes and can be altered as appropriate. Index i2 is an example of an index that relates to the power state. Index i2 is generated by subtracting the actual amount of power supplied in the predetermined interval from the planned power supply in the predetermined interval.

The planned value of the power supply amount that a PPS (Power Producer and Supplier) is to supply to a customer of the PPS is used as the planned power supply amount used for determining index i2. The actually measured value of the amount of generated power in the power generator maintained by the PPS or the actually measured value of the amount of generated power that the PPS can provide according to a contract is used as the actual power supply amount that is used for determining index i2. A value obtained by adding the actually measured value of the amount of generated power in the power generator maintained by the PPS and the actually measured value of the amount of generated power that the PPS can provide according to a contract may also be used as the actual power supply amount that is used for determining index i2. In particular, circumstances in which index i2 becomes great pertain to cases in which the majority of the generated power in a power generation unit that takes on the PPS power supply is provided by renewable energy such as solar power and wind power.

Upon receiving balancing identification information, determination unit E2 may determine index i2 that is transmitted from the predetermined device by bidirectional communication or one-way communication as the usage information.

Upon receiving instantaneous identification information, determination unit E2 determines the frequency of the power grid as the usage information.

The operation of the present exemplary embodiment is next described.

FIG. 4B is a flow chart for describing the operation of control device E.

Reception unit E1 receives specification information (Step S401). Reception unit E1 next supplies the specification information to determination unit E2.

Determination unit E2 next receives the specification information.

Determination unit E2 then determines, as the usage information, the frequency of the power grid, index i1, or index i2 according to the power supply/demand adjustment process that is specified in the specification information (Step S402).

In Step S402, determination unit E2 operates as shown below.

Determination unit E2 determines the frequency of the power grid as the usage information upon receiving GF identification information, first LFC identification information, or instantaneous identification information.

Determination unit E2 determines index i1 that was transmitted from an external device by bidirectional communication or one-way communication as the usage information upon receiving second LFC identification information.

Determination unit E2 determines index i2 that was transmitted from an external device by 1-to-N bidirectional communication as the usage information upon receiving balancing identification information.

The effect of the present exemplary embodiment is next described.

In the present exemplary embodiment, reception unit E1 receives specification information. Determination unit E2 determines the frequency of the power grid, index i1, or index i2 as the usage information according to the power supply/demand adjustment process that is specified in the specification information.

As a result, the usage information that is used in a power supply/demand adjustment process can be changed according to the power supply/demand adjustment process.

Accordingly, a power supply/demand adjustment process can be executed using usage information that is appropriate to the power supply/demand adjustment process, and the power supply/demand adjustment process can therefore be executed accurately.

Determination unit E2 determines the frequency of the power grid as the usage information when the power supply/demand adjustment process that is specified in the specification information is the first LFC adjustment process. Further, determination unit E2 determines index i1 as the usage information when the power supply/demand adjustment process specified in the specification information is the second LFC adjustment process.

As a result, the information (usage information) that is used in an LFC adjustment process can be switched as appropriate according to the circumstance of the use or non-use of linking line flow information, whereby the first LFC adjustment process and second LFC adjustment process can be executed accurately.

Determination unit E2 determines index i2 as the usage information when the power supply/demand adjustment process that is specified in the specification information is a balancing process.

As a result, a balancing process can be executed using information (index i2) that accords with the balancing process, whereby the balancing process can be executed accurately.

Determination unit E2 determines the frequency of the power grid as the usage information when the power supply/demand adjustment process specified by the specification information is an instantaneous adjustment process.

As a result, an instantaneous adjustment process can be executed using information (the frequency of the power grid) that accords with the instantaneous adjustment process, whereby the instantaneous adjustment process can be executed accurately.

Modifications of the present exemplary embodiment are next described.

Control device E may also function as an execution device. In this case, the predetermined device that transmits index i1 and index i2 is an external device (a device that differs from control device E). Control device E preferably controls the power supply/demand adjustment device on the basis of usage information and operation control information that accords with the power supply/demand adjustment process that is specified in the specification information.

Control device E may also report the specification information and report information that specifies the usage information to an execution device. The execution device uses the report information to specify the usage information. The execution device controls the power supply/demand adjustment device on the basis of usage information and operation control information that accords with the power supply/demand adjustment process that is specified in the specification information. In this case, control device E may be managed by, for example, an aggregator or the PPS.

### Fifth Exemplary Embodiment

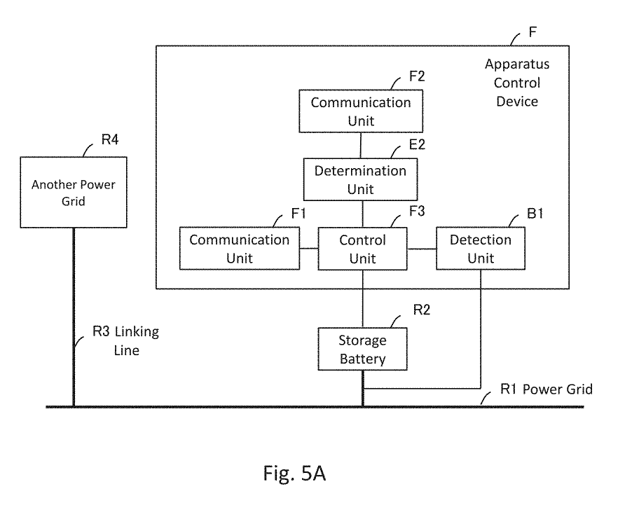

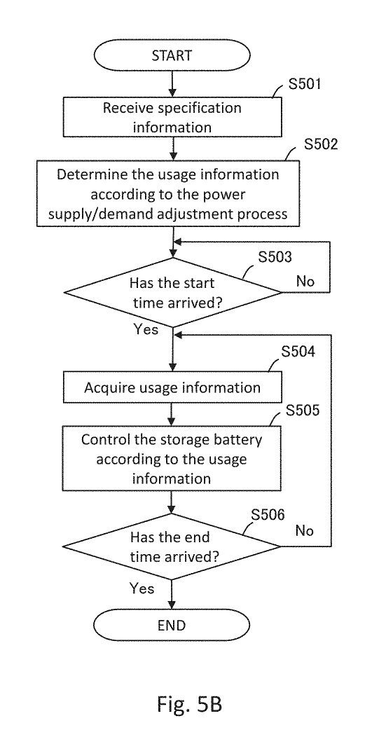

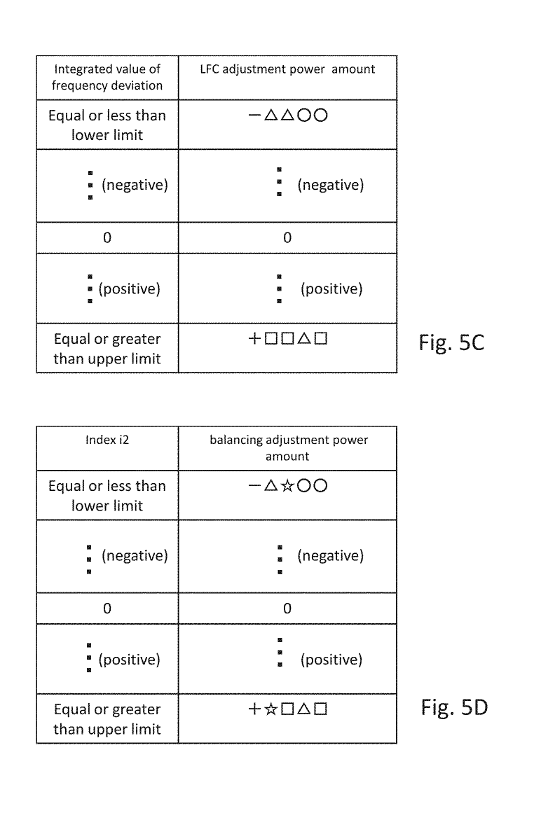

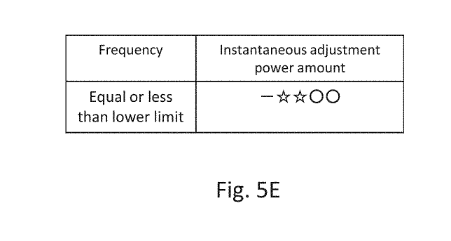

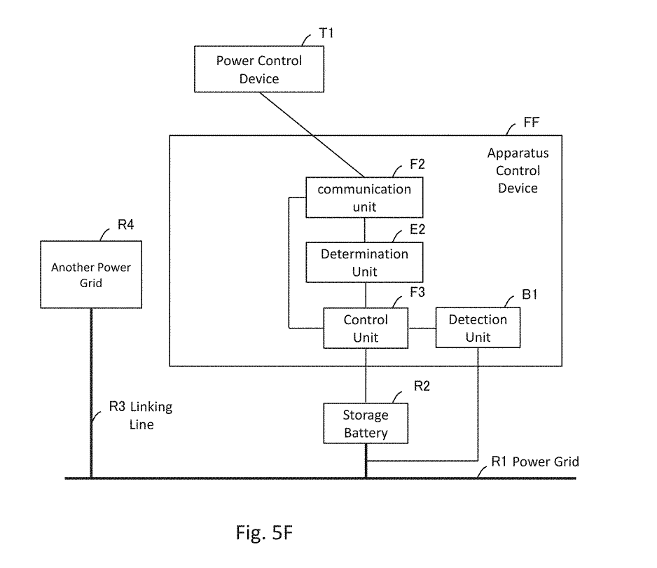

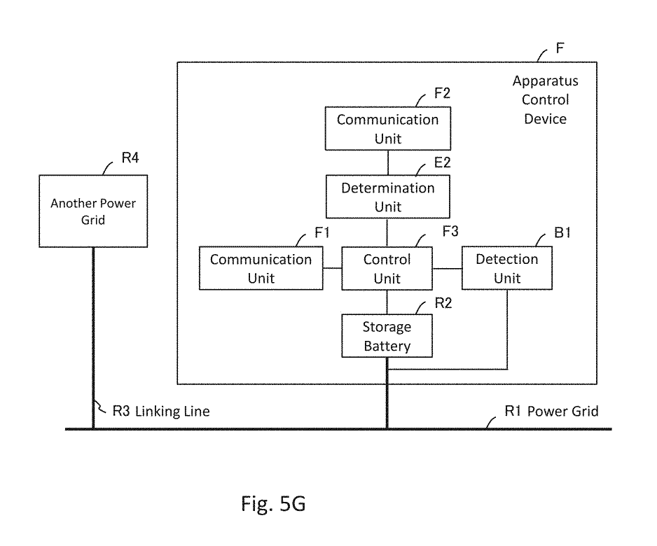

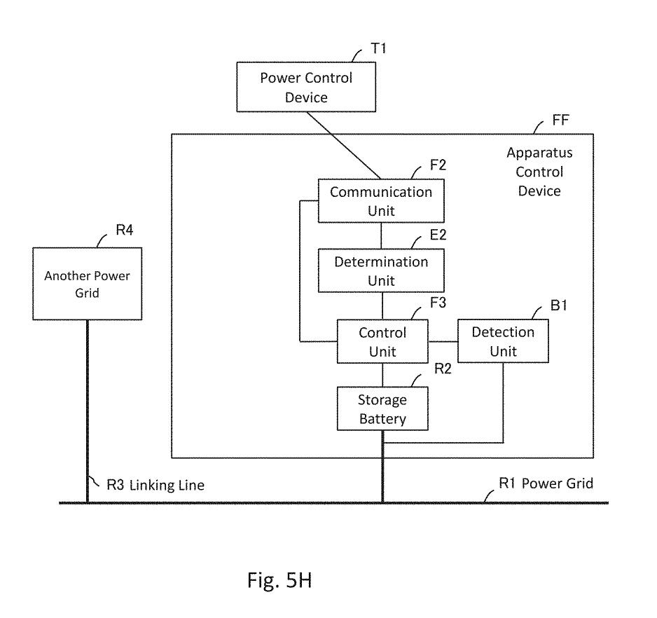

FIG. 5A shows apparatus control device F of the fifth exemplary embodiment of the present invention. In FIG. 5A, components that have a configuration that is identical to components shown in FIGS. 2A and 4A are given the same reference numbers.

In the fifth exemplary embodiment, apparatus control device F that is provided with the functions belonging to control device E shown in the fourth exemplary embodiment executes power supply/demand adjustment processes. The fifth exemplary embodiment is next described with focus upon the points of difference with the fourth exemplary embodiment.

Apparatus control device F is an example of a control device and an execution device. Apparatus control device F executes a power supply/demand adjustment process by controlling the charging and discharging of storage battery R2 that is connected to power grid R1.

Apparatus control device F includes determination unit E2, detection unit B1, communication units F1 and F2, and control unit F3.

Communication unit F1 receives index i1 and index i2 that are transmitted from an external device.

Communication unit F2 is an example of a reception unit. Communication unit F2 receives specification information (GF identification information, first LFC identification information, second LFC identification information, balancing identification information and instantaneous identification information) that is transmitted from an external device.

Determination unit E2 determines, as the usage information, either the frequency of power grid R1 that is detected by detection unit B1 or index i1 and index i2 that are received by communication unit F1 according to the power supply/demand adjustment process that is specified in the specification information.

In addition, determination unit E2 determines, as the usage information, operation control information for causing storage battery R2 to execute the power supply/demand adjustment process that is specified by the specification information.

Control unit F3 controls the operation (charging and discharging) of storage battery R2 on the basis of the usage information that was determined by determination unit E2. Control unit F3 receives operation control information from, for example, an external device by way of communication unit F1.

The operation of apparatus control device F is next described. Time slot information that indicates an execution time slot in which the power supply/demand adjustment process specified in the specification information is to be executed is appended to the specification information.

FIG. 5B is a flow chart for describing the operation of apparatus control device F.

Communication unit F2 receives specification information to which time slot information has been appended (Step S501). Communication unit F2 next supplies the specification information to which the time slot information has been appended to determination unit E2.

Determination unit E2, upon receiving the specification information to which the time slot information has been appended, determines, as the usage information, operation control information and frequency of power grid R1 or index i1 or index i2 according to the power supply/demand adjustment process that is specified in the specification information (Step S502).

In Step S502, determination unit E2 determines as the usage information the GF operation control information and the frequency of power grid R1 when the specification information is GF identification information.

When the specification information is first LFC identification information, determination unit E2 determines the frequency of power grid R1 and first LFC operation control information that accords with the first LFC adjustment process as the usage information.

When the specification information is second LFC identification information, determination unit E2 determines index i1 and second LFC operation control information that accords with the second LFC adjustment process as the usage information.

When the specification information is balancing identification information, determination unit E2 determines index i2 and operation control information (hereinbelow referred to as “BL operation control information”) that accords with the balancing process as the usage information.

When the specification information is instantaneous identification information, determination unit E2 determines the frequency of power grid R1 and operation control information (hereinbelow referred to as “MO operation control information”) that accords with the instantaneous adjustment process as the usage information.

Determination unit E2 next supplies the determination result of the usage information and the time slot information to control unit F3.

Control unit F3, upon receiving the determination result of the usage information and the time slot information, holds the determination result of the usage information and the time slot information.

Then, when the current time becomes the starting time of the execution time slot indicated by the time slot information (Step S503), control unit F3 acquires the usage information indicated by the determination result of the usage information (Step S504).

In Step S504, control unit F3 acquires the most recent frequency of power grid R1 that was detected by detection unit B1 and the most recent GF operation control information that was received by communication unit F1 when the usage information is the frequency of power grid R1 and GF operation control information.

Alternatively, when the usage information is the frequency of power grid R1 and the first LFC operation control information, control unit F3 acquires the most recent frequency of power grid R1 that was detected by detection unit B1 and the most recent first LFC operation control information that was received by communication unit F1.

When the usage information is index i1 and second LFC operation control information, control unit F3 acquires the most recent index i1 and the most recent second LFC operation control information that were received by communication unit F1.

When the usage information is index i2 and BL operation control information, control unit F3 acquires the most recent index i2 and the most recent BL operation control information that were received by communication unit F1.

When the usage information is the frequency of power grid R1 and MO operation control information, control unit F3 acquires the most recent frequency of power grid R1 that was detected by detection unit B1 and the most recent MO operation control information that was received by communication unit F1.

The operation of communication unit F1 and detection unit B1 is next described.

Communication unit F1 receives GF operation control information at period T1_{GF}.

Communication unit F1 receives first LFC operation control information at period T1_{firstLFC}.

Communication unit F1 receives second LFC operation control information at period T1_{SecondLFC}.

Communication unit F1 receives BL operation control information at period T1_{BL}.

Communication unit F1 receives MO operation control information at period T1_{MO}.

Detection unit B1 detects the frequency of power grid R1 at period T2_{GF} according to operation instructions from control unit F3 when the usage information is the frequency of power grid R1 and GF operation control information.

Detection unit B1 detects the frequency of power grid R1 at period T2_{FirstLFC} according to the operation instructions from control unit F3 when the usage information is the frequency of power grid R1 and first LFC operation control information.

Detection unit B1 detects the frequency of power grid R1 at period T2_{MO} according to operation instructions from control unit F3 when the usage information is the frequency of power grid R1 and MO operation control information.

Communication unit F1 receives index i1 at period T3_{SecondLFC}.

Communication unit F1 receives index i2 at period T3_{BL}.

Period T1_{GF} is here longer than period T2_{GF}.

Period T1_{FirstLFC} is longer than period T2_{FirstLFC}.

Period T1_{SecondLFC} is longer than period T3_{SecondLFC}.

Period T1_{BL} is longer than period T3_{BL}.

Period T1_{MO} is longer than period T2_{MO}.

Each period may be variable, as long as the size relation of the above-described periods is maintained.

In addition, period T_{FirstLFC} may be the same as period T1_{SecondLFC}. Period T2_{FirstLFC} may be the same as period T3_{SecondLFC}.

Control unit F3 next controls the operation (charging and discharging) of storage battery R2 on the basis of the usage information (Step S505).

Step S505 is next described.

The operation is described for a case in which the usage information is the frequency of power grid R1 and GF operation control information (for example, the GF operation control information shown in FIG. 2D).

In this case, control unit F3 controls the operation of storage battery R2 on the basis of the frequency of power grid R1 and the GF operation control information. The GF adjustment process is executed under this control.

For example, when the GF operation control information as shown in FIG. 2D represents the relation between the frequency deviation in power grid R1 and the GF adjustment power amount in storage battery R2, control unit controls the operation of storage battery R2 similarly to control unit B4 shown in FIG. 2A.

The operation is next described for a case in which the usage information is the frequency of power grid R1 and first LFC operation control information.

In this case, control unit F3 controls the operation of storage battery R2 on the basis of the frequency of power grid R1 and the first LFC operation control information. The first LFC adjustment process is executed by means of this control.

FIG. 5C shows an example of first LFC operation control information. When the first LFC operation control information as shown in FIG. 5C represents the relation between the integrated value of the frequency deviation and the LFC adjustment power amount in storage battery R2, control unit F3 operates as shown below. An LFC adjustment power amount of a positive value means charging in storage battery R2. An LFC adjustment power amount of a negative value means discharging in storage battery R2.

Control unit F3 first uses the first LFC operation control information to specify the LFC adjustment power amount (corresponding the LFC adjustment power amount) that corresponds to the integrated value of the frequency deviation in power grid R1. Control unit F3 next executes charging of the corresponding LFC adjustment power amount to storage battery R2 when the corresponding LFC adjustment power amount is a positive value. On the other hand, control unit F3 executes discharging of the corresponding LFC adjustment power amount from storage battery R2 when the corresponding LFC adjustment power amount is a negative value.

The operation is next described for a case in which the usage information is index i1 and second LFC operation control information (for example, the LFC operation control information shown in FIG. 2C).

In this case, control unit F3 controls the operation of storage battery R2 on the basis of index i1 and the second LFC operation control information. The second LFC adjustment process is executed by means of this control.

For example, when the second LFC operation control information represents the relation between index i1 and the LFC adjustment power amount in storage battery R2 as shown in FIG. 2C, control unit F3 controls the operation of storage battery R2 similarly to control unit B4 shown in FIG. 2A.

The operation is next described for a case in which the usage information is index i2 and BL operation control information.

In this case, control unit F3 controls the operation of storage battery R2 on the basis of index i2 and BL operation control information. A balancing process is executed by means of this control.

FIG. 5D shows an example of BL operation control information. When the BL operation control information represents the relation between index i2 and the balancing adjustment power amount in storage battery R2 as shown in FIG. 5D, control unit F3 operates as shown below. A positive value balancing adjustment power amount means charging in storage battery R2. On the other hand, a negative value balancing adjustment power amount means discharging in storage battery R2.

Control unit F3 first uses the BL operation control information to specify the balancing adjustment power amount that corresponds to index i2 (hereinbelow referred to as the “corresponding balancing adjustment power amount”). Control unit F3 next executes charging of the corresponding balancing adjustment power amount to storage battery R2 when the corresponding balancing adjustment power amount is a positive value. On the other hand, Control unit F3 executes discharging of the corresponding balancing adjustment power amount from storage battery R2 when the corresponding balancing adjustment power amount is a negative value.

The operation is next described for a case in which the usage information is the frequency of power grid R1 and MO operation control information.

In this case, control unit F3 controls the operation of storage battery R2 on the basis of the frequency of power grid R1 and the MO operation control information. An instantaneous adjustment process is executed by means of this control.

FIG. 5E shows an example of MO operation control information. When the MO operation control information represents the relation between the frequency of power grid R1 and the instantaneous adjustment power amount in storage battery R2 as shown in FIG. 5E, control unit F3 operates as shown below.

Control unit F3 first uses the MO operation control information to specify the instantaneous adjustment power amount (the corresponding instantaneous adjustment power amount) that corresponds to the frequency of power grid R1. When the MO operation control information shown in FIG. 5E is used, control unit F3 specifies the corresponding instantaneous adjustment power amount when the frequency of power grid R1 is equal to or less than the minimum value of a predetermined time (for example, 5 seconds).

Control unit F3 next executes discharging of the corresponding instantaneous adjustment power amount to storage battery R2 when the corresponding instantaneous adjustment power amount is specified.

Following Step S505, control unit F3 returns the process to Step S504 if the current time is not the ending time of the execution time slot indicated by the time slot information (Step S506).

On the other hand, when the current time is the ending time in Step S506, control unit F3 ends the control (power supply/demand adjustment process) of storage battery R2.

The effect of the present exemplary embodiment is next described.

In the present exemplary embodiment, determination unit E2 determines, as the usage information, either the frequency of the power grid that is detected by detection unit B1 or index i1 and index i2 that is received by communication unit F1 according to the power supply/demand adjustment process that is specified in the specification information.

As a result, either the information detected by apparatus control device F (the frequency of the power grid) or the information received by apparatus control device F (an index) can be determined as the information that is to be used in the power supply/demand adjustment process.

In addition, apparatus control device F is able to receive different usage information by different methods. As a result, apparatus control device F is able to receive the usage information by a method that is appropriate to the usage information.

Control unit F3 executes a GF adjustment process on the basis of the frequency of power grid R1 and GF operation control information when the power supply/demand adjustment process specified in the specification information is a GF adjustment process.

As a result, the GF adjustment process can be executed using information that is appropriate to the GF adjustment process (the frequency of power grid R1 and GF operation control information), whereby the GF adjustment process can be executed accurately.

Control unit F3 executes the first LFC adjustment process on the basis of the frequency of power grid R1 and first LFC operation control information when the power supply/demand adjustment process specified in the specification information is the first LFC adjustment process.

As a result, the first LFC adjustment process can be executed using information that is appropriate to the first LFC adjustment process (the frequency of power grid R1 and first LFC operation control information), whereby the first LFC adjustment process can be executed accurately.

Control unit F3 executes a second LFC adjustment process on the basis of index i1 and second LFC operation control information when the power supply/demand adjustment process specified in the specification information is the second LFC adjustment process.

As a result, the second LFC adjustment process can be executed using information that is appropriate to the second LFC adjustment process (index i1 and second LFC operation control information), whereby the second LFC adjustment process can be executed accurately.

Control unit F3 executes a balancing process on the basis of index i2 and BL operation control information when the power supply/demand adjustment process specified in the specification information is a balancing process.

As a result, the balancing process can be executed using information that is appropriate to the balancing process (index i2 and BL operation control information), whereby the balancing process can be executed accurately.

Control unit F executes an instantaneous adjustment process on the basis of the frequency of power grid R1 and MO operation control information when the power supply/demand adjustment process specified in the specification information is the instantaneous adjustment process.

As a result, the instantaneous adjustment process can be executed using information that is appropriate to the instantaneous adjustment process (the frequency of power grid R1 and MO operation control information), whereby the instantaneous adjustment process can be executed accurately.

Modifications of the present exemplary embodiment are next described.

Communication unit F1 or F2 may also receive each item of specification information, each index, and each item of operation control information.

Communication unit F1 or F2 may also use a reception method, for example, as described hereinbelow, when receiving specification information, index i1 and index i2, and operation control information.

In the case of a second LFC adjustment process, communication unit F1 or F2 receives index i1 at period T3_{SecondLFC} and receives second LFC operation control information at period T1_{SecondLFC}. As a result, Communication unit F1 or F2 successively receives index i1 at intervals of period T3_{SecondLFC} and then receives index i1 and second LFC operation control information together at the timing (the timing T1_{SecondLFC}) at which the number of receptions of index i1 reaches a predetermined number, as in: (i1, i1, . . . , i1+second LFC operation control information).

Communication unit F1 or F2 then performs communication of successively receiving index i1 at intervals of period T3_{SecondLFC} as described above, and at the timing at which period T1_{SecondLFC} has elapsed, receiving index i1 together with second LFC operation control information.

In the case of a balancing process, communication unit F1 or F2 receives index i2 at period T3_{BL} and receives BL operation control information at period T1_{BL}. As a result, communication unit F1 or F2 successively receives index i2 at intervals of period T3_{BL} and then receives index i2 together with BL operation control information at the timing (the timing T1_{BL}) at which the number of receptions of index i2 reaches a predetermined number, as in: (i2, i2, . . . , i2+BL operation control information).

Communication unit F1 or F2 then carries out communication of successively receiving index i2 at intervals of period T3_{BL} as described above, and then receiving index i2 together with BL operation control information at the timing at which period T1_{BL} has elapsed.

In the case of a GF adjustment process, an operation is implemented of detecting the frequency of the power grid at a short interval of period T2_{GF} and then receiving GF operation control information upon reaching the timing at which period T1_{GF} has elapsed.

In the case of the first LFC adjustment process, an operation is carried out of detecting the frequency of the power grid at a short interval of period T2_{FirstLFC} and then receiving first LFC operation control information upon reaching the timing at which period T1_{FirstLFC} has elapsed.

In the case of an instantaneous adjustment process, an operation is carried out of detecting the frequency of the power grid at short intervals of period T2_{MO} and then receiving MO operation control information upon reaching the timing at which period T1_{MO} has elapsed.

FIG. 5F shows apparatus control device FF in which communication unit F2 receives specification information, each index, and each item of operation control information. In FIG. 5F, components of the same configuration as shown in FIG. 5A are given the same reference numbers. Apparatus control device FF shown in FIG. 5F is next described with focus upon points of difference with apparatus control device F shown in FIG. 5A.

In FIG. 5F, communication unit F2 receives specification information that is transmitted from power control device T1. Power control device T1 is an example of an external device.

Communication unit F2 supplies the specification information to determination unit E2.

In addition, communication unit F2 receives each item of operation control information and index i1 and index i2 transmitted from power control device T1. Communication unit F2 supplies index i1 and index i2 as well as each item of operation control information to control unit F3. The reception period of each item of operation control information and each index at communication unit F2 is the same as the reception period of each item of operation control information and each index in communication unit F1.

The operations of determination unit E2, detection unit B1, and control unit F3 in apparatus control device FF are the same as the operations of determination unit E2, detection unit B1 and control unit F3 in apparatus control device F in FIG. 5A.

In apparatus control device FF, communication unit F2 receives specification information, each index and each item of operation control information. As a result, apparatus control device FF is able to achieve a simplification of configuration compared to apparatus control device F that receives the specification information and each index and each item of operation control information in separate communication units.

Power control device T1 may also alter the GF operation control information, first LFC operation control information, second LFC operation control information, BL operation control information and MO operation control information according to the state (such as the temperature, voltage, residual amount of stored power) of storage battery R2 that is controlled by apparatus control device FF.

For example, power control device T1 receives from apparatus control device FF the chargeable/dischargeable capacity of storage battery R2 (including specifications such as the PCS output and the capacity of the storage battery that the owner of the storage battery is to provide according to a contract).

Power control device T1 then generates GF operation control information, first LFC operation control information, second LFC operation control information, BL operation control information and MO operation control information according to the chargeable/dischargeable capacity of storage battery R2. For example, power control device T1 generates each item of operation control information such that the adjustment power amount in storage battery R2 in each power supply/demand adjustment process is equal to or less than the chargeable/dischargeable capacity of storage battery R2.

In addition, power control device T1 may also change each item of operation control information according to the power adjustment amount undertaken by power control device T1 (for example, the power adjustment amount delegated from a power company or the power adjustment amount that was successfully bid on a power exchange market).

For example, power control device T1 generates each item of operation control information such that the adjustment power amount in storage battery R2 in each power supply/demand adjustment process matches the power adjustment amount undertaken by power control device T1.

When power control device T1 controls a plurality of apparatus control devices FF, power control device T1 may generate operation control information as shown hereinbelow.

Power control device T1 generates operation control information for each apparatus control device FF such that for each power supply/demand adjustment process, the total amount of adjustment power amount in storage batteries R2 in a power supply/demand adjustment process matches the power adjustment amount undertaken by power control device T1.

In addition, power control device T1 may also generate operation control information on the basis of both the state of storage batteries R2 and the power amount that is borne by all N (where N is a number equal to or greater than 1) storage batteries R2.

For example, power control device T1 generates operation control information such that the adjustment power amount in storage batteries R2 in each power supply/demand adjustment process is equal to or less than the chargeable/dischargeable capacity of storage batteries R2 and the total amount of adjustment power amount in storage batteries R2 in a power supply/demand adjustment process matches the power adjustment amount undertaken by power control device T1.

In FIGS. 5A and 5F, storage battery R2 is provided outside the apparatus control device, but storage battery R2 may also be incorporated in the apparatus control device.

FIG. 5G shows apparatus control device F that incorporates storage battery R2.

FIG. 5H shows apparatus control device FF that incorporates storage battery R2.

Apparatus control device F or FF that incorporates storage battery R2 is one example of a power storage device.

### Sixth Exemplary Embodiment

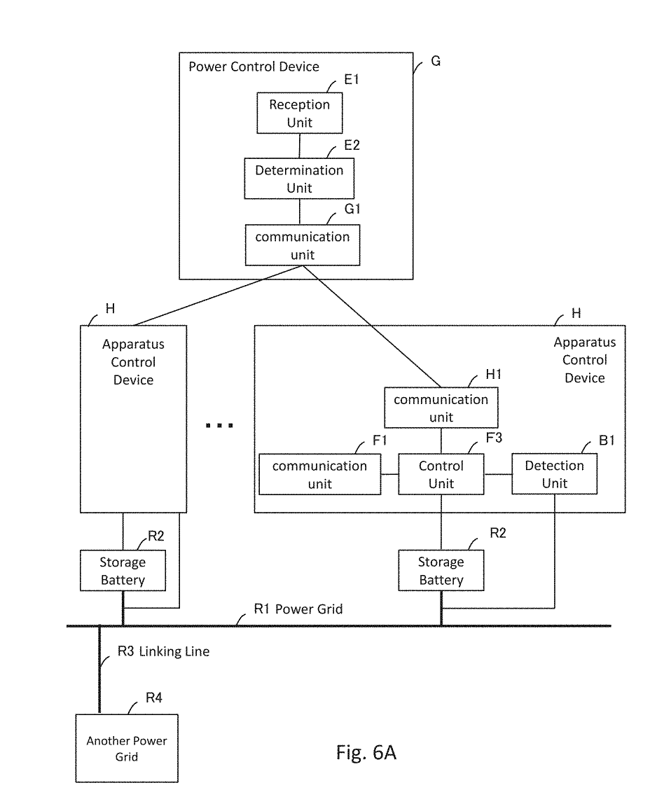

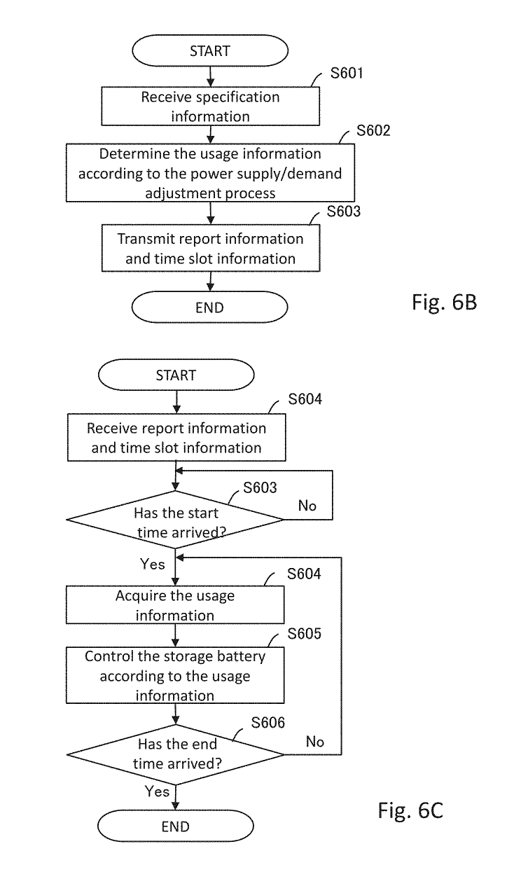

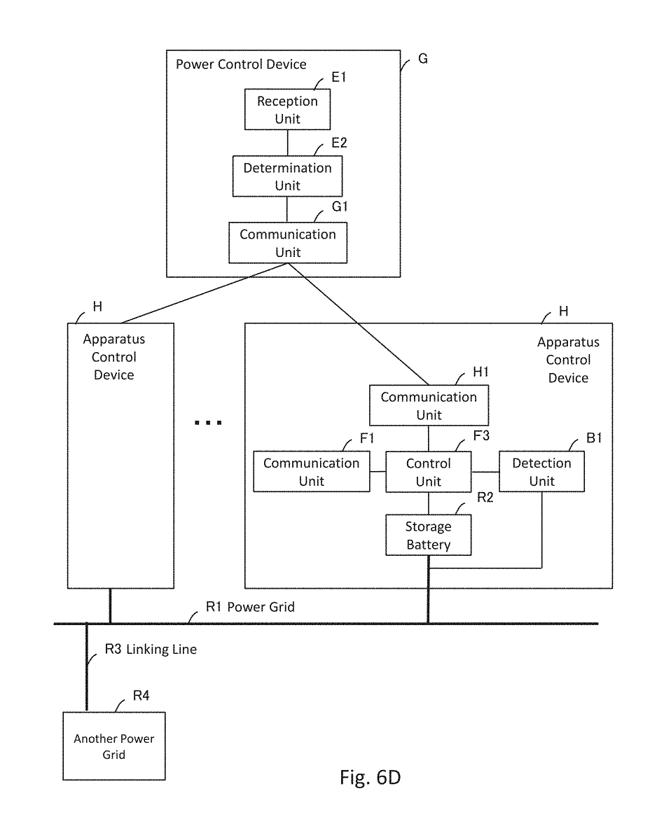

FIG. 6A shows power control device G of the sixth exemplary embodiment of the present invention. In FIG. 6A, components having identical configuration to components shown in FIGS. 4A, 5A and 5F are given the same reference numbers.

In the sixth exemplary embodiment, power control device G that is provided with the functions belonging to control device E shown in the fourth exemplary embodiment reports report information that specifies usage information to apparatus control device H that functions as an execution device.

The chief point of difference between power control device G of the sixth exemplary embodiment and control device E of the fourth exemplary embodiment is that power control device G of the sixth exemplary embodiment is provided with communication unit G1. The sixth exemplary embodiment is described below with focus on the point of difference with the fourth exemplary embodiment.

Power control device G is an example of a control device. Power control device G transmits report information that specifies usage information to apparatus control device H to cause apparatus control device H to execute a power supply/demand adjustment process.

Power control device G includes reception unit E1, determination unit E2 and communication unit G1.

Determination unit E2 has the same functions as determination unit E2 shown in FIG. 5A.

Communication unit G1 is an example of a reporting unit. Communication unit G1 reports report information (for example, the name or identifier of usage information) that specifies the usage information that was determined by determination unit E2 to each apparatus control device H.

Apparatus control device H includes detection unit B1, communication unit F1, control unit F3 and communication unit H1.

Communication unit H1 receives the report information from power control device G.

The operation of the sixth exemplary embodiment is next described.

The operation of power control device G is first described. Time slot information that indicates an execution time slot in which the power supply/demand adjustment process specified in the specification information is to be executed is appended to the specification information.

FIG. 6B is a flow chart for describing the operation of power control device G.

Reception unit E1 receives the specification information to which the time slot information has been appended (Step S601). Reception unit E1 next supplies the specification information to which the time slot information has been appended to determination unit E2.

Determination unit E2, upon receiving the specification information with the appended time slot information, determines, as the usage information, one of the frequency of power grid R1 and indices i1 and i2 according to the power supply/demand adjustment process that is specified in the specification information and operation control information according to the power supply/demand adjustment process (Step S602). The operation of Step S602 is the same as the operation of Step S502 shown in FIG. 5B, and explanation of this operation is therefore omitted.

Determination unit E2, upon determining the usage information, supplies the determination result of the usage information and the time slot information to communication unit G2.

Communication unit G1, upon receiving the determination result of the usage information and the time slot information, transmits the time slot information and report information that specifies the usage information to each apparatus control device H (Step S603).

The operation of apparatus control device H is next described.

FIG. 6C is a flow chart for describing the operation of apparatus control device H. In FIG. 6C, processes that are the same as processes shown in FIG. 5B are given the same reference numbers.

Communication unit H1 receives the report information and time slot information from power control device G (Step S604).

Communication unit H1 next supplies the report information and time slot information to control unit F3.

Control unit F3, upon receiving the report information and time slot information, executes Step S503. Step S504-Step S506 are then executed.

The effect of the present exemplary embodiment is next described.

In power control device G in the present exemplary embodiment, determination unit E2 determines, as usage information, the frequency of power grid R1 or index i1 or index i2 according to the power supply/demand adjustment process that is specified in the specification information. Communication unit G1 then reports to apparatus control device H report information that specifies the usage information.

As a result, power control device G is able to cause apparatus control device H to execute the power supply/demand adjustment process that uses usage information that is appropriate to the power supply/demand adjustment process.

In addition, communication unit H1 in apparatus control device H receives report information. Control unit H2 uses the usage information that is specified in the report information to control storage battery R2.

As a result, apparatus control device H is able to use usage information that is appropriate to the power supply/demand adjustment process to execute the power supply/demand adjustment process.

Modifications of the present exemplary embodiment are next described.

Power control device G may also transmit each item of operation control information to apparatus control device H. In this case, power control device G may generate each item of operation control information. Further, power control device G may also change each item of operation control information according to the state (for example, the temperature, voltage and residual amount of stored power) of storage battery R2 that is controlled by apparatus control device H.

For example, determination unit E2 in power control device G receives the chargeable/dischargeable capacity of storage battery R2 from apparatus control device H by way of communication unit G1.

Determination unit E2 then generates each item of operation control information according to the chargeable/dischargeable capacity of storage battery R2 (including specifications such as the capacity of the storage battery that the storage battery owner is obligated to supply according to a contract or the PCS output). For example, determination unit E2 generates each item of operation control information such that the adjustment power amount in storage battery R2 in each power supply/demand adjustment process is equal to or less than the chargeable/dischargeable capacity of storage battery R2.

In addition, determination unit E2 may also change each item of operation control information according to the power adjustment amount undertaken by power control device G (for example, the power adjustment amount that is delegated from a power company or the power adjustment amount that was successfully bid on a power exchange market).

For example, determination unit E2 generates each item of operation control information such that the adjustment power amount in storage battery R2 in each power supply/demand adjustment process matches the power adjustment amount undertaken by power control device G.

When power control device G controls a plurality of apparatus control devices H, determination unit E2 may generate operation control information for each apparatus control device H such that the total amount of adjustment power amount in storage batteries R2 matches the power adjustment amount undertaken by power control device G in each power supply/demand adjustment process.

In FIG. 6A, storage battery R2 is provided outside apparatus control device H, but storage battery R2 may also be incorporated in apparatus control device H.

FIG. 6D shows apparatus control device H that incorporates storage battery R2. Further, apparatus control device H that incorporates storage battery R2 is an example of a power storage device.

### Seventh Exemplary Embodiment

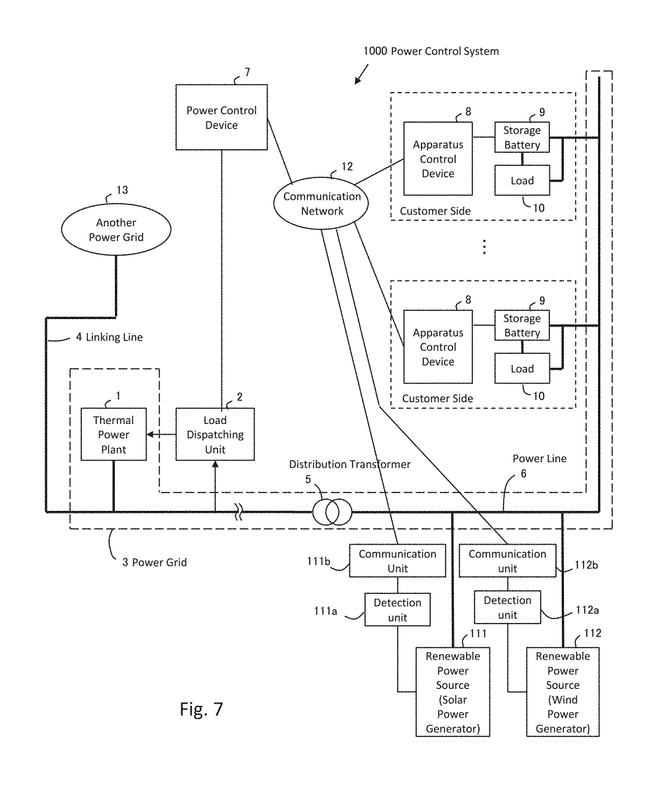

FIG. 7 shows power control system 1000 that adopts the seventh exemplary embodiment of the present invention. The seventh exemplary embodiment is next described with focus on the points of difference with the above-described exemplary embodiments.

Power control system 1000 includes thermal power generator 1, load dispatching unit 2, power grid 3, linking line 4, distribution transformer 5, power line 6, power control device 7, a plurality of apparatus control devices 8, a plurality of storage batteries 9 and a plurality of loads 10.

Thermal power generator 1, load dispatching unit 2, power grid 3, linking line 4, distribution transformer 5 and power line 6 belong to a power company.

Power control device 7 belongs to a PPS. Power control device 7 may also belong to an aggregator.

Apparatus control devices 8, storage batteries 9 and loads 10 belong to each customer.

Thermal power generator 1, distribution transformer 5 and power line 6 are included in power grid 3. Renewable power source (solar power generator) 111 and renewable power source (wind power generator) 112 are connected to power grid 3.

FIG. 7 shows one renewable power source 111 and one renewable power source 112, but in actuality, a plurality of renewable power sources 111 and a plurality of renewable power sources 112 are connected to power grid 3.

Detection unit 111a detects the amount of generated power of renewable power source 111. Communication unit 111b reports the detection result of detection unit 111a to power control device 7. Detection unit 111a and communication unit 111b are provided for each renewable power source 111.

Detection unit 112a detects the amount of generated power of renewable power source 112. Communication unit 112b reports the detection result of detection unit 112a to power control device 7. Detection unit 112b and communication unit 112b are provided for each renewable power source 112.

Storage batteries 9 are an example of the power supply/demand adjustment devices.

Storage batteries 9 connect to power grid 3. Loads 10 are, for example, household appliances.

A summary of the functions belonging to power control system 1000 is first described.

Load dispatching unit 2 on the power company side transmits a demand for a power supply/demand adjustment process to power control device 7 on the PPS side. Load dispatching unit 2 transmits demands of a plurality of types to power control device 7.

In the present exemplary embodiment, GF demands, first LFC demands, second LFC demands and instantaneous adjustment demands (hereinbelow “MO demands”) are used as the demands of the power company. The demands of the power company are not limited to these demands and can be altered as appropriate.

Power control device 7 on the PPS side receives the power company demand from load dispatching unit 2. Power control device 7 receives the power supply/demand adjustment process demand in the PPS (hereinbelow referred to as the “PPS demand”).

In the present exemplary embodiment, a balancing demand (hereinbelow referred to as a “BL demand”) is used as the PPS demand. The PPS demand is not limited to the above-described demand and can be changed as appropriate.

Power control device 7 creates operation control information for controlling storage battery 9 for each apparatus control device 8.

For example, power control device 7 creates operation control information that reflects the state (for example, the residual capacity or the SOC (State of Charge)) of storage battery 9 and the content of the power supply/demand adjustment process that accords with the demand.

If the demand is a “GF demand,” power control device 7 generates GF operation control information for executing a GF adjustment process (hereinbelow referred to as “DR application 1”) that uses the frequency deviation of power grid 3 to control storage battery 9.

If the demand is a “first LFC demand,” power control device 7 generates first LFC operation control information for executing a first LFC adjustment process (hereinbelow also referred to as “DR application 2”) that uses the integrated value of the frequency deviation of power grid 3 to control the operation of storage battery 9.

If the demand is a “second LFC demand,” power control device 7 generates second LFC operation control information for executing a second LFC adjustment process (hereinbelow also referred to as “DR application 3”) that uses index i1 to control the operation of storage battery 9.

If the demand is a “BL demand,” power control device 7 generates BL operation control information for executing a balancing (BL) adjustment process (hereinbelow also referred to as “DR application 4”) that uses index i2 to control the operation of storage battery 9.

If the demand is an “MO demand,” power control device 7 generates MO operation control information for executing an instantaneous adjustment process (hereinbelow also referred to as “DR application 5”) that uses the frequency of power grid 3 to control the operation of storage battery 9.

It assumed hereinbelow that each storage battery 9 is assigned to DR applications 1-5.

Power control device 7 transmits the received demand to apparatus control device 8. The demand is an example of specification information.

Power control device 7 repeatedly transmits the operation control information to apparatus control device 8 at time intervals.

Power control device 7 repeatedly transmits indices i1 and i2 to apparatus control device 8 at time intervals. Indices i1 and i2 are here the same as indices i1 and i2 in the fourth exemplary embodiment.

The transmission spacing of the operation control information is longer than the transmission spacing of indices i1 and i2.

Upon receiving the demand, apparatus control device 8 determines according to the demand the usage information (the frequency of power grid 3 or index i1 or index i2, and the operation control information that accords with the demand) that is used in the power supply/demand adjustment process that corresponds to the demand.

Apparatus control device 8 executes the power supply/demand adjustment process (DR applications 1-5) that accords with the demand by using the usage information to control the operation of storage battery 9. The power supply/demand adjustment process that accords with the demand means the response to the demand (hereinbelow also referred to as “response”).

The configuration of power control system 1000 is next described.

Thermal power generator 1 is an example of a power generator. Load dispatching unit 2 communicates with power control device 7. Load dispatching unit 2 transmits demands (GF demands, first LFC demands, second LFC demands, MO demands) to power control device 7.

Power grid 3 is a system that supplies electric power to the customer side. Power grid 3 transforms the voltage of the generated power that is supplied from thermal power generator 1 to a predetermined voltage in distribution transformer 5. Power grid 3 supplies the power to the customer side at a predetermined voltage.

Linking line 4 connects power grid 3 with another power grid 13.

Power control device 7 receives power company demands (GF demands, first LFC demands, second LFC demands, MO demands) from load dispatching unit 2. In addition, power control device 7 receives PPS demands (BL demands) from PPS apparatuses.

Power control device 7 creates operation control information for each of DR applications 1-5.

Power control device 7 transmits the demands that are received to apparatus control device 8. Power control device 7 repeatedly transmits operation control information at time intervals to apparatus control device 8. Power control device 7 repeatedly transmits indices i1-i2 with time intervals to apparatus control device 8.

Apparatus control device 8 determines the usage information used in the power supply/demand adjustment processes that correspond to the demands in accordance with the demands that are received from power control device 7. Apparatus control device 8 uses the usage information to control the operation of storage battery 9.

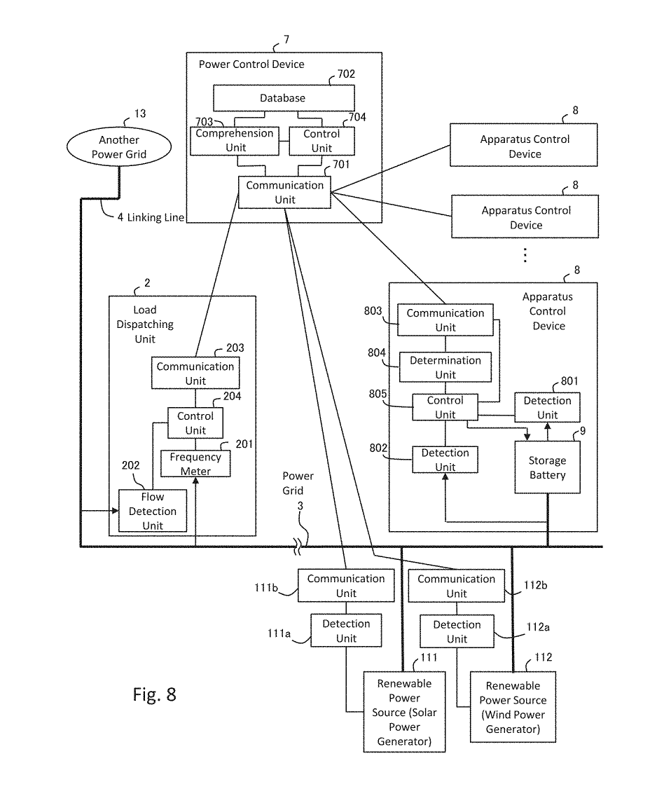

FIG. 8 shows an example of load dispatching unit 2, power control device 7 and a plurality of apparatus control devices 8. In FIG. 8, components having the same configuration as components shown in FIG. 7 are given the same reference numbers. In FIG. 8, communication network 12 is omitted. In FIG. 8, storage batteries 9 are incorporated in apparatus control devices 8, but storage batteries 9 need not be incorporated in apparatus control devices 8. Apparatus control device 8 that incorporates storage battery 9 is an example of a power storage device.

Apparatus control device 8 is first described.

Apparatus control device 8 controls the operation of storage battery 9. Apparatus control device 8 includes detection units 801 and 802, communication unit 803, determination unit 804 and control unit 805.

Detection unit 801 detects the SOC of storage battery 9. The SOC of storage battery 9 takes a value in the range of from 0 to 1. The SOC of storage battery 9 represents the state of storage battery 9. The state of storage battery 9 is not limited to the SOC of storage battery 9 and may be altered as appropriate. For example, the cell temperature, amount of current, or the voltage of storage battery 9 may also be used.

Detection unit 802 detects the frequency of power grid 3. Detection unit 802 may be inside apparatus control device 8, or may be outside. When detection unit 802 is outside apparatus control device 8, control unit 805 detects (receives) the frequency of power grid 3 by receiving the detection result of detection unit 802.

Communication unit 803 is an example of a reception unit or transceiver unit.

Communication unit 803 communicates with power control device 7.

Communication unit 803 receives demands, operation control information, index i1 and index i2 from power control device 7.

For example, communication unit 803 receives demands that are transmitted from power control device 7 using bidirectional communication, for example, MQTT (Message Queuing Telemetry Transport). In addition, communication unit 803 may also receive demands that are transmitted by, for example, one-way communication such as by broadcast from power control device 7.

Communication unit 803 receives index i1 that is transmitted by one-way communication such as by broadcast from power control device 7. Communication unit 803 may also receive index i1 that is transmitted from power control device 7 using bidirectional communication such as MQTT.

Communication unit 803 receives index i2 that is transmitted from power control device 7 using bidirectional communication such as MQTT.

Communication unit 803 receives operation control information that has been transmitted from power control device 7 using bidirectional communication such as MQTT.

Determination unit 804 determines usage information according to the demand that communication unit 803 has received.

Control unit 805 uses the usage information that was determined by determination unit 804 to control the charging/discharging operation of storage battery 9.

Control unit 805 executes an information acquisition operation (transmission/reception process) of acquiring operation control information from power control device 7 and a control operation (battery operation control process) of using the operation control information to control the charging/discharging operation of storage battery 9.

Control unit 805 repeatedly executes the information acquisition operation at time intervals.

Control unit 805 repeatedly executes the control operation at time intervals that are shorter than the time intervals for the information acquisition operation.

For example, control unit 805 repeatedly executes the information acquisition operation at period T and repeatedly executes the control operation at period T₁ (where T>T₁). Period T is an example of a predetermined time interval. In addition, for example, the detection of the frequency of power grid 3 and the transmission and reception of indices i1-i2 are repeatedly executed at period T₁.

The operation time interval of the information acquisition operation, the operation time interval of the control operation, or both need not be uniform, but the shortest time of each operation time interval of the information acquisition operation should be longer than the longest time of each operation time interval of the control operation.

Each customer has apparatus control device 8, storage battery 9 and load 10. Apparatus control device 8 and storage battery 9 are maintained by a PPS or aggregator that is provided with power control device 7 and are arranged connected to allow usage by load 10 of each customer. In this case, the PPS or aggregator that is essentially the owner of apparatus control device 8 and storage battery 9 can freely control apparatus control device 8 and storage battery 9, but by concluding a predetermined contract, the customer is also able to use apparatus control device 8 and storage battery 9 in, for example, the control of load 10.

Power control device 7 is next described.

Power control device 7 has under its control N apparatus control devices 8 and N storage batteries 9. For example, N apparatus control devices 8 and N storage batteries 9 are held by customers that are supplied with power from a PPS. Here, N is an integer equal to or greater than 1. Power control device 7 includes communication unit 701, database 702, comprehension unit 703 and control unit 704.

Communication unit 701 communicates with each apparatus control device 8, load dispatching unit 2, communication unit 111b and communication unit 112b. For example, communication unit 701 receives the SOC and ID (Identification) of storage battery 9 from each apparatus control device 8. In addition, communication unit 701 receives information indicating the amount of generated power of renewable power sources 111 and 112 from communication units 111b and 112b.

Database 702 stores the information of each storage battery 9.

Database 702 further holds a storage battery distribution rate curve that is used for finding the chargeable/dischargeable capacity of storage battery 9 from the SOC of storage battery 9 that is received by communication unit 701. Database 702 further holds rated output P(n) of each storage battery 9 that is used for finding the chargeable/dischargeable capacity. The rated output of a power conditioner (AC/DC converter) (not shown) that is connected to storage battery 9 is used as the rated output P(n) of storage battery 9.

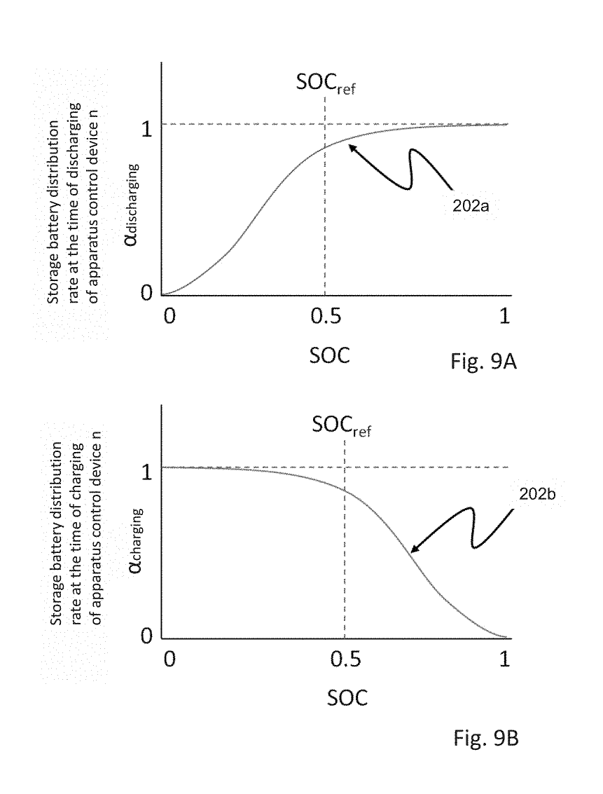

FIGS. 9A and 9B shows examples of the storage battery distribution rate curve. FIG. 9A shows an example of storage battery distribution rate curve 202a at the time of discharging. FIG. 9B shows an example of storage battery distribution rate curve 202b at the time of charging.

Comprehension unit 703 comprehends, for each of DR applications 1-3, the power amounts (hereinbelow referred to as “DR1 allotted power amount”−“DR3 allotted power amount”) that are allotted to N storage batteries 9 that are under the jurisdiction of power control device 7 for adjusting the power amount in power grid 3. Each allotted power amount is an example of the condition of the power grid.

Comprehension unit 703 comprehends the DR1 allotted power amount as shown below.

Comprehension unit 703 uses the storage battery distribution rate curve in database 702 to derive the chargeable/dischargeable capacity of a storage battery group that is made up of N storage batteries 9 (hereinbelow referred to as simply “storage battery group”) from the SOC of N storage batteries 9. The chargeable/dischargeable capacity of the storage battery group is referred to as the “total adjustable capacity P_{ES}.”

Comprehension unit 703 transmits the total adjustable capacity P_{ES} from communication unit 701 to load dispatching unit 2. Comprehension unit 703 then receives DR1 allotted power amount information that represents the DR1 allotted power amount that reflects the total adjustable capacity P_{ES} from load dispatching unit 2 by way of communication unit 701.

Comprehension unit 703 uses the DR1 allotted power amount information to comprehend the DR1 allotted power amount.

In the present exemplary embodiment, a DR1 drooping characteristic line is used as the DR1 allotted power amount information. The DR1 drooping characteristic line represents the GF assigned capacity GF_{ES-DR1} that represents the DR1 maximum allotted power amount, the maximum value (threshold value) of the frequency deviation+fₘₐₓ, and −fmax (for the sake of simplification, ± is hereinbelow lumped together and the value fₘₐₓ is used).

The “maximum value of frequency deviation” is used as a threshold value of the amount of divergence (frequency deviation) with respect to a reference frequency (for example, 50 Hz) of the grid frequency. The reference frequency of the grid frequency is stored in control unit 805.

In addition, the “maximum value of frequency deviation” means the maximum amount of shifting of the frequency deviation” that can be accommodated by the total output GF_{ES} of N storage batteries 9 that execute DR application 1. It is difficult for GF_{ES-DR1} to accommodate a case where the value of frequency deviation equals or surpasses the maximum value (threshold value) of frequency deviation.

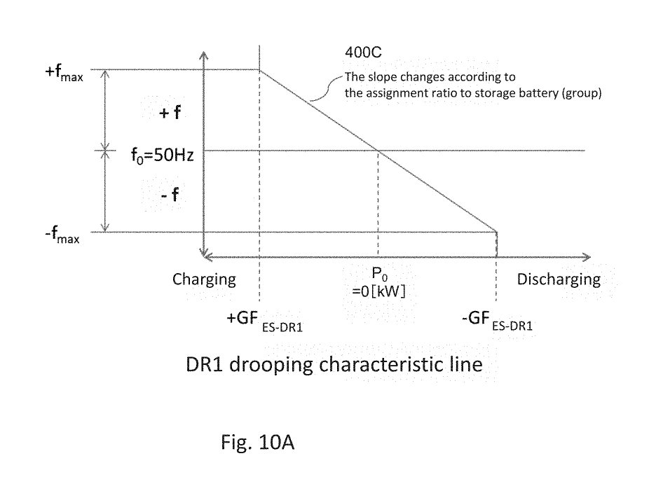

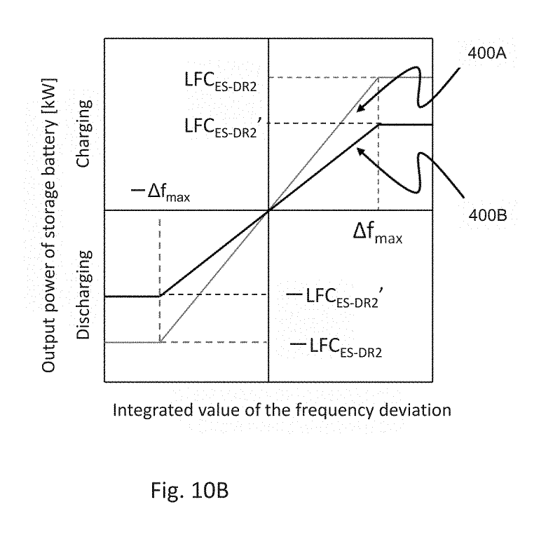

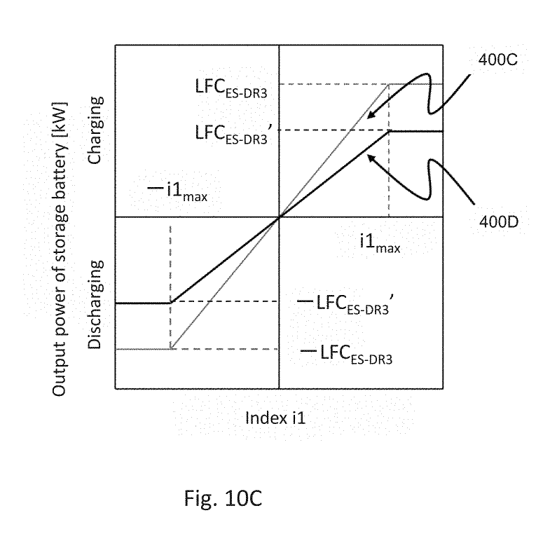

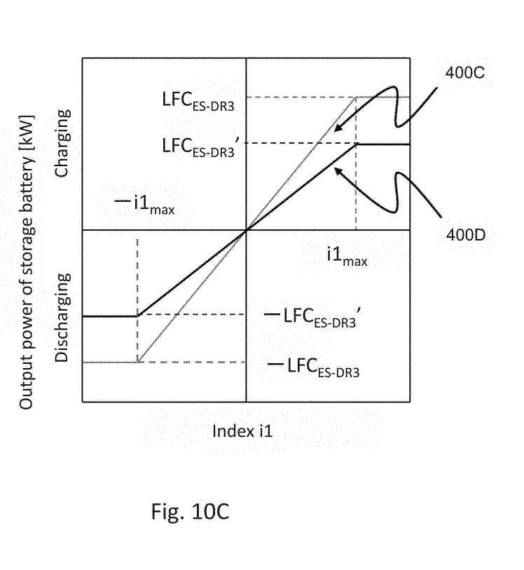

FIG. 10A shows an example of the DR1 drooping characteristic line. Details of the DR1 drooping characteristic line are described later.

The DR1 drooping characteristic line indicates the relation between the frequency deviation f and the storage battery group output (total output of N storage batteries 9 that execute DR application 1).

Control unit 704 generates DR1 allotment information of each storage battery 9 that executes DR application 1 so as to satisfy the relation between the frequency deviation and the storage battery group output shown by the DR1 drooping characteristic line. The DR1 allotment information is an example of the GF operation control information.

In the present exemplary embodiment, control unit 704 generates DR1 allotment information (DR1 allotment coefficient K1 and the maximum value fₘₐₓ of frequency deviation) of each storage battery 9 that executes DR application 1 on the basis of each storage battery 9 that executes DR application 1 and the DR1 drooping characteristic line. Control unit 704 transmits the DR1 allotment information from communication unit 701 to each apparatus control device 8 that executes DR application 1. DR1 allotment coefficient K1 increases with the increase of the allotment proportion to storage batteries 9 that execute DR application 1.

Comprehension unit 703 comprehends the DR2 allotted power amount as shown below.

Comprehension unit 703 uses the storage battery distribution rate curve in database 702 to derive the chargeable/dischargeable capacity (total adjustable capacity P_{ES}) of a storage battery group. The storage battery distribution rate curve used here need not necessarily be the same as the storage battery distribution rate curve that was used when deriving the DR1 allotted power amount.

Comprehension unit 703 transmits the total adjustable capacity P_{ES} from communication unit 701 to load dispatching unit 2. Comprehension unit 703 then receives DR2 allotted power amount information that represents the DR2 allotted power amount that reflects the total adjustable capacity P_{ES} from load dispatching unit 2 by way of communication unit 701. Comprehension unit 703 uses the DR2 allotted power amount information to comprehend the DR2 allotted power amount.

In the present exemplary embodiment, a DR2 charge/discharge gain line is used as the DR2 allotted power amount information. The DR2 charge/discharge gain line represents the LFC assigned capacity LFC_{ES-DR2} that represents the DR2 maximum allotted power amount and the maximum value (threshold value) Δfₘₐₓ of the integrated value of the frequency deviation (although there are ±Δfₘₐₓ, ± is hereinbelow omitted in the interest of simplification).

The “maximum value of the integrated value of frequency deviation” is used as the threshold value of the integrated value of the amount of divergence (frequency deviation) of the grid frequency with respect to a reference frequency.

In addition, the “maximum value of the integrated value of frequency deviation” means the “maximum amount of shifting of the integrated value of frequency deviation” that can be accommodated by total output LFC_{ES-DR2} of the N storage batteries 9 that execute DR application 2. It is difficult for LFC_{ES-DR2} to accommodate an integrated value of frequency deviation that reaches a value equal to or greater than the maximum value (threshold value) of the integrated value of frequency deviation.

FIG. 10B shows an example of the DR2 charge/discharge gain line. The details of the DR2 charge/discharge gain line will be described later.

The DR2 charge/discharge gain line indicates the relation between the integrated value of frequency deviation and the storage battery group output (the total output of the N storage batteries 9 that execute DR application 2).

Control unit 704 generates DR2 allotment information of each storage battery 9 that executes DR application 2 so as to satisfy the relation between the integrated value of frequency deviation and the storage battery group output shown by the DR2 charge/discharge gain line.

The DR2 allotment information is an example of the first LFC operation control information.

In the present exemplary embodiment, control unit 704 generates DR2 allotment information (DR2 allotment coefficient K2 and the maximum value Δfₘₐₓ of the integrated value of frequency deviation) of each storage battery 9 that executes DR application 2 on the basis of the SOC of storage batteries 9 that execute DR application 2 and the DR2 charge/discharge gain line. Control unit 704 transmits the DR2 allotment information from communication unit 701 to each apparatus control device 8 that executes DR application 2. DR2 allotment coefficient K2 increases in the proportion allotted to storage batteries 9 that execute DR application 2.

Comprehension unit 703 comprehends the DR3 allotted power amount as shown below.

Comprehension unit 703 uses the storage battery distribution rate curve in database 702 to derive the chargeable/dischargeable capacity (total adjustable capacity P_{ES}) of a storage battery group. The storage battery distribution rate curve used here need not necessarily be the same as the storage battery distribution rate curve that was used when deriving the DR1 allotted power amount or the DR2 allotted power amount.

Comprehension unit 703 transmits the total adjustable capacity P_{ES} from communication unit 701 to load dispatching unit 2. Comprehension unit 703 then receives the DR3 allotted power amount information that represents the DR3 allotted power amount that reflects total adjustable capacity P_{ES} from load dispatching unit 2 by way of communication unit 701. Comprehension unit 703 uses the DR3 allotted power amount information to comprehend the DR3 allotted power amount.

In the present exemplary embodiment, the DR3 charge/discharge gain line is used as the DR3 allotted power amount information. The DR3 charge/discharge gain line represents the LFC assigned capacity LFC_{ES-DR3} that represents the DR3 maximum allotted power amount and the maximum value (threshold value) i1ₘₐₓ of index i1 (although there are ±i1max, ± is omitted in the interest of simplification). The “maximum value of index i1” is used as the threshold value of index i1.

In addition, the “maximum value of index i1” means the “maximum amount of shifting of index i1” that can be accommodated by the total output LFC_{ES-DR3} of storage batteries 9 that execute DR application 3. It is difficult for LFC_{ES-DR3} to accommodate index i1 that reaches or surpasses the maximum value (threshold value) of index i1.

FIG. 10C shows an example of the DR3 charge/discharge gain line. The details of the DR3 charge/discharge gain line will be described later.

The DR3 charge/discharge gain line shows the relation between index i1 and the storage battery group output (the total output of N storage batteries 9 that execute DR application 3).

Control unit 704 generates the DR3 allotment information of each storage battery 9 that executes DR application 3 so as to satisfy the relation between index i1 and the storage battery group output that is shown by the DR3 charge/discharge gain line. The DR3 allotment information is an example of the second LFC operation control information.

In the present exemplary embodiment, control unit 704 generates the DR3 allotment information (DR3 allotment coefficient K3 and the maximum value i1ₘₐₓ of index i1) of each storage battery 9 that executes DR application 3 on the basis of the SOC of storage batteries 9 that execute DR application 3 and the DR3 charge/discharge gain line. Control unit 704 transmits the DR3 allotment information from communication unit 701 to each apparatus control device 8 that executes DR application 3. DR3 allotment coefficient K3 increases with increase in the proportion allotted to storage batteries 9 that execute DR application 3.

In addition, control unit 704 uses information (the amount of generated power of renewable power sources 111 and 112) received from communication units 111b and 112b to generate index i2.

Load dispatching unit 2 is next described.

Load dispatching unit 2 includes frequency meter 201, flow detection unit 202, communication unit 203 and control unit 204.

Frequency meter 201 detects the frequency of power grid 3.

Flow detection unit 202 detects the flow in linking line 4.

Communication unit 203 communicates with power control device 7.

For example, communication unit 203 receives total adjustable capacity P_{ES} from power control device 7. In addition, communication unit 203 transmits the DR1 drooping characteristic line, the DR2 charge/discharge gain line and the DR3 charge/discharge gain line to power control device 7.

Control unit 204 controls the operation of load dispatching unit 2.

For example, control unit 204 transmits various demands to power control device 7 by way of communication unit 203.

In addition, control unit 204 uses the detection result of frequency meter 201 and the detection result of flow detection unit 202 to generate index i1. The method of generating index i1 is the same as the method described in the first exemplary embodiment. Control unit 204 transmits index i1 from communication unit 203 to power control device 7. In power control device 7, upon receiving index i1 by way of communication unit 701, control unit 704 transmits index i1 to each apparatus control device 8 from communication unit 701.

In addition, control unit 204 generates the DR1 drooping characteristic line, DR2 charge/discharge gain line and DR3 charge/discharge gain line as shown below.

The method of generating the DR1 drooping characteristic line (DR1 allotted power amount information) is first described.

Control unit 204 first acquires total adjustable capacity P_{ES} from communication unit 203 with regard to the GF capacity necessary for keeping the frequency deviation of power grid 3 within “a particular range of frequency deviation.” Control unit 204 uses a predetermined maximum value (threshold value) fₘₐₓ of the frequency deviation and total adjustable capacity P_{ES} to generate the DR1 drooping characteristic line and the GF capacity GF_{ES-DR1} for a storage battery group. Here, GF_{ES-DR1}≦P_{ES}. Control unit 204 transmits the DR1 drooping characteristic line from communication unit 203 to power control device 7.

Control unit 204 may also assign the GF capacity to thermal power generator 1 and a storage battery group in accordance with an assignment ratio (predetermined value) of GF capacity to thermal power generator 1 and the storage battery group. In this case, DR1 drooping characteristic line differs according to the ratio.

The method of generating the DR2 charge/discharge gain line (the DR2 allotted power amount information) is next described.

Control unit 204 uses the grid frequency that was detected by frequency meter 201 to calculate an Area Requirement that is an output correction amount of a power plant. Control unit 204 uses the area requirement AR, the LFC adjustment capacity of thermal power generator 1 that is the object of control, and total adjustable capacity P_{ES} to derive the LFC capacity. Control unit 204 acquires the LFC adjustment capacity of thermal power generator 1 from a thermal power generator control unit (not shown). The total adjustable capacity P_{ES} is supplied to control unit 204 from communication unit 203.

Control unit 204 assigns to thermal power generator 1, of the LFC capacity, a capacity from which the rapid fluctuation component has been removed. Control unit 204 assigns to the storage battery group the remaining LFC capacity LFC_{ES-DR2} (where LFC_{ES-DR2}≦P_{ES}). For example, control unit 204 uses a high-pass filter that passes, of the LFC capacity, a fluctuation component having a period no greater than 10 seconds and that does not pass a fluctuation component having period longer than 10 seconds to extract the rapid fluctuation component (capacity LFC_{ES-DR2}) from the LFC capacity.

Control unit 204 otherwise assigns the LFC capacity to thermal power generator 1 and a storage battery group in accordance with an assignment ratio (predetermined value) of the LFC capacity to thermal power generator 1 and the storage battery group.

Control unit 204 treats capacity LFC_{ES-DR2} as LFC assignment capacity LFC_{ES-DR2}.

Control unit 204 generates a DR2 charge/discharge gain line (see FIG. 10B) that represents the LFC assignment capacity LFC_{ES-DR2} and the maximum value (threshold value) Δfₘₐₓ of the integrated value of the frequency deviation, this value having been determined beforehand.

Control unit 204 transmits the DR2 charge/discharge gain line from communication unit 202 to power control device 7.

The method of generating a DR3 charge/discharge gain line (DR3 adjustment power amount information) is next described.

The method of generating the DR3 charge/discharge gain line (DR3 allotted power amount information) is similar to the method of generating the DR2 charge/discharge gain line (DR2 allotted power amount information).

The operation is next described.

[1] Operation by which Apparatus Control Device 8 Determines Usage Information

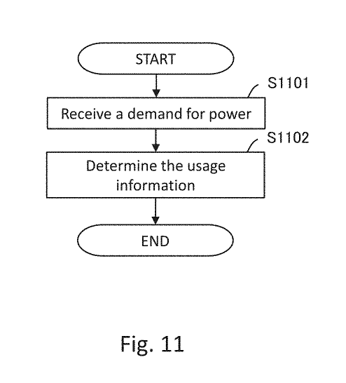

FIG. 11 is a flow chart for describing the operation by which apparatus control device 8 determines the usage information.

When control unit 704 in power control device 7 receives a demand for power (a power company demand) from load dispatching unit 2, or when a PPS input unit (not shown in the figure) receives a demand for power (a PPS demand), control unit 704 transmits this demand for power from communication unit 701 to apparatus control device 8.

In apparatus control device 8, upon receiving a demand for power (Step S1101), communication unit 803 supplies this demand for power to determination unit 804.

In addition, time slot information that indicates the execution time slot of the DR application that is required by the demand for power is appended to each demand for power.

Determination unit 804, upon receiving a demand for power, determines according to the demand for power the usage information that is to be used in the DR application that is specified by the demand for power (Step S1102).

In Step S1102, when the demand for power is a “GF demand,” determination unit 804 determines, as the usage information, the GF operation control information and the frequency of power grid 3.

When the demand for power is a “first LFC demand,” determination unit 804 determines, as the usage information, the first LFC operation control information and the frequency of power grid 3.

When the demand for power is a “second LFC demand,” determination unit 804 determines, as the usage information, the second LFC operation control information and index i1.

When the demand for power is a “BL demand,” determination unit 804 determines, as the usage information, the BL operation control information and index i2.

When the demand for power is an “MO demand,” determination unit 804 determines, as the usage information, the MO operation control information and the frequency of power grid 3.

Determination unit 804 supplies the determination result of the usage information and the demand for power (the demand for power with the appended time slot information) to control unit 805.

Upon receiving the determination result of the usage information and the demand for power, control unit 805 holds the determination result of the usage information and the demand.

### [2] Operation of Executing DR Application 1 (GF Adjustment Process)

A summary of the operation of executing DR application 1 is first described.

(2-1) Power control device 7 receives the SOC of storage batteries 9 from apparatus control devices 8 at period T1_{GF} and collects the SOC of storage batteries 9. Period T1_{GF} is, for example, five minutes.

(2-2) Power control device 7 derives, for each collection of SOC of storage batteries 9, total adjustable capacity P_{ES} on the basis of the SOC of storage batteries 9.

(2-3) Power control device 7 then transmits total adjustable capacity P_{ES} to load dispatching unit 2 at period Tₘ. Period Tₘ is equal to or greater than period T1_{GF} and is, for example, fifteen minutes.

(2-4) Load dispatching unit 2 calculates the GF assignment capacity GF_{ES-DR1} (GF_{ES-DR1}≦P_{ES}) for each reception of total adjustable capacity P_{ES}.

(2-5) For each calculation of the GF assignment capacity GF_{ES-DR1}, load dispatching unit 2 uses the GF assignment capacity GF_{ES-DR1} and the maximum value fₘₐₓ of the frequency deviation to create a DR1 drooping characteristic line. Load dispatching unit 2 then transmits the DR1 drooping characteristic line to power control device 7.

(2-6) Power control device 7, in accordance with the most recent DR1 drooping characteristic line from load dispatching unit 2, calculates DR1 allotment coefficient K1.

(2-7) Power control device 7 then transmits DR1 allotment information (DR1 allotment coefficient K1 and the maximum value fₘₐₓ of frequency deviation) to each apparatus control device 8 at period T1_{GF}. DR1 allotment information is also an example of GF operation control information.

(2-8) Each apparatus control device 8 calculates a local drooping characteristic line that prescribes a charging/discharging operation of storage battery 9 on the basis of DR1 allotment coefficient K1 and the maximum value fₘₐₓ of frequency deviation. The local drooping characteristic line will be described later.

(2-9) Each apparatus control device 8 uses the local drooping characteristic line and the frequency of power grid 3 to control the charging/discharging operations of storage battery 9.

The details of the operation of implementing DR application 1 (the GF adjustment process) are next described.

The operation in which power control device 7 derives total adjustable capacity P_{ES} on the basis of the SOC of storage batteries 9 (hereinbelow referred to as the “P_{ES} derivation operation”) is first described.

The derivation of total adjustable capacity P_{ES} requires information such as the rated output P(n) of storage batteries 9 (the output value of a power conditioner, storage battery capacity, and the range of SOC that can be used (such as the range from 30% to 90%)). Because this information is basically static information, in the present exemplary embodiment, this information is assumed to have been acquired beforehand by power control device 7 from each apparatus control device 8.

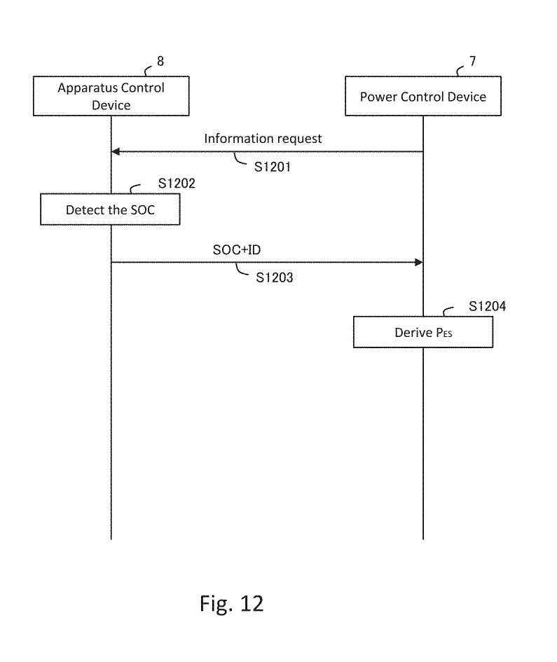

FIG. 12 is a sequence diagram for describing the P_{ES} derivation operation. In FIG. 12, the number of apparatus control devices 8 is assumed to be one in the interest of simplifying the explanation.

Communication unit 701 of power control device 7 transmits an information request to each apparatus control device 8 demanding the SOC (Step S1201).

In each apparatus control device 8, control unit 805, upon receiving by way of communication unit 803 the information request demanding SOC, causes detection unit 801 to detect the SOC of storage battery 9 (Step S1202).

Control unit 805 next transmits the SOC that was detected by detection unit 801 together with ID from communication unit 803 to power control device 7 (Step S1203). In the following explanation, the ID is described as sequential numbers (n) from “1” to “N.”

Power control device 7, upon receiving from each apparatus control device 8 an SOC to which an ID is appended (hereinbelow referred to as “SOC(n)”), derives the total adjustable capacity P_{ES} (Step S1204).

Power control device 7 and each apparatus control device 8 repeat the operations of Steps S1201-S1204 (the P_{ES} derivation operation) at period T1_{GF}. Period T1_{GF} may also be altered within a range that satisfies the demand conditions of the demand according to the state of the communication network or other states such as a breakdown in the condition of storage batteries.

Step S1204 (derivation of total adjustable capacity P_{ES}) is next described.

Communication unit 701 of power control device 7 collects SOC(n) at period T1_{GF} from each apparatus control device 8.

Comprehension unit 703 next uses SOC(n) and storage battery distribution rate curves 202a and 202b in database 702 to derive storage battery distribution rate α_{discharging}(n) during discharging and storage battery distribution rate α_{charging}(n) during charging.

The present exemplary embodiment uses, as storage battery distribution rate curves 202a and 202b, curves obtained by altering the forms shown in FIGS. 9A and 9B in accordance with information that relates to the execution time required by DR application 1 and information (the output value of a power conditioner and the storage battery capacity) such as the rated output P(n) of storage batteries 9.

For example, curves are used in which the value of total adjustable capacity P_{ES} that is derived by the process described hereinbelow becomes a value that at least allows continuation of the charging/discharging of a storage battery group during the interval of period T1_{GF} (in the current case, equal to the execution time required by DR application 1). The storage battery distribution rate curves are not limited to the curves here described and can be altered as appropriate according to the demand and DR application.

Comprehension unit 703 next uses storage battery distribution rate α_{discharging}(n) during discharging, storage battery distribution rate α_{charging}(n) during charging, the rated output P(n) of each of a total of N storage batteries 9 in database 702, and the numerical expressions shown in Numerical Expression 1 and Numerical Expression 2 to derive P_{ES,discharging} and P_{ES,charging}.

$$\begin{matrix}{P}_{ES , discharging} = {\sum }_{n = 1}^{N} {α}_{discharging} ( n ) \cdot P ( n ) & [ Numerical Expression 1 ] \\ {P}_{ES , charging} = {\sum }_{n = 1}^{N} {α}_{charging} ( n ) \cdot P ( n ) & [ Numerical Expression 2 ]\end{matrix}$$

Comprehension unit 703 next adopts the smaller value of P_{ES,discharging} and P_{ES,charging} as the total adjustable capacity P_{ES}.

The operation in which power control device 7 communicates with load dispatching unit 2 to comprehend the DR1 drooping characteristic line (hereinbelow referred to as the “DR1 comprehension operation”) is next described.

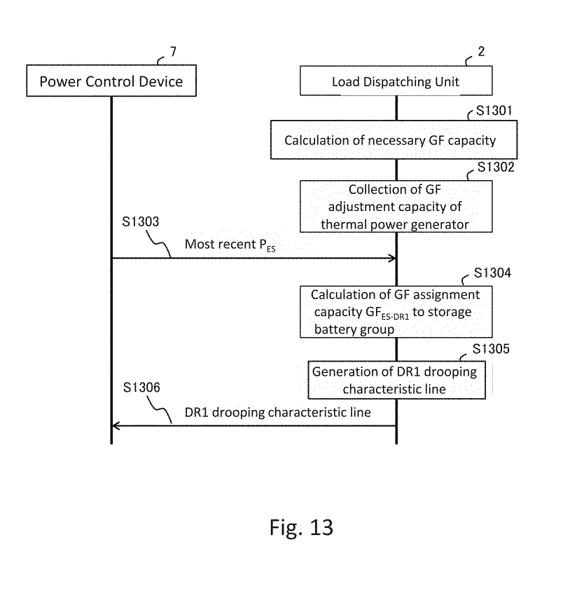

FIG. 13 is a sequence diagram for describing the DR1 comprehension operation.

Control unit 204 of load dispatching unit 2 calculates the GF capacity that is required in an area on the basis of, for example, the estimated amount of generated power of solar power generator 111, the estimated amount of generated power of wind power generator 112 and the estimated power demand (Step S1301).

Control unit 204 next collects the GF adjustment capacity of thermal power generator 1 from the thermal power generator control unit (not shown) (Step S1302).

On the other hand, communication unit 701 of power control device 7 transmits the most recent total adjustable capacity P_{ES} to load dispatching unit 2 (Step S1303).

Communication unit 203 of load dispatching unit 2 receives the most recent total adjustable capacity P_{ES} that was transmitted from communication unit 701 of power control device 7. Communication unit 203 supplies this most recent total adjustable capacity P_{ES} to control unit 204.

Control unit 204, upon receiving the most recent total adjustable capacity P_{ES}, uses the GF adjustment capacity of thermal power generator 1 and the most recent total adjustable capacity P_{ES} to assign to thermal power generator 1, of the required GF capacity, a capacity portion that is estimated to be efficiently usable based on a prediction of the operating conditions of thermal power generator 1. Control unit 204 next assigns the remaining GF capacity GF_{ES-DR1} (where GF_{ES-DR1}≦P_{ES}) to a storage battery group as GF assignment capacity GF_{ES-DR1} (Step S1304).

Control unit 204 next generates a DR1 drooping characteristic line (see FIG. 10A) that represents GF assignment capacity GF_{ES-DR1} and the predetermined maximum value fₘₐₓ of frequency deviation (Step S1305).

The DR1 drooping characteristic line shown in FIG. 10A represents the charging/discharging amount of the storage battery group with respect to frequency deviation f.

The slope of DR1 drooping characteristic line changes according to the magnitude (assignment ratio) of the GF assignment capacity GF_{ES-DR1} within the range in which “GF assignment capacity GF_{ES-DR1}≦total adjustable capacity P_{ES}.”

Control unit 204 next transmits the DR1 drooping characteristic line from communication unit 203 to power control device 7 (Step S1306).

Power control device 7 and load dispatching unit 2 repeat the operations of Steps S1301-S1306 (the DR1 comprehension operation) at period Tₘ (where, for example, Tₘ=15 minutes).

Comprehension unit 703 of power control device 7 continues receiving the DR1 drooping characteristic line by way of communication unit 701 and holds, of the DR1 drooping characteristic lines, the most recent DR1 drooping characteristic line.

The operations of generating DR1 allotment information, transmitting the DR1 allotment information to each apparatus control device 8, and deriving the local drooping characteristic line such that each apparatus control device 8 controls the operation of storage battery 9 on the basis of the DR1 allotment information (hereinbelow referred to as “DR1 allotment operation) is next described.

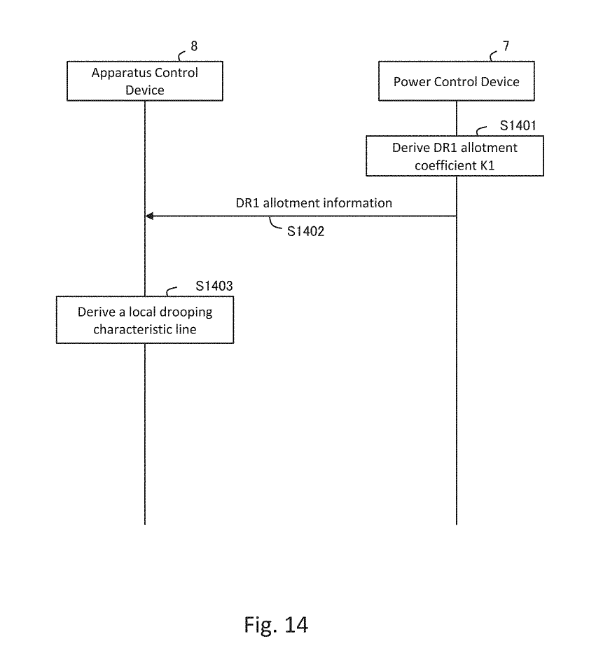

FIG. 14 is a sequence diagram for describing the DR1 allotment operation. In FIG. 14, the number of apparatus control devices 8 is assumed to be one in the interest of simplifying the explanation.

Control unit 704 of power control device 7 uses the GF assignment capacity GF_{ES-DR1} that is indicated in the most recent DR1 drooping characteristic line, the most recent total adjustable capacity P_{ES} and the equation shown in Numerical Expression 3 to derive DR1 allotment coefficient K1 (Step S1401).

K1=(GF_{ES-DR1})(P_{ES}) [Numerical Expression 3]

Control unit 704 next transmits DR1 allotment information that indicates DR1 allotment coefficient K1 and the maximum value fₘₐₓ of the frequency deviation that is indicated in the most recent DR1 drooping characteristic line from communication unit 701 to each apparatus control device 8 (Step S1402). DR1 allotment coefficient K1 is not limited to the value specified in Numerical Expression 3. For example, when electric power demand is urgently needed, a value that indicates output that forcibly approaches the limit (for example, 0.97) may be used as DR1 allotment coefficient K1. The value that indicates output that approaches the limit is not limited to 0.97 and can be changed as appropriate.

In the present exemplary embodiment, the following process is executed in Step S1402.

Control unit 704 specifies, as the storage battery distribution rate α(n) for each storage battery 9 that executes DR application 1, the smaller value of the most recent storage battery distribution rate α_{discharging}(n) during discharging and storage battery distribution rate α_{charging}(n) during charging that were derived by comprehension unit 703.

Control unit 704 next generates, for each storage battery 9 that executes DR application 1, operation-relevant information that represents storage battery distribution rate α(n) and rated output P(n) that is being held in database 702.

Control unit 704 next appends DR1 allotment information to each item of operation-relevant information.

Control unit 704 then transmits DR1 allotment information to which operation-relevant information has been appended from communication unit 701 to apparatus control device 8 that corresponds to the operation-relevant information. The DR1 allotment information to which operation-relevant information is appended is an example of GF operation control information.

In each apparatus control device 8 that executes DR application 1, control unit 805 receives DR1 allotment information to which operation-relevant information has been appended by way of communication unit 803.

Control unit 805 uses the maximum value fₘₐₓ of frequency deviation that is indicated in the DR1 allotment information to which the operation-relevant information is appended and the equation shown in Numerical Expression 4 to derive a local drooping characteristic line (Step S1403).

GF(n)=K1·α(n)P(n) [Numerical Expression 4]

The values in the numerical expression of Numerical Expression 4 are shown in the DR1 allotment information to which the operation-relevant information has been appended.

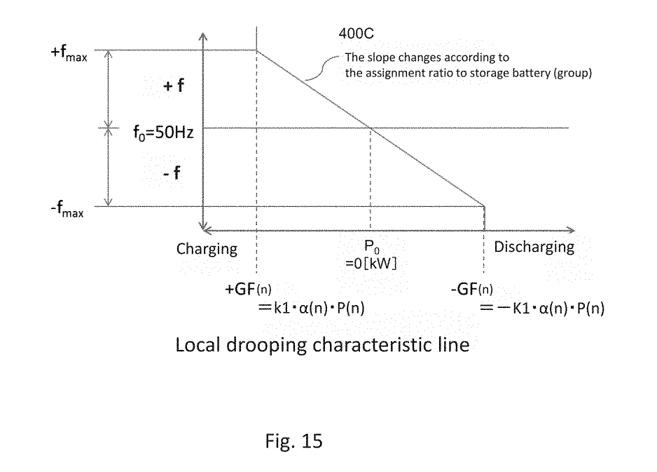

Local drooping characteristic line 400C shown in FIG. 15 is a straight line that passes through the origin (0 [kW], f₀=50 Hz) having a slope determined by GF(n) and fₘₐₓ in the range in which the frequency deviation f is −fₘₐₓ≦f≦+fₘₐₓ. In addition, local drooping characteristic line 400C takes the fixed value “−K1·α(n)·P(n)” (where the minus sign indicates discharging) in the range in which the frequency deviation f is f<−fₘₐₓ. Local drooping characteristic line 400C further takes on the fixed value “K1·α(n)·P(n)” in the range in which the frequency deviation f is +fₘₐₓ<f.

Power control device 7 and each apparatus control device 8 that executes DR application 1 repeat Steps S1401-S1403 at period T1_{GF} (for example, T1_{GF}=5 minutes).

In each apparatus control device 8 that executes DR application 1, control unit 805 continues receiving DR1 allotment information to which operation-relevant information is appended by way of communication unit 803 and holds, of the DR1 allotment information to which the operation-relevant information is appended, the most recent DR1 allotment information to which operation-relevant information is appended.

The operation by which apparatus control device 8 that executes DR application 1 controls the charging/discharging of storage battery 9 on the basis of the DR1 allotment information to which operation-relevant information is appended and the grid frequency (hereinbelow referred to as “DR1 charging/discharging control operation) is next described.

Upon reaching the starting time of DR application 1 that is indicated in the time slot information, control unit 704 of power control device 7 transmits DR1 execution spacing information that indicates the operation period T2 to apparatus control device 8 that executes DR application 1 by way of communication unit 701. The operation period T2 is, for example, 0.1 seconds. Control unit 805 of apparatus control device 8 that executes DR application 1, having received the DR1 execution spacing information by way of communication unit 803, holds the DR1 execution spacing information.

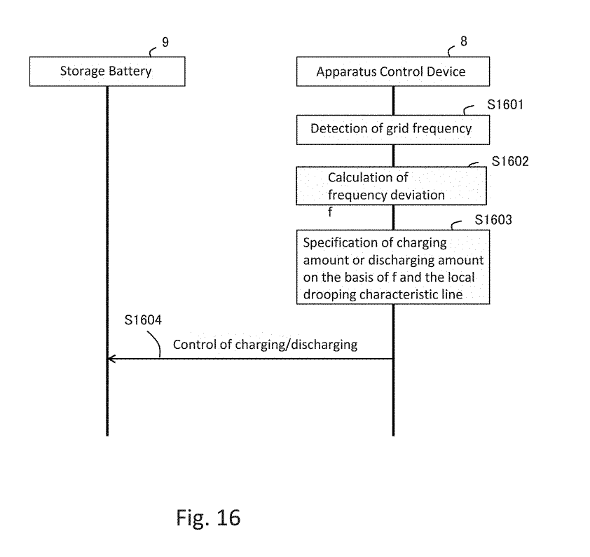

FIG. 16 is a sequence diagram for describing the charging/discharging control operation.

In apparatus control device 8 that executes DR application 1, control unit 805 causes detection unit 802 to detect the grid frequency (Step S1691).

Control unit 805 next subtracts a reference frequency (50 Hz) of the grid frequency from the detection result of detection unit 802 to calculate frequency deviation f (Step S1602).

Control unit 805 then calculates the charging amount or discharging amount of storage battery 9 that executes DR application 1 in accordance with frequency deviation f and the local drooping characteristic line (Step S1603).

In Step S1603, when the absolute value of frequency deviation f is equal to or less than the maximum value (threshold value) fₘₐₓ of the frequency deviation, control unit 805 calculates, as the adjustment power amount, the absolute value of the value “GF(n)·f/fₘₐₓ” that is obtained by multiplying GF(n) by the result of dividing frequency deviation f by fₘₐₓ.

On the other hand, when the absolute value of frequency deviation f is greater than the maximum value fₘₐₓ of the absolute value of the frequency deviation, control unit 805 calculates GF(n) as the adjustment power amount.

Control unit 805 next causes storage battery 9 that executes DR application 1 to carry out a charging operation for exactly the adjustment power amount when frequency deviation f is a positive value. When frequency deviation f is a negative value, control unit 805 causes storage battery 9 that executes DR application 1 to carry out a discharging operation for exactly the adjustment power amount (Step S1604).

Each apparatus control device 8 repeats Steps S1601-S1604 at period T2 that is indicated in the DR1 execution spacing information. As a result, the value of the frequency deviation changes each time, charging/discharging according to GF(n)·f/fₘₐₓ being effected each time.

Essentially, the frequency deviation changes each time at period T2 (=0.1 seconds), and the charging/discharging operation of storage battery 9 is carried out using the same DR1 allotment information until period T1_{GF} (=5 minutes) has elapsed.

As a result, in DR application 1 (GF adjustment process), apparatus control device 8 receives DR1 allotment information at period T1_{GF} (=5 minutes), detects the grid frequency at period T2 (=0.1 seconds) that is shorter than period T1_{GF}, and carries out the charging/discharging operation of storage battery 9 on the basis of the DR1 allotment information and grid frequency at period T2. Because DR1 allotment information that requires time for acquisition and bidirectional communication processing is acquired at a period that is longer than the detection period of the grid frequency while the grid frequency that fluctuates according to the balance of power supply and demand is detected in real time as described hereinabove, a GF adjustment process having short control spacing can also be accommodated.

### [3] Operation of Executing DR Application 2 (First LFC Adjustment Process)

A summary of the operation of executing DR application 2 is first described.

(3-1) Power control device 7 receives the SOC of storage batteries 9 from apparatus control devices 8 at period T1_{FirstLFC} and collects the SOC of storage batteries 9. Period T1_{FirstLFC} is, for example, 15 minutes.

(3-2) Power control device 7 derives total adjustable capacity P_{ES} on the basis of the SOC of storage batteries 9 for each collection of the SOC of storage batteries 9.

(3-3) Power control device 7 next transmits total adjustable capacity P_{ES} to load dispatching unit 2 at period Tₘ. Period Tₘ is equal to or greater than period T1_{FirstLFC}, and is, for example, 15 minutes.

(3-4) Load dispatching unit 2 calculates a first LFC assignment capacity LFC_{ES-D}R2 (where LFC_{ES-DR2}≦P_{ES}) for a storage battery group for each reception of total adjustable capacity P_{ES}.

(3-5) Load dispatching unit 2 uses LFC assignment capacity LFC_{ES-DR2} and the maximum value Δfₘₐₓ of the integrated value of the frequency deviation to create a DR2 charge/discharge gain line for each calculation of the first LFC assignment capacity LFC_{ES-DR2}. Load dispatching unit 2 then transmits the DR2 charge/discharge gain line to power control device 7.

(3-6) Power control device 7 calculates DR2 allotment coefficient K2 in accordance with the most recent DR2 charge/discharge gain line from load dispatching unit 2.

(3-7) Power control device 7 next transmits DR2 allotment information (DR2 allotment coefficient K2 and the maximum value Δfₘₐₓ of the integrated value of the frequency deviation) to each apparatus control device 8 at period T1_{FirstLFC}.

(3-8) Each apparatus control device 8 calculates a first local charge/discharge gain line that prescribes the charging/discharging operation of storage battery 9 on the basis of DR2 allotment coefficient K2 and the maximum value Δfₘₐₓ of the integrated value of the frequency deviation. The first local charge/discharge gain line will be described later.

(3-9) Each apparatus control device 8 uses the first local charge/discharge gain line and the frequency of power grid 3 to control the charging/discharging operation of storage battery 9.

The details of the execution operation of DR application 2 (first LFC adjustment process) are next described.

The operation by which power control device 7 derives total adjustable capacity P_{ES} on the basis of the SOC of storage batteries 9 that execute DR application 2 is first described.

The explanation of this P_{ES} derivation operation is realized by altering the readings of the explanation of the P_{ES} derivation operation in the above-described DR application 1.

“Period T1_{GF}” is altered to “period T1_{FirstLFC}.”

“DR application 1” is altered to “DR application 2.”

The operation by which power control device 7 communicates with load dispatching unit 2 to comprehend the DR2 charge/discharge gain line (hereinbelow referred to as the “DR2 comprehension operation”) is next described.

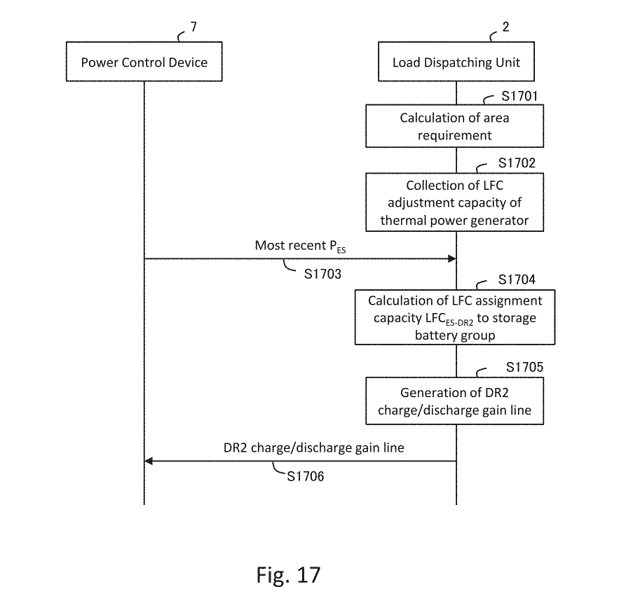

FIG. 17 is a sequence diagram for describing the DR2 comprehension operation. Control unit 204 of load dispatching unit 2 uses the grid frequency that was detected in frequency meter 201 to calculate the Area Requirement AR (Step S1701).

Control unit 204 next collects the LFC adjustment capacity of thermal power generator 1 from a thermal power generator control unit (not shown) (Step S1702).

On the other hand, communication unit 701 of power control device 7 transmits to load dispatching unit 2 the most recent total adjustable capacity P_{ES} (Step S1703).

Communication unit 203 of load dispatching unit 2 receives the most recent total adjustable capacity P_{ES} that was transmitted from communication unit 701 of power control device 7. Communication unit 203 supplies the most recent total adjustable capacity P_{ES} to control unit 204.

Control unit 204, upon receiving the most recent total adjustable capacity P_{ES}, uses the area requirement AR, the LFC adjustment capacity of thermal power generator 1, and the most recent total adjustable capacity P_{ES} to derive the LFC capacity. Control unit 204 next assigns to thermal power generator 1, of the LFC capacity, a capacity from which the rapid fluctuation component has been removed. Control unit 204 next assigns the remaining LFC capacity LFC_{ES-DR2} (where LFC_{ES-DR2}≦P_{ES}) as LFC assignment capacity LFC_{ES-DR2} to the storage battery group that executes DR application 2 (Step S1704).

Control unit 204 determines the ratio of the assignment of the LFC capacity to thermal power generator 1 and LFC assignment capacity LFC_{ES-DR2} while taking into account the economic perspective as well as considering the assigned portion of the EDC (Economic Load Dispatching Control) component.

Control unit 204 next generates DR2 charge/discharge gain line (see FIG. 10B) that represents the LFC assignment capacity LFC_{ES-DR2} and the maximum value Δfₘₐₓ of the integrated value of the frequency deviation (Step S1705).

The DR2 charge/discharge gain line shown in FIG. 10B represents the charging/discharging amount of the storage battery group (storage batteries 9 that execute DR application 2) with respect to the integrated value Δf of the frequency deviation. The DR2 charge/discharge gain line changes by varying between line 400A and line 400B according to the size (LFC_{ES-DR2} and LFC_{ES-DR2′}) of LFC assignment capacity LFC_{ES-DR2} within the range in which “LFC assignment capacity LFC_{ES-DR2}≦total adjustable capacity P_{ES}.”

Control unit 204 next transmits the DR2 charge/discharge gain line from communication unit 203 to power control device 7 (Step S1706).

Power control device 7 and load dispatching unit 2 repeat Steps S1701-S1706 (DR2 comprehension operation) at period Tₘ.

Comprehension unit 703 of power control device 7 continues receiving the DR2 charge/discharge gain line by way of communication unit 701 and holds, of the DR2 charge/discharge gain line, the most recent charge/discharge gain line.

The operations of generating DR2 allotment information, transmitting the DR2 allotment information to each apparatus control device 8, and deriving local charge/discharge gain line in order that each apparatus control device 8 controls the operation of storage battery 9 on the basis of the DR2 allotment information (hereinbelow referred to as the “DR2 allotment operation”) are next described.

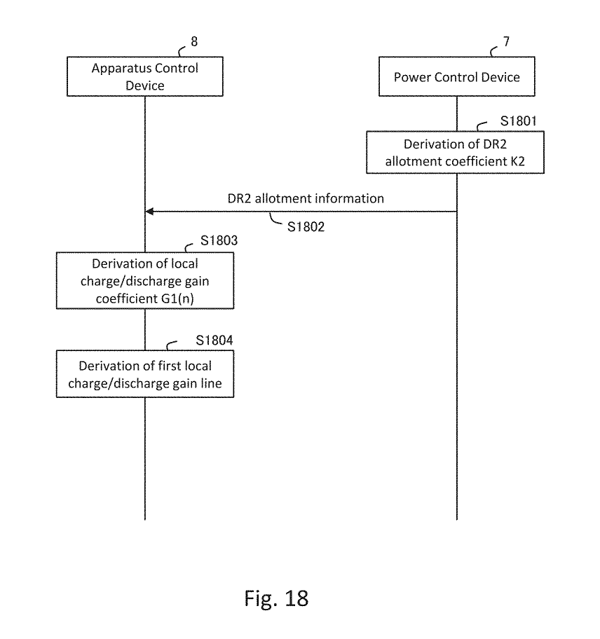

FIG. 18 is a sequence diagram for describing the DR2 allotment operation. In FIG. 18, the number of apparatus control devices 8 that execute DR application 2 is assumed to be one in the interest of simplifying the explanation.

Control unit 704 of power control device 7 uses the LFC assignment capacity LFC_{ES-DR2} that is indicated in the most recent charge/discharge gain line, the most recent total adjustable capacity P_{ES} and the numerical expression shown in Numerical Expression 5 to derive DR2 allotment coefficient K2 (Step S1801).

$$K 2 = \frac{{LFC}_{ES \cdot DR 2}}{{P}_{ES}} \qquad [ Numerical Expression 5 ]$$

Control unit 704 next transmits DR2 allotment information that indicates DR2 allotment coefficient K2 and the maximum value Δfₘₐₓ of the integrated value of the frequency deviation that is indicated in the most recent DR2 charge/discharge gain line from communication unit 701 to each apparatus control device 8 that executes DR application 2 (Step S1802). DR2 allotment coefficient K2 is not limited to the value specified in Numerical Expression 5. For example, at times of stringent power supply and demand, a value (for example, 0.97) that indicates the forcible supply of output that approaches the limit may be used as DR2 allotment coefficient K2. The value that indicates that output be supplied that approaches the limit is not limited to 0.97 and can be altered as appropriate.

In the present exemplary embodiment, the following process is executed in Step S1802.

Control unit 704 specifies, as the storage battery distribution rate α(n) for each storage battery 9 that executes DR application 2, the smaller value of the most recent storage battery distribution rate α_{discharging}(n) during discharging and storage battery distribution rate α_{charging}(n) during charging that were derived by comprehension unit 703.

Control unit 704 then generates operation-relevant information that represents the storage battery distribution rate α(n) and the rated output P(n) that is held in database 702 for each storage battery 9 that executes DR application 2.

Control unit 704 next appends the DR2 allotment information to each item of operation-relevant information.

Control unit 704 then transmits the DR2 allotment information to which the operation-relevant information has been appended to apparatus control device 8 that corresponds to the operation-relevant information from communication unit 701. The DR2 allotment information to which the operation-relevant information has been appended is an example of the first LFC operation control information.

In each apparatus control device 8 that executes DR application 2, control unit 805 receives the DR2 allotment information to which the operation-relevant information has been appended by way of communication unit 803.

Control unit 805 uses the DR2 allotment information to which the operation-relevant information has been appended and the equation shown in Numerical Expression 6 to derive a local charge/discharge gain coefficient G1(n) (Step S1803).

$$G 1 ( n ) = \frac{K 2 \cdot α ( n ) \cdot P ( n )}{Δ {f}_{max}} \qquad [ Numerical Expression 6 ]$$

The values in the equation of Numerical Expression 6 are indicated in the DR2 allotment information to which the operation-relevant information has been appended.

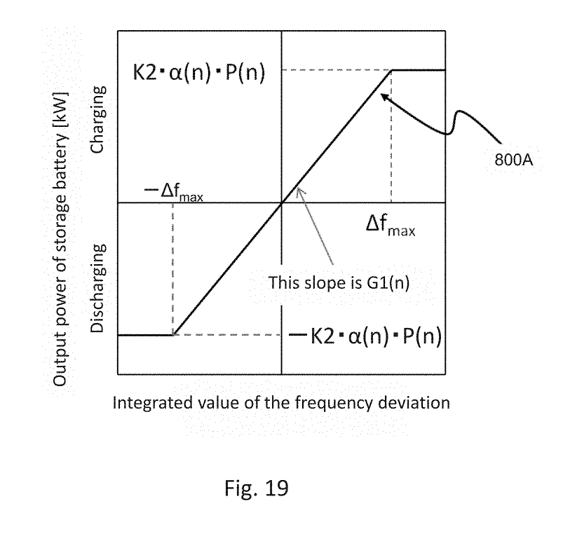

Control unit 805 next uses the local charge/discharge gain coefficient G1(n) and the maximum value Δfₘₐₓ of the integrated value of the frequency deviation indicated in the DR2 allotment information to which the operation-relevant information is appended to derive first local charge/discharge gain line 800A shown in FIG. 19 (Step S1804).

First local charge/discharge gain line 800A shown in FIG. 19 is a straight line that passes through the origin 0 with a slope that is the local charge/discharge gain coefficient G1(n) in the range in which the integrated value Δf of the frequency deviation is −Δfₘₐₓ≦Δf≦Δfₘₐₓ. In addition, first local charge/discharge gain line 800A assumes a fixed value of “−K2·α(n)·P(n)” (where the minus sign indicates discharging) in the range in which the integrated value Δf of frequency deviation is Δf<−Δfₘₐₓ. First local charge/discharge gain line 800A further assumes a fixed value “K2·α(n)·P(n)” in the range in which the integrated value Δf of the frequency deviation is Δfₘₐₓ<Δf.

Power control device 7 and each apparatus control device 8 that executes DR application 2 repeat Steps S1801-S1804 at period T1_{FirstLFC}.

In each apparatus control device 8 that executes DR application 2, control unit 805 continues receiving DR2 allotment information to which operation-relevant information is appended by way of communication unit 803, and holds, of the DR2 allotment information to which operation-relevant information is appended, the most recent DR2 allotment information to which operation-relevant information is appended.

The operation in which apparatus control device 8 that executes DR application 2 controls the charging/discharging of storage battery 9 on the basis of the DR2 allotment information to which operation-relevant information is appended and the grid frequency (hereinbelow referred to as the “DR2 charging/discharging control operation”) is next described.

Control unit 704 of power control device 7 transmits DR2 execution spacing information that indicates operation period T2-A to apparatus control device 8 that executes DR application 2 by way of communication unit 701 at the starting time of DR application 2 that is indicated in the time slot information. Operation period T2-A is, for example, 1 second. Control unit 805 of apparatus control device 8 that executes DR application 2, upon receiving the DR2 execution spacing information by way of communication unit 803, holds the DR2 execution spacing information.

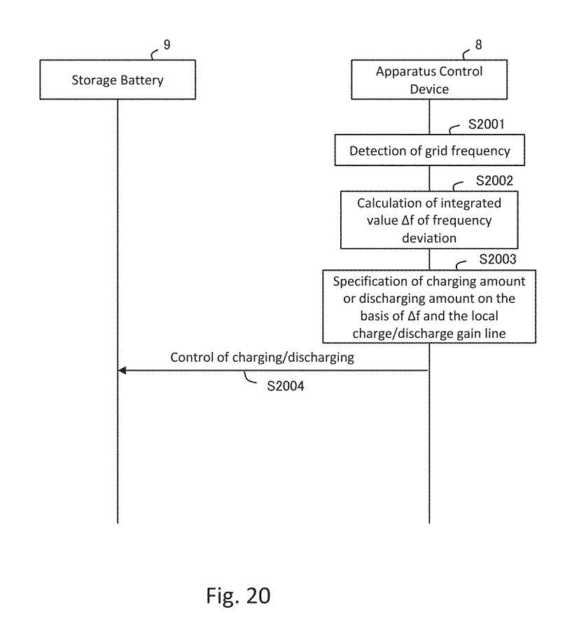

FIG. 20 is a sequence diagram for describing the charging/discharging control operation. In apparatus control device 8 that executes DR application 2, control unit 805 causes detection unit 802 to detect the grid frequency (Step S2001).

Control unit 805 next calculates the integrated value Δf of frequency deviation by subtracting the reference frequency (50 Hz) of the grid frequency from the detection result of detection unit 802 and integrating the result of subtraction (Step S2002).

Control unit 805 then calculates the amount of charging or the amount of discharging of storage battery 9 that executes DR application 2 in accordance with the integrated value Δf of frequency deviation and the local charge/discharge gain line (Step S2003).

In Step S2003, control unit 805 calculates, as the adjustment power amount, the absolute value of the value (G1(n)·Δf) obtained by multiplying the local charge/discharge gain coefficient G1(n) by the integrated value Δf of frequency deviation when the absolute value of the integrated value Δf of frequency deviation is equal to or less than the maximum value (threshold value) Δfₘₐₓ of the integrated value of the frequency deviation.

On the other hand, when the absolute value of the integrated value Δf of the frequency deviation is greater than the maximum value Δfₘₐₓ of the integrated value of the frequency deviation, control unit 805 calculates, as the adjustment power amount, a value (K2·α(n)·P(n)) that is obtained by multiplying together allotment coefficient K2, storage battery distribution rate α(n) and rated output P(n).

In this example, a case of point symmetry is shown in which the slope of G1(n) is the same on the charging side and discharging side in FIG. 19, but in actuality, cases lacking point symmetry can also be assumed. In such cases, G1(n) is determined by the same concept as shown above.

Control unit 805 next causes storage battery 9 that executes DR application 2 to execute a charging operation of exactly the adjustment power amount when the integrated value Δf of the frequency deviation is a positive value. Alternatively, control unit 805 causes storage battery 9 that executes DR application 2 to execute a discharging operation of exactly the adjustment power amount when the integrated value Δf of the frequency deviation is a negative value (Step S2004).

Each apparatus control device 8 repeats Steps S2001-S2004 at period T2-A that is indicated in the DR2 execution spacing information. As a result, the integrated value of frequency deviation changes each time, and charging/discharging is effected each time according to G1(n)·Δf.

Essentially, the integrated value of frequency deviation changes each time at period T2-A (=1 second), and the charging/discharging operation of storage battery 9 is carried out using the same DR2 allotment information until period T1_{FirstLFC} (=15 minutes) has elapsed.

As a result, in DR application 2 (first LFC adjustment process), apparatus control device 8 receives DR2 allotment information at period T1_{FirstLFC} (=15 minutes), detects the grid frequency at period T2-A that is shorter than period T1_{FirstLFC}, and carries out a charging/discharging operation of storage battery 9 on the basis of the DR2 allotment information and grid frequency at period T2-A. The first LFC adjustment process can also be accommodated because DR2 allotment information that requires time for acquisition and bidirectional communication processing is acquired at a period that is longer than the period of detecting grid frequency while the grid frequency that fluctuates according to the balance of power supply/demand is detected at period T2-A as described hereinabove.

### [4] Operation of Executing DR Application 3 (Second LFC Adjustment Process)

A summary of the operation of executing DR application 3 is first described.

(4-1) Power control device 7 receives the SOC of storage batteries 9 from apparatus control devices 8 at period T1_{SecondLFC} to collect the SOC of storage batteries 9. Period T1_{SecondLFC} is, for example, 15 minutes.

(4-2) Power control device 7 derives total adjustable capacity P_{ES} on the basis of the SOC of storage batteries 9 for each collection of SOC of storage batteries 9.

(4-3) Power control device 7 next transmits the total adjustable capacity P_{ES} to load dispatching unit 2 at period Tₘ. Period Tₘ is equal to or greater than period T1_{SecondLFC}.

(4-4) Load dispatching unit 2 calculates the LFC assignment capacity LFC_{ES-DR3} (where LFC_{ES-DR3}≦P_{ES}) for the storage battery group for each reception of total adjustable capacity P_{ES}.

(4-5) Load dispatching unit 2 uses the maximum value i1ₘₐₓ of index i1, which is the integrated value of the corrected frequency deviation realized by correcting the frequency deviation by the flow on linking line 4, and the LFC assignment capacity LFC_{ES-DR3} to create a DR3 charge/discharge gain line for each calculation of the LFC assignment capacity LFC_{ES-DR3}. Load dispatching unit 2 then transmits the DR3 charge/discharge gain line to power control device 7.

(4-6) Power control device 7 calculates DR3 allotment coefficient K3 in accordance with the most recent DR3 charge/discharge gain line from load dispatching unit 2.

(4-7) Power control device 7 next transmits the DR 3 allotment information (DR3 allotment coefficient K3 and the maximum value i1ₘₐₓ of index i1) to each apparatus control device 8 at period T1_{SecondLFC}.

(4-8) Each apparatus control device 8 calculates a second local charge/discharge gain line that prescribes the charging/discharging operation of storage battery 9 on the basis of DR3 allotment coefficient K3 and the maximum value i1ₘₐₓ of index i1. The second local charge/discharge gain line will be described later.

(4-9) Each apparatus control device 8 uses the second local charge/discharge gain line and the index i1 that was received to control the charging/discharging operation of storage battery 9.

The details of the execution operation of DR application 3 are next described.

The operation by which power control device 7 derives total adjustable capacity P_{ES} on the basis of the SOC of storage batteries 9 that execute DR application 3 is first described.

The explanation of this P_{ES} derivation operation is realized by altering the explanation of the above-described P_{ES} derivation operation in DR application 2 as shown below.

“Period T_{FirstLFC}” is altered to “period T1_{secondLFC}.”

“DR application 2” is altered to “DR application 3.”

The operation by which power control device 7 communicates with load dispatching unit 2 to comprehend the DR33 charge/discharge gain line (hereinbelow referred to as the “DR3 comprehension operation”) is next described.

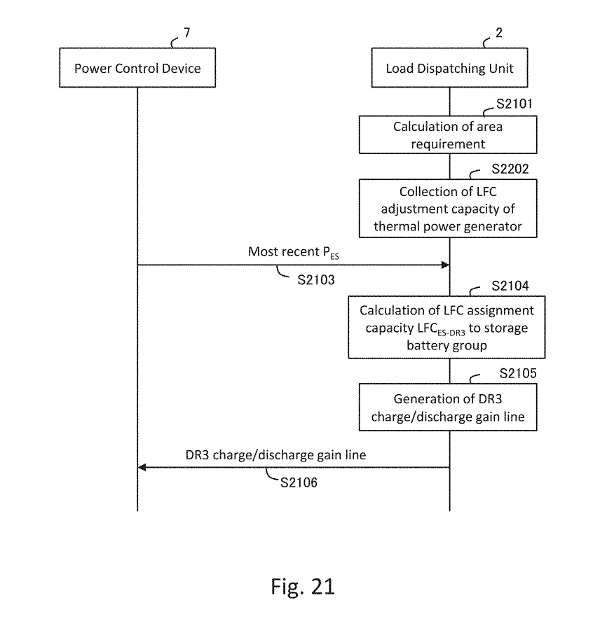

FIG. 21 is a sequence diagram for describing the DR3 comprehension operation.

Control unit 204 of load dispatching unit 2 uses the grid frequency that was detected by frequency meter 201 and the flow on linking line 4 that was detected by flow detection unit 202 to calculate area requirement AR-1 (Step S2101).

Control unit 204 next collects the LFC adjustment capacity of thermal power generator 1 from the thermal power generator control unit (not shown) (Step S2102).

On the other hand, control unit 701 of power control device 7 transmits the most recent total adjustable capacity P_{ES} to load dispatching unit 2 (Step S2103).

Communication unit 203 of load dispatching unit 2 receives the most recent total adjustable capacity P_{ES} that was transmitted from communication unit 701 of power control device 7. Communication unit 203 supplies this most recent total adjustable capacity P_{ES} to control unit 204.

Upon receiving the most recent total adjustable capacity P_{ES}, control unit 204 uses the area requirement AR-1, the LFC adjustment capacity of thermal power generator 1, and the most recent total adjustable capacity P_{ES} to derive the LFC capacity. Control unit 204 next assigns, of the LFC capacity, a capacity from which the rapid fluctuation component has been removed to thermal power generator 1. Control unit 204 next assigns, as the LFC assignment capacity LFC_{ES-DR3}, the remaining LFC capacity LFC_{ES-DR3} (where LFC_{ES-DR3}≦P_{ES}) to a storage battery group that executes DR application 3 (Step S2104).

Control unit 204 while taking into account the economic perspective as well as considering the allotment of the EDC component to determine the ratio of the assignment of LFC capacity to thermal power generator 1 and the LFC assignment capacity LFC_{ES-DR3}.

Control unit 204 then generates a DR3 charge/discharge gain line (see FIG. 10C) that represents the LFC assignment capacity LFC_{ES-DR3} and the maximum value i1ₘₐₓ of index i1 that was determined in advance (Step S2105).

The DR3 charge/discharge gain line shown in FIG. 10C represents the charging/discharging amount of the storage battery group (storage batteries 9 that execute DR application 3) with respect to index i1. The DR3 charge/discharge gain line changes by varying between line 400C and line 400D according to the size (LFC_{ES-DR3} and LFC_{ES-DR3′}) of the LFC assignment capacity LFC_{ES-DR3} within the range in which “LFC assignment capacity LFC_{ES-DR3}≦total adjustable capacity P_{ES}.”

Control unit 204 next transmits the DR3 charge/discharge gain line from communication unit 203 to power control device 7 (Step S2106).

Power control device 7 and load dispatching unit 2 repeat the operations of Steps S2101-S2106 (DR3 comprehension operation) at period Tₘ.

Comprehension unit 703 of power control device 7 continues receiving the DR3 charge/discharge gain line by way of communication unit 701 and holds, of the DR3 charge/discharge gain line, the most recent DR3 charge/discharge gain line.

The operations of generating the DR3 allotment information, transmitting the DR3 allotment information to each apparatus control device 8, and deriving a second local charge/discharge gain line in order that each apparatus control device 8 controls the operation of storage battery 9 on the basis of the DR3 allotment information (hereinbelow referred to as the “DR3 allotment operation”) are next described.

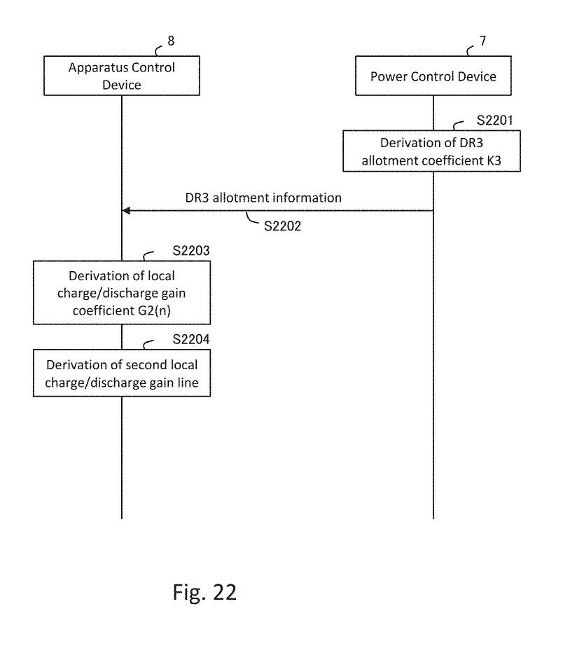

FIG. 22 is a sequence diagram for describing the DR3 allotment operation. In FIG. 22, the number of apparatus control devices 8 that execute DR application 3 is assumed to be one in the interest of simplifying the explanation.

Control unit 704 of power control device 7 uses the LFC assignment capacity LFC_{ES-DR3} that is indicated in the most recent DR3 charge/discharge gain line, the most recent total adjustable capacity P_{ES}, and the equation shown in Numerical Expression 7 to derive DR3 allotment coefficient K3 (Step S2201).

$$K 3 = \frac{{LFC}_{ES \cdot DR 3}}{{P}_{ES}} \qquad [ Numerical Expression 7 ]$$

Control unit 704 next transmits DR3 allotment information that indicates DR3 allotment coefficient K3 and the maximum value i1ₘₐₓ of index i1 that is indicated in the most recent DR3 charge/discharge gain line from communication unit 701 to each apparatus control device 8 that executes DR application 3 (Step S2202). DR3 allotment coefficient K3 is not limited to the value specified in Numerical Expression 7. For example, at times of stringency of the power supply/demand, a value (for example 0.97) that indicates the forcible supply of output that approaches the limit may also be used as DR3 allotment coefficient K3. The value that indicates the supply of output that approaches the limit is not limited to 0.97 and can be altered as appropriate.

In the present exemplary embodiment, the following process is executed in Step S2202.

Control unit 704 specifies, as storage battery distribution rate α(n) for each storage battery 9 that executes DR application 3, the smaller value of the most recent storage battery distribution rate α_{discharging}(n) during discharging and storage battery distribution rate α_{charging}(n) during charging that were derived by comprehension unit 703.

Control unit 704 next generates, for each storage battery 9 that executes DR application 3, operation-relevant information that represents storage battery distribution rate α(n) and rated output P(n) that is held in database 702.

Control unit 704 appends DR3 allotment information to each item of operation-relevant information.

Control unit 704 transmits from communication unit 701 the DR3 allotment information to which the operation-relevant information has been appended to apparatus control device 8 that corresponds to the operation-relevant information. The DR3 allotment information to which operation-relevant information has been appended is also an example of the second LFC operation control information.

In each apparatus control device 8 that executes DR application 3, control unit 805 receives DR3 allotment information to which operation-relevant information is appended by way of communication unit 803.

Control unit 805 uses the DR3 allotment information to which operation-relevant information is appended and the numerical expression shown in Numerical Expression 8 to derive a local charge/discharge gain coefficient G2(n) (Step S2203).

$$G 2 ( n ) = \frac{K 3 \cdot α ( n ) \cdot P ( n )}{i {1}_{max}} \qquad [ Numerical Expression 8 ]$$

The values in the equation of Numerical Expression 8 are shown in the DR3 allotment information to which operation-relevant information has been appended.

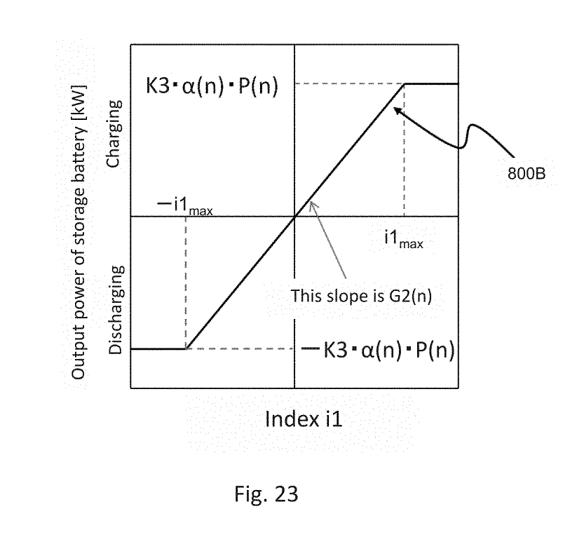

Control unit 805 next uses the local charge/discharge gain coefficient G2(n) and the maximum value i1ₘₐₓ of index i1 that is shown in the DR3 allotment information with appended operation-relevant information to derive second local charge/discharge gain line 800B shown in FIG. 23 (Step S2204).

The second local charge/discharge gain line 800B shown in FIG. 23 is a straight line that passes through the origin 0 with slope that is the local charge/discharge gain coefficient G2(n) in the range in which index i1 is −i1ₘₐₓ≦i1≦i1ₘₐₓ. In addition, the second local charge/discharge gain line 800B assumes the fixed value “−K3·α(n) P(n)” (where the minus sign represents discharging) in the range in which index i1 is i1<−i1ₘₐₓ. Further, the second local charge/discharge gain line 800B assumes the fixed value “K3·α(n)·P(n)” in the range in which index i1 is i1ₘₐₓ<i1.

Power control device 7 and each apparatus control device 8 that executes DR application 3 repeat Steps S2201-S2204 at period T1_{SecondLFC}.

In each apparatus control device 8 that executes DR application 3, control unit 805 goes on receiving DR3 allotment information to which operation-relevant information has been appended by way of communication unit 803 and holds, of the DR3 allotment information to which operation-relevant information has been appended, the most recent DR3 allotment information to which operation-relevant information has been appended.

The operation in which apparatus control device 8 that executes DR application 3 controls the charging/discharging of storage battery 9 on the basis of the DR3 allotment information to which operation-relevant information has been appended and index i1 (hereinbelow referred to as the “DR3 charging/discharging control operation”) is next described.

At the starting time of DR application 3 that is indicated in the time slot information, control unit 704 of power control device 7 transmits DR3 execution spacing information that indicates operation period T3_{SecondLFC} to apparatus control device 8 that executes DR application 3 by way of communication unit 701. Operation period T3_{SecondLFC} is, for example, 1 second. Control unit 805 of apparatus control device 8 that executes DR application 3, having received DR3 execution spacing information by way of communication unit 803, holds the DR3 execution spacing information.

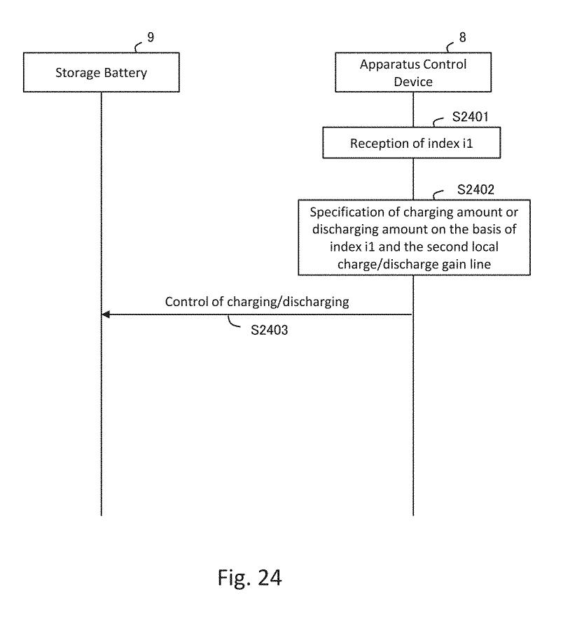

FIG. 24 is a sequence diagram for describing the charging/discharging control operation.

In apparatus control device 8 that executes DR application 3, communication unit 803 receives index i1 that was transmitted by power control device 7 (Step S2401).

Control unit 805 next calculates the amount of charging or the amount of discharging of storage battery 9 that executes DR application 3 in accordance with index i1 and the second local charge/discharge gain line that were received by communication unit 803 (Step S2402).

In Step S2402, when the absolute value of index i1 is equal to or less than maximum value (threshold value) i1ₘₐₓ of index i1, control unit 805 calculates the absolute value of the value (G2(n)·i1) that is the product of multiplying index i1 by the local charge/discharge gain coefficient G2(n) as the adjustment power amount.

On the other hand, if the absolute value of index i1 is greater than the maximum value 1ₘₐₓ of index i1, control unit 805 calculates the value (K3·α(n)·P(n)) that is the product of multiplying together allotment coefficient K3, storage battery distribution rate α(n), and rated output P(n) as the adjustment power amount.

In this example, a case of point symmetry is shown in which the slope of G2(n) is the same on the charging side and discharging side in FIG. 23, but in actuality, cases that lack point symmetry are also considered. In such a case, G2(n) is determined by the same approach as in the above-described case.

Control unit 805 next causes storage battery 9 that executes DR application 3 to execute a charging operation of exactly the adjustment power amount when index i1 is a positive value. Alternatively, when index i1 is a negative value, control unit 805 causes storage battery 9 that executes DR application 3 to execute a discharging operation of exactly the adjustment power amount (Step S2403).

Each apparatus control device 8, repeats Steps S2401-S2403 at period T3_{SecondLFC} that is indicated in DR3 execution spacing information. As a result, the value of index i1 changes each time, charging/discharging being effected each time according to G2(n)·i1.

In the present exemplary embodiment, a case of deriving index i1 was shown, but the derivation is not limited to the method shown in the present exemplary embodiment and an index may also be used that is derived by a different method in the load dispatching unit. An index can be offered as an example that is similar to the LFC signal that is distributed by PJM, which is a U.S. ISO (Independent System Operator).

Essentially, index i1 changes each time at period T3_{SecondLFC} that is shorter than period T1_{SecondLFC}, and the charging/discharging operation of storage battery 9 is carried out using the same DR3 allotment information until period T1_{SecondLFC} (=15 minutes) has elapsed.

As a result, in DR application 3 (the second LFC adjustment process), apparatus control device 8 receives DR3 allotment information at period T1_{SecondLFC} (=15 minutes), receives index i1 at period T3_{SecondLFC} that is shorter than period T1_{SecondLFC}, and carries out a charging/discharging operation of storage battery 9 on the basis of the DR3 allotment information and index i1 at period T3_{SecondLFC}. As described hereinabove, because DR3 allotment information that requires time for acquisition and bidirectional communication processing is acquired at a period that is longer than the reception period of index i1 while index i1 that fluctuates according to the power supply/demand balance is being received at period T3_{SecondLFC}, the second LFC adjustment process can also be accommodated.

### [5] Operation of Executing DR Application 4 (Balancing Process)

As an example of DR application 4 in the present exemplary embodiment, an application is described in which a planned-value balancing process is implemented at a thirty-minute integrated value. This is a PPS application.

By forming a bilateral contract with a power-generation business, a PPS is able to treat a renewable power source such as solar power generator 111 or wind power generator 112 as its own power source. Alternatively, a PPS can increase the power supply capability by procuring electric power from, for example, a spot market or a futures market.

In the interest of simplifying the explanation in the present exemplary embodiment, “an application of carrying out 30-minute planned-value balancing” is described in which power generation in renewable power sources 111 and 112 is implemented according to a previously planned value.

Although not shown in the drawing, solar power generators 111 shown in FIG. 8 are provided at a plurality of sites. The rated value of the total amount of generated power of solar power generators 111 is assumed to be 5 MW. Although not shown in the drawing, wind power generators 112 are also provided at a plurality of sites. The rated value of the total amount of generated power of wind power generators 112 is assumed to be 4 MW.

Solar power generators 111 generate power in time slots in which there is sun. Wind power generators 112 are able to generate power according to wind conditions regardless of the time.

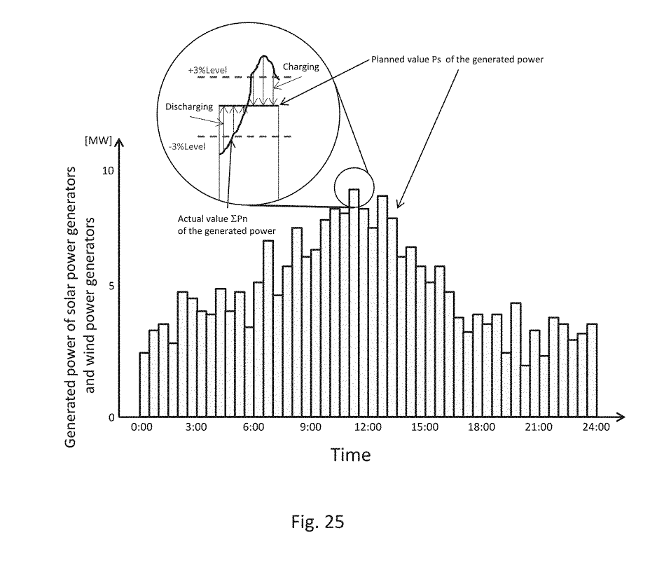

On the day before a day of implementing a 30-minute planned-value balancing process, control unit 704 in a PPS first creates a power generation plan for the next day in 48 30-minute time slots as shown in FIG. 25 based on the power generation forecast of solar power generators 111 and wind power generators 112.

In addition, control unit 704 selects from among a plurality of storage batteries 9, storage battery group m that implements the 30-minute planned-value balancing (DR application 4). In the present exemplary embodiment, all storage batteries 9 are assumed to belong to storage battery group m. On the day of implementing the thirty-minute planned-value balancing process, detection units 111a and 112a measure the generated power Pn for each second of each of renewable power sources 111 and 112.

Detection units 111a and 112a each communicate the integrated values of the generated power that were measured for each second by way of communication units 111b and 112b, respectively, to communication unit 701 of power control device 7 at period T3_{BL} (for example, T3_{BL}=10 seconds).

In power control device 7, comprehension unit 703 integrates all of the amount of generated power of solar power generators 111 and wind power generators 112 to find integrated value ΣPn.

Comprehension unit 703 next calculates the difference ΔP (ΔP=Ps−ΣPn) between integrated value ΣPn and planned value Ps.

Comprehension unit 703 next transmits, at period T3_{BL}, the difference ΔP to apparatus control device 8 that controls storage batteries 9 that belong to storage battery group m by way of communication unit 701. Here, difference ΔP is an example of index i2. In addition, apparatus control devices 8 that control storage batteries 9 that belong to storage battery group m are also referred to as “apparatus control devices m.”

In apparatus control devices m, communication units 803 receive difference ΔP.

Further, in apparatus control devices m, communication units 803 receive operation control information am at period T1_{BL} (for example, T1_{BL}=5 minutes).

The derivation of operation control information am is next described.

In the present exemplary embodiment, it will be assumed that the output βm [kW] of C rate 1 is used as the rating of each storage battery 9 (assuming that a storage battery having SOC of 0% will achieve SOC of 100% if charged at the output of C rate 1 for one hour. Alternatively, C rate 1 is the output that will deplete a storage battery having SOC of 100% to an SOC of 0%.)

In power control device 7, communication unit 701 collects the SOC from storage batteries 9 from each apparatus control device m at period T1_{BL}.

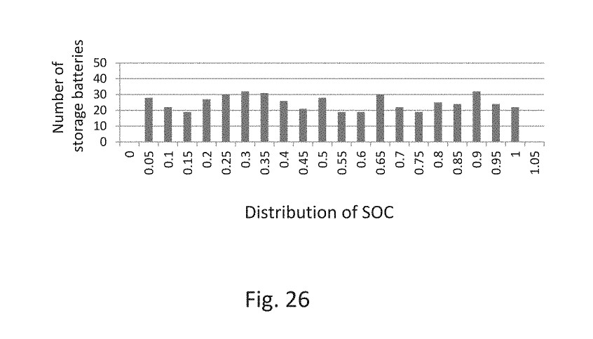

It is here assumed that the number of storage batteries 9 belonging to storage battery group m is 500 in this instance, and that the distribution of SOC is the distribution shown in FIG. 26.

Control unit 704 divides storage battery group m into storage battery group 1 made up of storage batteries having SOC equal to or greater than 50% and storage battery group n made up of storage batteries having SOC lower than 50%.

The method of deriving operation control information am is here described on the assumption that Σβ1=Pl (Total output of storage battery group 1 in which SOC is equal to or greater than 50%) and Σβn=Pn (total output of storage battery group n in which SOC is less than 50%).

(1) When ΔP (=Ps−ΣPn)>0 (a condition requiring discharging):

When ΔP (=Ps−ΣPn)>0, control unit 704 determines that Pl (the total output of storage battery group 1 in which SOC is equal to or greater than 50%) is to be used in the balancing process.

Control unit 704 next determines αm1=β1/Pl (the ratio of the output of the object storage batteries to the total output of the storage battery group that includes the object storage batteries) as the operation control information αm1 for storage battery group 1. Control unit 704 further determines αmn=0 as the operation control information αmn for storage battery group n.

(2) When ΔP (=Ps−ΣPn)<0 (a condition requiring charging):

When ΔP (=Ps−ΣPn)<0, control unit 704 determines that Pn (the total output of storage battery group n in which SOC is less than 50%) is to be used in the balancing process.

Control unit 704 next determines αmn=βn/Pn as the operation control information αm1 for storage battery group n. Control unit 704 further determines αm1=0 as operation control information αm1 for storage battery group 1.

### (3) When ΔP (=Ps−ΣPn)=0:

When ΔP (=Ps−ΣPn)=0, control unit 704 determines αm=0 as operation control information αm of storage battery group m. In the present exemplary embodiment, a case is assumed in which the total number of storage batteries that belong to storage battery group m is sufficiently large, and Pl and Pn are always greater than |Ps−ΣPn|.

When control unit 805 in apparatus control device m then receives difference ΔP at period T3_{BL} by way of communication unit 803, control unit 805 uses operation control information am that is received in advance at period T1_{BL} to implement charging/discharging of the value ΔP×αm of storage batteries 9. Control unit 704 implements updating of operation control information am on the basis of the SOC value at period T1_{BL}.

By means of this charging/discharging, the planned-value balancing can be realized in 30 minutes.

In the present exemplary embodiment, a case was described in which T3_{BL}=10 seconds, but T3_{BL} can be altered as appropriate. For example, taking into consideration limiting conditions of the application such as the number of minutes to be expended in realizing balancing, period T3_{BL} may be set to, for example, T3_{BL}=from several minutes to 30 minutes. Here, if the interval of T3_{BL} is long and a sufficient time interval is obtained for calculating the operation control information for the storage battery group that is to be the object, T1_{BL} may be set equal to T3_{BL}.

When the interval of T3_{BL} is short and there are as many as 100,000 storage batteries that are the objects of control, it is effective to implement communication of T3_{BL} by using a communication technology such as MQTT that has a high real-time capability.

In the present exemplary embodiment, an example was shown in which a balancing process was used for power generation, but another balancing process may also be used as the balancing process.

For example, in addition to the amount of generated power of renewable power sources 111 and 112, comprehension unit 703 uses, for example, a B-route of a smart meter to collect the total amount of demand of customers by way of communication unit 701. Comprehension unit 703 then uses the difference of the total amount of demand for power for this total amount of generated power as ΔP. The charging/discharging of storage batteries is then controlled as described above using this ΔP. In this case, the 30-minute balancing application of the power supply/demand of a PPS can be accommodated.

Difference ΔP changes each time at period T3_{BL} (=10 seconds), but the charging/discharging operation of storage batteries 9 is carried out using operation control information am until period T1_{BL} (=5 minutes) elapses.

In DR application 4 (balancing adjustment process), apparatus control device 8 receives operation control information am at period T1_{BL} (=5 minutes), receives difference ΔP at period T3_{BL} (=10 seconds) that is shorter than period T1_{BL}, and carries out a charging/discharging operation of storage batteries 9 on the basis of operation control information am and difference ΔP at period T3_{BL}. As shown hereinabove, because operation control information am that requires time for acquisition and bidirectional communication processing is acquired at a period that is longer than the period of receiving difference ΔP while difference ΔP that fluctuates according to the power supply/demand balance is being received in real time, a balancing adjustment process having a short control interval can be accommodated.

### [6] Operation of Executing DR Application 5 (Instantaneous Adjustment Process)

The instantaneous adjustment application of power supply and demand is described as an instantaneous adjustment process.

This application takes a form in which a PPS provides the function of “instantaneous adjustment” to a power company.

The PPS appeals to, of customers who purchase power from a PPS, customers who, for example, have storage batteries to participate in this application. A contract of a form that continues 24 hours/365 days is effective. A contract is hereinbelow assumed in which all customers participate in this application.

In the PPS, control unit 704 first collects, by means of bidirectional communication at period T1_{MO} (for example, 15 minutes), power Pn [kW] that storage battery 9 of each customer can discharge at the time of activation of the instantaneous adjustment application (a value of the power that can be continuously discharged for ten minutes based on the SOC state of each storage battery) and voltage Vn of the linking point. Here, the linking point is the linking point of power grid 3 and storage battery 9.

Control unit 704 divides the storage battery group that is made up of storage batteries 9 into storage battery group U1 that permits discharge according to the grid frequency and storage battery group U2 that does not permit discharge that accord with the grid frequency.

Storage battery group U1 satisfies the operating condition in which voltage Vn does not deviate from a prescribed range despite the simultaneous implementation of discharging of storage batteries that belong to storage battery group U1. The PPS uses this operation condition to divide the storage battery group into storage battery group U1 and storage battery group U2.

Control unit 704 integrates the Pn of storage battery group U1. Control unit 704 next comprehends this integrated value ΣP as Pmax. Control unit 704 reports Pmax to the power company.

Control unit 704 transmits discharge-permitted information “1” as operation control information to apparatus control devices 8 that control storage batteries 9 that belong to storage battery group U1. On the other hand, control unit 704 transmits discharge-not-permitted information “0” as operation control information to apparatus control devices 8 that control storage batteries 9 that belong to storage battery group U2. However, due to circumstances in which the effect of a power source failure due to power plant problems appears to be serious, control unit 704 may also send discharge-permitted information “1” to apparatus control devices 8 that control storage batteries 9 that belong to storage battery group U2.

In each apparatus control device 8, detection unit 802 measures the frequency of the linking point at period T2_{MO} (for example, 0.5 seconds). Control unit 805 determines the activation of instantaneous adjustment when the frequency of a linking point drops to, for example, 49.6 Hz or less for 5 seconds or more under the condition of having received discharge-permitted information “1.” Control unit 805, upon determining the activation of instantaneous adjustment, causes storage battery 9 to continuously discharge power Pn [kW] for ten minutes. Control unit 805 leaves the discharge results in a log.

The frequency of the linking point changes each time at period T2_{MO} (=0.5 seconds), but the charging/discharging operation of storage battery 9 is carried out using the same discharge-permitted information “1” (operation control information) until period T1_{MO} (=15 minutes) has elapsed.

In DR application 5 (instantaneous adjustment process), apparatus control device 8 receives discharge-permitted information “1” (operation control information) at period T1_{MO} (=15 minutes), detects the frequency of the linking point at period T2_{MO} (=0.5 seconds) that is shorter than period T1_{MO}, and carries out the charging/discharging operation of storage battery 9 on the basis of the discharge-permitted information “1” (operation control information) and the frequency of the linking point at period T2_{MO}. As described hereinabove, because operation control information that requires time for acquisition and bidirectional communication processing is acquired at a period longer than the detection period of the frequency of the linking point while the frequency of the linking point that fluctuates according to the power supply/demand balance is detected in real time, an instantaneous adjustment process for which the control interval is short can be accommodated.

The effect of the present exemplary embodiment is next described.

According to the present exemplary embodiment, determination unit 804 determines, according to the DR application, either the frequency of power grid 3 that is detected by detection unit 801 or index i1 and index i2 that are received by communication unit 803 as the usage information.

As a result, either information (the frequency of the power grid) that is detected by apparatus control device 8 or information (index) that is received by apparatus control device 8, i.e., information that is optimal for the DR application, can be determined as the information that is used in a power supply/demand adjustment process.

Modifications of the present exemplary embodiment are next described.

The number DR applications carried out by power control device 7 is not limited to five and can be altered as appropriate.

The DR applications that are carried out by power control device 7 are not limited to DR applications 1-5 and can be altered as appropriate.

For example, other DR applications that can be considered include spinning reserve and supplemental reserve/non-spinning reserve.

In the present exemplary embodiment, storage batteries were used as the power supply/demand adjustment devices, but the power supply/demand adjustment devices are not limited to storage batteries. For example, as shown in the first exemplary embodiment, the power supply/demand adjustment device may also be a household appliance, an electric hot water heater, a heat pump water heater, a pump, or an electric vehicle.

Further, in communication that is carried out in periods of T1_{GF}, T1_{FirstLFC}, T1_{SecondLFC}, T1_{BL}, and T1_{MO}, power control device 7 also implements not only communication of operation control information, but also collection of information relating to monitoring of the communication state and monitoring of the state of implementation of control.

In addition, when discharging from storage battery 9 (customer side) to power grid 3 (reverse flow) is prohibited, control unit 805 implements control such that the discharged power of storage battery 9 is discharged within the range of the amount of power consumption of loads 10 of the customer. The power demand upon power grid 3 is reduced by the consumption of the discharged power of storage battery 9 by loads 10.

When discharge from storage battery 9 (customer side) to power grid 3 (reverse flow) is not prohibited, control unit 805 may supply the discharged power of storage battery 9 to power grid 3.

In addition, control unit 704 may select storage batteries to be used in a DR application on the basis of static characteristics such as the response time or communication characteristics of storage batteries 9 that are demanded by the DR application or dynamic characteristics such as the implementation time or profitability of the DR application.

More specifically, for a DR application for which response is fast such as a GF adjustment process, storage batteries having a fast response time are selected. Alternatively, for a DR application having a slow response time, storage batteries having a slow response time may be selected.

Still further, control unit 704 may alter GF operation control information, first LFC operation control information, second LFC operation control information, BL operation control information, and MO operation control information according to the state (such as the temperature, voltage, or amount of residual stored power) of storage batteries 9 controlled by apparatus control device 8.

For example, control unit 704 accepts from apparatus control device 8 the chargeable/dischargeable capacity of storage battery 9 (including the capacity of the storage battery that the storage battery owner is to supply, for example, according to a contract, and the specification of the output of PCS).

Control unit 704 then generates GF operation control information, first LFC operation control information, second LFC operation control information, BL operation control information, and MO operation control information according to the chargeable/dischargeable capacity of storage battery 9. For example, control unit 704 generates each item of operation control information such that the adjustment power amount in storage battery 9 in each power supply/demand adjustment process is no greater than the chargeable/dischargeable capacity of storage battery 9.

In addition, control unit 704 may alter each item of operation control information according to the power adjustment amount (for example the power adjustment amount delegated from a power company, or the power adjustment amount that was successfully bid in a power exchange market) that is undertaken by power control device 7.

For example, control unit 704 generates each item of operation control information such that the adjustment power amount in storage battery 9 in each power supply/demand adjustment process matches the power adjustment amount that is undertaken by power control device 7. When power control device 7 controls a plurality of apparatus control devices 8, control unit 704 may generate operation control information as shown below.

Control unit 704 generates operation control information for each apparatus control device 8 such that the total adjustment power amount of each storage battery 9 in a power supply/demand adjustment process matches the power adjustment amount undertaken by power control device 7.

When bidirectional communication is carried out in each of the above-described exemplary embodiments, the transmission of indices and operation control information and the transmission of reception acknowledgements of these transmissions (Ack) may be carried out. When bidirectional communication is carried out in each of the above-described exemplary embodiments, the transmission of resending demands and requests of indices and operation control information and the indices and operation control information that are the responses to these demands and requests may be carried out.

In the above-described exemplary embodiments, each of control devices A and E, apparatus control devices B, BB, D, F, FF, H and 8, and power control devices C, G and 7 may be realized by a computer. In these cases, the computer reads and executes a program that is recorded on a recording medium that can be read by a computer to execute the functions of any of control devices A and E, apparatus control devices B, BB, D, F, FF, H and 8, and power control devices C, G and 7. The recording medium is, for example, a CD-ROM (Compact Disk Read Only Memory). The recording medium is not limited to a CD-ROM and can be altered as appropriate.

In each of the above-described exemplary embodiments, the configurations shown in the drawings are merely examples and the configuration of the present invention is not limited to these configurations.

Although the invention of the present application has been described with reference to the exemplary embodiments, the invention of the present application is not limited to the above-described exemplary embodiments. The configuration and details of the invention of the present application are open to various modifications within the scope of the invention of the present application that will be clear to one of ordinary skill in the art. This application is based upon and claims the benefit of priority from Japanese patent application No. 2014-216286, filed on Oct. 23, 2014, the disclosure of which is incorporated herein in its entirety by reference.

### EXPLANATION OF REFERENCE NUMBERS

A, E control device
A1, E1 reception unit
A2, E2 determination unit
B, BB, D, F, FF, H apparatus control device
B1 detection unit
B2, B3, D1, F1, F2, G1, H1 communication unit
B4, D2, F3 control unit
R1 power grid
R2 storage battery
R3 linking line
R4 another power grid
T, C, T1, G power control device
C1 communication unit
D1
1000 power control system
1 thermal power plant
2 load dispatching unit
201 frequency meter
202 flow detection unit
203 communication unit
204 control unit
3 power grid
4 linking line
distribution transformer
6 power line
7 power control device
701 communication unit
702 database
703 comprehension unit
704 control unit
8 apparatus control device
801, 802 detection unit
803 communication unit
804 determination unit
805 control unit
9 storage battery
10 load
111 renewable power source (solar power generator)
112 renewable power source (wind power generator)

1. A control device comprising:
a reception unit that receives information indicating characteristics of a power supply/demand adjustment process; and
a determination unit that, on the basis of information indicating characteristics of said power supply/demand adjustment process, determines an index that relates to an adjustment power amount received from a predetermined device or the state of a power grid as usage information that is used in the adjustment process.

2. The control device as set forth in claim 1, wherein said reception unit receives said index and operation control information for controlling the operation of a power supply/demand adjustment device according to an adjustment process that is specified by information that indicates characteristics of said power supply/demand adjustment process.

3. The control device as set forth in claim 2, wherein said reception unit continuously receives said index and receives said index and said operation control information at a predetermined timing.

4. The control device as set forth in claim 1, wherein an execution device that executes said adjustment process carries out detection of the state of said power grid or reception of said index.

5. The control device as set forth in claim 4, wherein said index is received by said execution device using one-way communication or is received by said execution device using bidirectional communication.

6. The control device as set forth in claim 1, wherein said determination unit determines said index as said usage information when the adjustment process that is specified by information that indicates characteristics of said power supply/demand adjustment process is a process of adjusting the difference between a target value in a predetermined interval and a supply amount or demand amount of electric power in said predetermined interval.

7. The control device as set forth in claim 1, wherein said determination unit determines said index as said usage information when the adjustment process that is specified in information that indicates characteristics of said power supply/demand adjustment process is a load frequency control process in a power grid to which a linking line is connected.

8. The control device as set forth in claim 1, wherein said determination unit determines the state of said power grid as said usage information when the adjustment process that is specified by information that indicates characteristics of said power supply/demand adjustment process is a load frequency control process in a power grid to which a linking line is not connected.

9. The control device as set forth in claim 1, wherein said determination unit determines the state of said power grid as said usage information when the adjustment process specified by information that indicates characteristics of said power supply/demand adjustment process is a governor-free process.

10. The control device as set forth in claim 1, wherein said determination unit determines the state of said power grid as said usage information when the adjustment process that is specified by information that indicates characteristics of said power supply/demand adjustment process is an electric power instantaneous adjustment process.

11. The control device as set forth in claim 1, wherein said determination unit also determines, as said usage information, operation control information for controlling the operation of a power supply/demand adjustment device according to the adjustment process that is specified by information that indicates characteristics of said power supply/demand adjustment process.

12. The control device as set forth in claim 11, wherein said determination unit determines said operation control information according to the state of said power supply/demand adjustment device.

13. The control device as set forth in claim 11, wherein:
said power supply/demand adjustment device is a storage battery; and
said determination unit determines said operation control information according to the chargeable/dischargeable capacity of said storage battery.

14. The control device as set forth in claim 11, wherein said determination unit determines said operation control information according to a power adjustment amount that is undertaken by a power control device that manages said power supply/demand adjustment process.

15. The control device as set forth in claim 11, further comprising:
a detection unit that detects the state of said power grid;
a communication unit that receives said index;
a transmission/reception unit that transmits the state of said power supply/demand adjustment device to an external device and that receives said operation control information that was transmitted by said external device at a time interval that is longer than the detection interval of the state of said power grid and the reception interval of said index; and
a control unit that controls said power supply/demand adjustment device on the basis of said usage information to execute said adjustment process.

16. The control device as set forth in claim 15, wherein said operation control information is generated on the basis of the state of said power supply/demand adjustment devices and the amount of electric power that is allotted to all N (where N is a number equal to or greater than 1) said power supply/demand adjustment devices.

17. The control device as set forth in claim 11, further comprising:
a detection unit that detects the state of said power grid;
a communication unit that receives said index; and
a control unit that controls said power supply/demand adjustment device on the basis of said usage information to execute said adjustment process;
wherein said operation control information is generated on the basis of the state of said power supply/demand adjustment devices and the amount of electric power that is allotted to all N (where N is a number equal to or greater than 1) said power supply/demand adjustment devices.

18. The control device as set forth in claim 1, further comprising a reporting unit that reports, to execution devices that execute said adjustment process, report information that specifies said usage information.

19. The control device as set forth in claim 6, wherein:
when the adjustment process specified by said specification information is a process of adjusting the difference between a target value in a predetermined interval and a supply amount or demand amount of electric power in said predetermined interval, said index is an index that accords with the difference between a target value in a predetermined interval and the supply amount or the demand amount of electric power in said predetermined interval.

20. The control device as set forth in claim 7, wherein:
when the adjustment process that is specified by said specification information is a load frequency control process in a power grid to which a linking line is connected, said index is determined on the basis of the state of said power grid and the flow of said linking line.

21. The control device as set forth in claim 1, wherein the state of said power grid is the frequency of said power grid.

22. A control device, comprising:
a communication unit that receives report information that specifies usage information that is used in a power supply/demand adjustment process; and
a control unit that uses usage information that is specified in said report information to control a power supply/demand adjustment device.

23. A power storage device comprising:
a battery that is connected to a power grid;
a detection unit that detects the state of a power grid;
a communication unit that receives an index relating to an adjustment power amount that is received from an external device;
a reception unit that receives information that indicates characteristics of a power supply/demand adjustment process that uses said battery;
a determination unit that, in accordance with an adjustment process that is specified in information that indicates characteristics of said power supply/demand adjustment process, determines the state of said power grid or said index as usage information that is to be used in the adjustment process; and
a control unit that, on the basis of said usage information, controls said battery to execute said adjustment process.

24. A control method comprising steps of:
receiving information that indicates characteristics of a power supply/demand adjustment process; and
on the basis of information that indicates characteristics of said power supply/demand adjustment process, determining, as usage information that is to be used in the adjustment process, an index that relates to an adjustment power amount that is received from a predetermined device or the state of a power grid.

25. A control method comprising steps of:
receiving report information that specifies usage information that is used in a power supply/demand adjustment process; and
using the usage information that is specified in said report information to control a power supply/demand adjustment device.

26. A recording medium that can be read by a computer and on which is recorded a program for causing a computer to execute:
a reception procedure of receiving information that indicates characteristics of a power supply/demand adjustment process; and
a determination procedure of, on the basis of information that indicates characteristics of said power supply/demand adjustment process, determining, as usage information that is to be used in the adjustment process, an index relating to an adjustment power amount that is received from a predetermined device or the state of a power grid.

27. A recording medium that can be read by a computer and on which is recorded a program that causes a computer to execute:
a reception procedure of receiving report information that specifies usage information that is used in a power supply/demand adjustment process; and
a control procedure of using usage information that is specified in said report information to control a power supply/demand adjustment device.
